(19) United States
(12) Patent Application Publication
(10) Pub. No.: US 2021/0323333 A1
(43) Pub. Date: Oct. 21, 2021

(54) IMAGING MEDIUM

(71) Applicant: HEWLETT-PACKARD DEVELOPMENT COMPANY, L.P., Spring, TX (US)

(72) Inventors: Jayprakash C. Bhatt, Corvallis, OR (US); Michael W. Cumbie, Corvallis, OR (US)

(21) Appl. No.: 16/605,236

(22) PCT Filed: Aug. 30, 2018
(86) PCT No.: PCT/US2018/048888

§ 371 Date: Oct. 15, 2019

(30) Foreign Application Priority Data
Apr. 13, 2018 (US) PCT/US2018/027618
Apr. 13, 2018 (US) PCT/US2018/027621
Apr. 13, 2018 (US) PCT/US2018/027623

(51) Int. Cl. B41M 5/34; B41M 5/44; B41J 2/325; B41J 2/335

(52) U.S. Cl. CPC B41M 5/345; B41J 2/3353; B41J 2/325; B41M 5/44

(57) ABSTRACT

Imaging medium includes an image-receiving substrate including a color-forming layer, a donor ribbon attached to the image-receiving substrate and including a color layer, and a repeated pattern. The repeated pattern is defined by a portion of each of the color-forming layer and color layer. A repeat of the pattern includes at least three adjacent colored stripes including a cyan or cyan-forming stripe, a magenta or magenta-forming stripe, and a yellow or yellow-forming stripe. A first of the at least three adjacent stripes is a color-forming stripe in the color-forming layer. A second of the at least three adjacent stripes is a colored stripe in the color layer. A third of the at least three adjacent stripes is either a second color-forming stripe in the color-forming layer or a second colored stripe in the color layer of the donor ribbon.

### CROSS-REFERENCE TO RELATED APPLICATIONS

This application claims priority to: International Patent Application Number PCT/US2018/027618 filed Apr. 13, 2018, the contents of which are incorporated by reference herein in its entirety; International Patent Application Number PCT/US2018/027621 filed Apr. 13, 2018, the contents of which are incorporated by reference herein in its entirety; and International Patent Application Number PCT/US2018/027623 filed Apr. 13, 2018, the contents of which are incorporated by reference herein in its entirety.

### BACKGROUND

Thermal imaging (also known as thermal printing) is a printing process used to form images. During a thermal imaging process, a printer uses heat to produce the images. The heat may be selectively applied, for example, with a thermal printhead. Some thermal imaging methods are direct printing methods that may involve thermal paper. In these thermal imaging methods, the thermal paper changes color where it is heated. Other thermal imaging methods are transfer printing methods that may involve the use of separate donor and receiver materials. In these thermal imaging methods, a heat sensitive donor material may be used to thermally transfer colorants from the donor material to the receiver material.

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIG. 1 is a cross-sectional view of an example of an imaging medium disclosed herein;

FIGS. 2A and 2B are top, schematic views of examples of a repeat of a pattern of the imaging medium disclosed herein; and

FIG. 3 is a flow diagram illustrating an example of a method of making the imaging medium.

### DETAILED DESCRIPTION

Thermal imaging may be used to produce multicolored images. In some thermal imaging methods, a separate donor ribbon with successive patches of differently-colored materials or different color-forming materials may be used to produce the multicolored images. These methods involve moving the donor ribbon so that a patch of the desired colored or color-forming material is in contact with a desired location of an image-receiving substrate so that the desired color is transferred from the donor ribbon to the desired location on the image-receiving substrate. This process involves activating each color in separate passes and moving the donor ribbon between each activation (so that the next colored or color-forming material is in contact with the image-receiving substrate), which may result in a slow printing speed. When a separate donor ribbon is used, the size of the printer has to be large enough to accommodate the donor ribbon, and potentially a cartridge to collect the excess ribbon after printing. Moreover, thermal imaging with a donor ribbon involves two consumables, i.e., the donor ribbon and the separate image-receiving medium, which can increase the cost of printing.

In other thermal imaging methods, a single imaging medium without a separate donor ribbon may be used to produce multicolored images. An example of the single imaging medium includes multiple layers of different color-forming materials separated by thermal interlayers. These methods involve heating the imaging medium to different temperatures for different time periods to produce different colors from the respective color-forming materials. Heating at a particular temperature activates a particular color, and thus, activating each color occurs in separate passes, which may result in a slow printing speed. The different temperatures to which, and the different time periods for which the imaging medium is heated to produce the different colors may also result in high power consumption. Moreover, the temperature control utilized for color activation may be complex, as a result of trying to avoid cross-talk between the colors. Additionally, producing an imaging medium with multiple layers of different color-forming materials separated by thermal interlayers may be complex and expensive.

Imaging Medium

Examples of an imaging medium are disclosed herein, which may be used in a relatively inexpensive thermal imaging process and may be used in a relatively small printer. The imaging medium disclosed herein includes a donor ribbon attached to an image-receiving substrate. Because the donor ribbon is attached to, and not separate from, the image-receiving substrate, one consumable (including the donor ribbon and the image-receiving substrate) is used. Thus, the cost of printing may be reduced (compared to a thermal imaging process that uses two consumables, i.e., separate donor ribbon and imaging medium). Moreover, because the donor ribbon is integrated into the imaging medium in the examples disclosed herein, a separate donor ribbon and cartridge for collecting the used donor ribbon do not need to be accommodated by the printer used to print on the medium. As such, the size of the printer used with the imaging medium disclosed herein may be reduced (as compared to a printer that uses two consumables).

Further, examples of the imaging medium disclosed herein may result in relatively fast printing and relatively low power consumption. The image-receiving substrate includes a color-forming layer, which defines a portion of a repeated pattern, and the donor ribbon includes a color layer, which defines another portion of the repeated pattern. A repeat of the pattern includes at least three adjacent stripes or a grid of four sections. A colored image may be produce by activating at least a portion of one or more of the color-forming stripes or the color-forming sections in the color-forming layer (of the image-receiving substrate), and/or transferring, to the image-receiving substrate, one or more thermal transfer dyes from at least a portion of one or more of the colored stripes or the colored sections in the color layer (of the donor ribbon). In some examples, the color-forming stripes or color-forming sections may be activated and/or each of the thermal transfer dyes may be transferred in a single pass and under the same heat exposure conditions, which may increase the printing speed (as compared to thermal imaging processes including multiple passes) and/or reduce power consumption (as compared to a thermal imaging process that involves heating an imaging medium to different temperatures for different time periods) and/or simplify the temperature control process.

Examples of the imaging medium disclosed herein may also be less expensive to produce than a separate donor ribbon and image-receiving substrate and/or than an imaging medium with multiple layers of different color-forming materials separated by thermal interlayers.

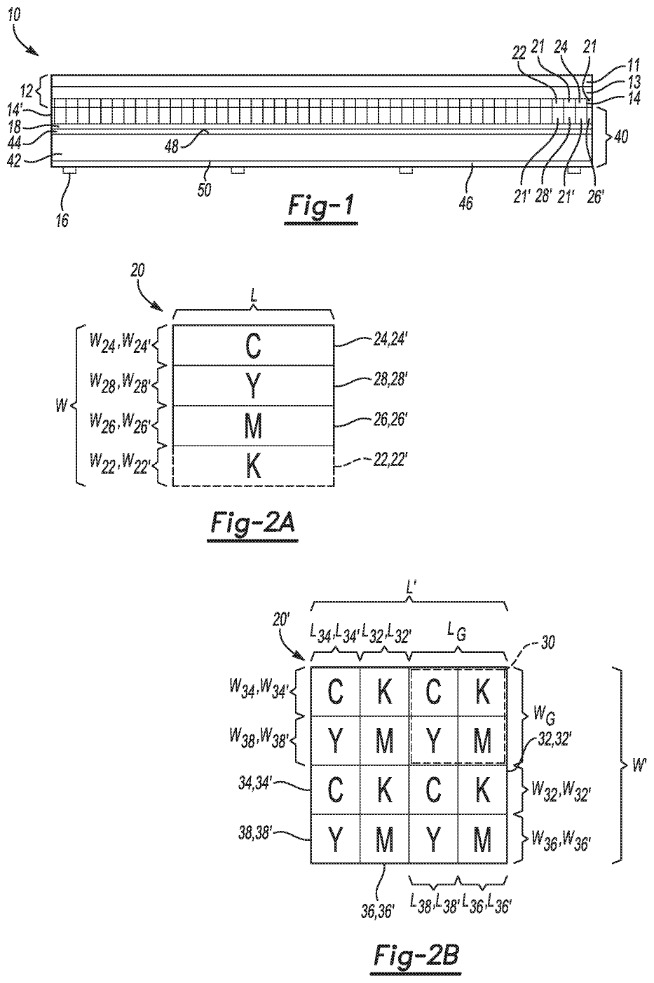

Referring now to FIG. 1, a cross-section of an example of the imaging medium 10 is depicted.

In one example, the imaging medium 10 comprises: an image-receiving substrate 12 including a color-forming layer 14; a donor ribbon 40 attached to the image-receiving substrate 12 and including a color layer 14′; and a repeated pattern defined by a portion of the color-forming layer 14 and a portion of the color layer 14′, a repeat 20 (see, e.g., FIG. 2A) of the pattern including: at least three adjacent stripes 24, 24′, 26, 26′, 28, 28′ (see, e.g., FIG. 2A) including a cyan or cyan-forming stripe 24, 24′, a magenta or magenta-forming stripe 26, 26′, and a yellow or yellow-forming stripe 28, 28′, wherein: a first of the at least three adjacent stripes 24, 24′, 26, 26′, 28, 28′ is a color-forming stripe 24, 26, 28 in the color-forming layer 14 of the image-receiving substrate 12; a second of the at least three adjacent stripes 24, 24′, 26, 26′, 28, 28′ is a colored stripe 24′, 26′, 28′ in the color layer 14′ of the donor ribbon 40; and a third of the at least three adjacent stripes 24, 24′, 26, 26′, 28, 28′ is either a second color-forming stripe 24, 26, 28 in the color-forming layer 14 or a second colored stripe 24′, 26′, 28′ in the color layer 14′ of the donor ribbon 40.

In another example, the imaging medium 10 comprises: an image-receiving substrate 12 including a color-forming layer 14; a donor ribbon 40 attached to the image-receiving substrate 12 and including a color layer 14′; and a repeated pattern defined by a portion of the color-forming layer 14 and a portion of the color layer 14′, a repeat 20 of the pattern including: four adjacent stripes 22, 22′, 24, 24′, 26, 26′, 28, 28′ including a black or black-forming stripe 22, 22′, a cyan or cyan-forming stripe 24, 24′, a magenta or magenta-forming stripe 26, 26′, and a yellow or yellow-forming stripe 28, 28′, wherein: a first of the four adjacent stripes 22, 22′, 24, 24′, 26, 26′, 28, 28′ is a color-forming stripe 22, 24, 26, 28 in the color-forming layer 14 of the image-receiving substrate 12; a second of the four adjacent stripes 22, 22′, 24, 24′, 26, 26′, 28, 28′ is a colored stripe 22′, 24′, 26′, 28′ in the color layer 14′ of the donor ribbon 40; and a third and a fourth of the four adjacent stripes 22, 22′, 24, 24′, 26, 26′, 28, 28′ are one of: a second color-forming stripe 22, 24, 26, 28 in the color-forming layer 14 of the image-receiving substrate 12 and a second colored stripe 22′, 24′, 26′, 28′ in the color layer 14′ of the donor ribbon 40; or a second color-forming stripe 22, 24, 26, 28 in the color-forming layer 14 of the image-receiving substrate 12, and a third color-forming stripe 22, 24, 26, 28 in the color-forming layer 14 of the image-receiving substrate 12; or a second colored 22′, 24′, 26′, 28′ stripe in the color layer 14′ of the donor ribbon 40, and a third colored stripe 22′, 24′, 26′, 28′ in the color layer 14′ of the donor ribbon 40.

In still another example, the imaging medium 10 comprises: an image-receiving substrate 12 including a color-forming layer 14; and a donor ribbon 40 attached to the image-receiving substrate 12 and including a color layer 14′; and a repeated pattern defined by a portion of the color-forming layer 14 and a portion of the color layer 14′, a repeat 20′ (see, e.g., FIG. 2B) of the pattern including: a grid 30 (see, e.g., FIG. 2B) of four sections 32, 32′, 34, 34′, 36, 36′, 38, 38′ (see, e.g., FIG. 2B) including i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′; wherein: a first of the four sections 32, 32′, 34, 34′, 36, 36′, 38, 38′ is a color-forming section 32, 34, 36, 38 in the color-forming layer 14 of the image-receiving substrate 12; a second of the four sections 32, 32′, 34, 34′, 36, 36′, 38, 38′ is a colored section 32′, 34′, 36′, 38′ in the color layer 14′ of the donor ribbon 40; and a third and a fourth of the four sections 32, 32′, 34, 34′, 36, 36′, 38, 38′ are one of: a second color-forming section 32, 34, 36, 38 in the color-forming layer 14 of the image-receiving substrate 12, and a second colored section 32′, 34′, 36′, 38′ in the color layer 14′ of the donor ribbon 40; or a second color-forming section 32, 34, 36, 38 in the color-forming layer 14 of the image-receiving substrate 12, and a third color-forming section 32, 34, 36, 38 in the color-forming layer 14 of the image-receiving substrate 12; or a second colored section 32′, 34′, 36′, 38′ in the color layer 14′ of the donor ribbon 40, and a third colored section 32′, 34′, 36′, 38′ in the color layer 14′ of the donor ribbon 40.

In yet another example, the imaging medium 10 comprises: an image-receiving substrate 12 including a color-forming layer 14; and a donor ribbon 40 attached to the image-receiving substrate 12 and including a color layer 14′; and a repeated pattern defined by a portion of the color-forming layer 14 and a portion of the color layer 14′, a repeat 20′ of the pattern including: a grid 30 of four sections 32, 32′, 34, 34′, 36, 36′, 38, 38′ including a black or black-forming section (an example of the section 32, 32′), a cyan or cyan-forming section 34, 34′, a magenta or magenta-forming section 36, 36′, and a yellow or yellow-forming section 38, 38′; wherein: a first of the four sections 32, 32′, 34, 34′, 36, 36′, 38, 38′ is a color-forming section 32, 34, 36, 38 in the color-forming layer 14 of the image-receiving substrate 12; a second of the four sections 32, 32′, 34, 34′, 36, 36′, 38, 38′ is a colored section 32′, 34′, 36′, 38′ in the color layer 14′ of the donor ribbon 40; and a third and a fourth of the four sections 32, 32′, 34, 34′, 36, 36′, 38, 38′ are one of: a second color-forming section 32, 34, 36, 38 in the color-forming layer 14 of the image-receiving substrate 12, and a second colored section 32′, 34′, 36′, 38′ in the color layer 14′ of the donor ribbon 40; or a second color-forming section 32, 34, 36, 38 in the color-forming layer 14 of the image-receiving substrate 12, and a third color-forming section 32, 34, 36, 38 in the color-forming layer 14 of the image-receiving substrate 12; or a second colored section 32′, 34′, 36′, 38′ in the color layer 14′ of the donor ribbon 40, and a third colored section 32′, 34′, 36′, 38′ in the color layer 14′ of the donor ribbon 40.

In some examples, the imaging medium 10 consists of the image-receiving substrate 12, the donor ribbon 40, and the repeated pattern, with no other components. In other examples, the imaging medium 10 may include additional components, such as a registration mark 16. In some of these examples, the imaging medium 10 consists of the image-receiving substrate 12, the donor ribbon 40, the repeated pattern, and the registration mark 16, with no other components.

In the example shown in FIG. 1, the imaging medium 10 includes the image-receiving substrate 12, the donor ribbon 40, the repeated pattern, and the registration mark 16. In the example shown in FIG. 1, the image-receiving substrate 12 includes: a base layer 11; an ink-receiving layer 13 disposed on the base layer 11; and a color-forming layer 14 disposed on the ink-receiving layer 13. In the example shown in FIG. 1, the donor ribbon 40 includes: a donor ribbon substrate 42 having a front side 48 and a back side 50; a back coat 46 disposed on the back side 50 of the donor ribbon substrate 42; a release layer 44 disposed on the front side 48 of the donor ribbon substrate 42; a clear and colorless topcoat 18 disposed on the release layer 44; and a color layer 14′ disposed on the clear and colorless topcoat 18. In the example shown in FIG. 1, the donor ribbon 40 is attached to the image-receiving substrate 12 so that the color layer 14′ of the donor ribbon 40 is in contact with the color-forming layer 14 of the image-receiving substrate 12. Each of the components of the imaging medium 10 will be described below.

The imaging medium 10 may be any size (e.g., width, length, area, etc.) that is desired. As an example, the imaging medium 10 may have a width of 2 inches. As another example, the imaging medium 10 may have a width of 4 inches. In still another example, the imaging medium 10 may have a width greater than 4 inches. In yet another example, the imaging medium 10 may have a width of 2 inches and a length of 3 inches. In other examples, the imaging medium 10 may have a width of 3 inches and a length of 5 inches, may have a width of 4 inches and a length of 6 inches, or may have a width of 5 inches and a length of 7 inches.

Repeated Patterns

The repeated pattern of the imaging medium 10 will be described in reference to FIGS. 2A and 2B.

In some examples, a repeat 20 of the pattern includes at least three adjacent stripes 24, 24′, 26, 26′, 28, 28′ as shown in FIG. 2A. In these examples, the at least three adjacent stripes 24, 24′, 26, 26′, 28, 28′ may include a cyan or cyan-forming stripe 24, 24′, a magenta or magenta-forming stripe 26, 26′, and a yellow or yellow-forming stripe 28, 28′. A first of the at least three adjacent stripes 24, 24′, 26, 26′, 28, 28′ may be a color-forming stripe 24, 26, 28 in the color-forming layer 14 of the image-receiving substrate 12. A second of the at least three adjacent stripes 24, 24′, 26, 26′, 28, 28′ may be a colored stripe 24′, 26, 28′ in the color layer 14′ of the donor ribbon 40. A third of the at least three adjacent stripes 24, 24′, 26, 26′, 28, 28′ may be either a second color-forming stripe 24, 26, 28 in the color-forming layer 14 or a second colored stripe 24′, 26, 28′ in the color layer 14′ of the donor ribbon 40. In these examples, either one stripe of the repeat 20′ is in the color layer 14′ and two stripes of the repeat 20′ are in the color-forming layer 14, or two stripes of the repeat 20′ are in the color layer 14′ and one stripe of the repeat 20′ is in the color-forming layer 14.

In some other examples, a repeat 20′ of the pattern includes a grid 30 of four sections 32, 32′, 34, 34′, 36, 36′, 38, 38′ as shown in FIG. 2B. In these examples, the grid 30 may include i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′. A first of the four sections 32, 32′, 34, 34′, 36, 36′, 38, 38′ may be a color-forming section 32, 34, 36, 38 in the color-forming layer 14 of the image-receiving substrate 12. A second of the four sections 32, 32′, 34, 34′, 36, 36′, 38, 38′ may be a colored section 32′, 34′, 36′, 38′ in the color layer 14′ of the donor ribbon 40. In one example, a third and a fourth of the four sections 32, 32′, 34, 34′, 36, 36′, 38, 38′ may be a second color-forming section 32, 34, 36, 38 in the color-forming layer 14 of the image-receiving substrate 12, and a second colored section 32′, 34′, 36′, 38′ in the color layer 14′ of the donor ribbon 40. In this example, two sections of the repeat 20′ are in the color layer 14′ and two sections of the repeat 20′ are in the color-forming layer 14. In another example, a third and a fourth of the four sections 32, 32′, 34, 34′, 36, 36′, 38, 38′ may be a second color-forming section 32, 34, 36, 38 in the color-forming layer 14 of the image-receiving substrate 12, and a third color-forming section 32, 34, 36, 38 in the color-forming layer 14 of the image-receiving substrate 12. In this example, one section of the repeat 20′ is in the color layer 14′ and three sections of the repeat 20′ are in the color-forming layer 14. In still another example, a third and a fourth of the four sections 32, 32′, 34, 34′, 36, 36′, 38, 38′ may be a second colored section 32′, 34′, 36′, 38′ in the color layer 14′ of the donor ribbon 40, and a third colored section 32′, 34′, 36′, 38′ in the color layer 14′ of the donor ribbon 40. In this example, three sections of the repeat 20′ are in the color layer 14′ and one section of the repeat 20′ is in the color-forming layer 14.

It is to be understood that the color-forming layer 14 and the color layer 14′ together form one repeated pattern. The repeat 20 or 20′ may be replicated any number of times and in any desired configuration throughout the color-forming layer 14 and the color layer 14′ to form the repeated pattern.

The repeats 20, 20′ of the pattern are adjacent to one another, but not layered on top of each other. As such, the portion of the repeated pattern that is included in the color-forming layer 14 does not overlap with the remaining portion of the repeated pattern that is included in the color layer 14′. Therefore, if the color-forming layer 14 and the color layer 14′ were superimposed, the repeats 20, 20′ would be formed, but the various stripes or sections of the repeats 20, 20′ would not overlap one another. More specifically, the stripes 22, 22′, 24, 24′, 26, 26′, 28, 28′ of the repeat 20 or the sections 32, 32′, 34, 34′, 36, 36′, 38, 38′ of the repeat 20′ are substantially planar throughout the color-forming layer 14 and the color layer 14′ and are not layered on top of each other. Further, the repeats 20, 20′ may be contiguous throughout the repeated pattern and the color-forming layer 14 and color layer 14′. In other words, the configuration of the repeats 20, 20′ is such that i) each repeat 20, 20′ shares a common border with at least one other repeat 20, 20′, and ii) the repeated pattern is devoid of spaces that do not include either a stripe 22, 22′, 24, 24′, 26, 26′, 28, 28′ or a section 32, 32′, 34, 34′, 36, 36′, 38, 38′.

In FIGS. 2A and 2B, two examples of the repeat 20, 20′ of the pattern are depicted. As shown in FIG. 2A, one example of the repeat 20 of the pattern includes at least three adjacent stripes 24, 24′, 26, 26′, 28, 28′ including a cyan or cyan-forming stripe 24, 24′ (labeled with a “C” in FIG. 2A), a magenta or magenta-forming stripe 26, 26′ (labeled with a “M” in FIG. 2A), and a yellow or yellow-forming stripe 28, 28′ (labeled with a “Y” in FIG. 2A). In some examples, the at least three adjacent stripes 24, 24′, 26, 26′, 28, 28′ includes four adjacent stripes 22, 22′, 24, 24′, 26, 26′, 28, 28′, and a fourth of the four adjacent stripes 22, 22′, 24, 24′, 26, 26′, 28, 28′ is a black or black-forming stripe 22, 22′ (labeled with a “K” in FIG. 2A). As shown in FIG. 2A, the stripes 22, 22′, 24, 24′, 26, 26′, 28, 28′ may be positioned so that one of the longer sides (having length L) of any stripe 22, 22′, 24, 24′, 26, 26′, 28, 28′ abuts one of the longer sides of any other stripe 22, 22′, 24, 24′, 26, 26′, 28, 28′. It is to be understood that the color arrangement shown in FIG. 2A is one example, and that the stripes 22, 22′, 24, 24′, 26, 26′, 28, 28′ may be rearranged so that different colors are next to each other in the repeat 20. While the repeat 20 is depicted as being planar in FIG. 2A, it is to be understood that at least one of the at least three adjacent stripes 24, 24′, 26, 26′, 28, 28′ is a color-forming stripe in the color-forming layer 14 and at least one other of the at least three adjacent stripes 24, 24′, 26, 26′, 28, 28′ is a color stripe in the color layer 14′.

As shown in FIG. 2B, another example of the repeat 20′ of the pattern includes the grid 30 of four sections 32, 32′, 34, 34′, 36, 36′, 38, 38′ including i) a section 32, 32′ (labeled with a “K” in FIG. 2B) selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′ (labeled with a “C” in FIG. 2B), iii) a magenta or magenta-forming section 36, 36′ (labeled with a “M” in FIG. 2B), and iv) a yellow or yellow-forming section 38, 38′ (labeled with a “Y” in FIG. 2B). While the section 32, 32′ is labeled with a “K” in FIG. 2B (indicating a black or black-forming section), it is to be understood that a black or black-forming section is one example of the section 32, 32′, and in other examples, the section 32, 32′ may be cyan or cyan-forming, light cyan or light cyan-forming, yellow or yellow-forming, magenta or magenta-forming, or light magenta or light magenta-forming. It is to be understood that the color arrangement shown in FIG. 2B is one example, and that the sections 32, 32′, 34, 34′, 36, 36′, 38, 38′ may be rearranged so that different colors are next to each other in the repeat 20′. While the repeat 20′ is depicted as being planar in FIG. 2B, it is to be understood that at least one of the four sections 32, 32′, 34, 34′, 36, 36′, 38, 38′ is a color-forming section in the color-forming layer 14 and at least one other of the four sections 32, 32′, 34, 34′, 36, 36′, 38, 38′ is a color section in the color layer 14′.

In some examples, the grid 30 may be the repeat 20′ (i.e., the grid 30 is repeated to form the repeated pattern). In other examples, several grids 30 may be arranged in a desirable pattern to form the repeat 20′, and the repeat 20′ (including several grids 30) is repeated to form the repeated pattern. In any of the examples disclosed herein, the grid 30 has a square or rectangular shape, and the sections 32, 32′, 34, 34′, 36, 36′, 38, 38′ may each make up one quarter of the grid 30. The square or rectangular shape of the grid 30 is desirable so that when repeated (e.g., to form the repeated pattern, or arranged to form the repeat 20′, which is repeated to form the repeated pattern), the grids 30 can be contiguous without having to accommodate for curves or other non-straight edges. In some examples, the term “section” refers to a shape that has a length that is at least substantially equal to (e.g., within 5% of) its width. In these examples, each section 32, 32′, 34, 34′, 36, 36′, 38, 38′ may have a square shape or a rectangular shape. As such, the shape of the sections 32, 32′, 34, 34′, 36, 36′, 38, 38′ may be similar to the shape of the thermal resistors of a thermal printhead, as thermal resistors may be square or rectangular. It is to be understood that when the imaging medium 10 is to be used with thermal resistors having another shape (e.g., oval, round, triangular, parallelograms, or some other arbitrary shape), the shape of the sections 32, 32′, 34, 34′, 36, 36′, 38, 38′ may be altered to correspond with the shape of the resistors.

The size (e.g., width, length, area, etc.) of each stripe 22, 22′, 24, 24′, 26, 26′, 28, 28′ or each section 32, 32′, 34, 34′, 36, 36′, 38, 38′ may depend, in part, on desired resolution of the image to be formed with the imaging medium 10. A smaller size may enable the imaging medium 10 to produce (when selectively exposed to heat) an image with reduced grain and higher resolution (as compared to the grain and resolution of an image produced by the imaging medium 10 when each stripe 22, 22′, 24, 24′, 26, 26′, 28, 28′ or each section 32, 32′, 34, 34′, 36, 36′, 38, 38′ has a larger size). In some examples, defining the repeated pattern by a portion of the color-forming layer 14 and a portion of the color layer 14′ may enable the dot gain for a given resolution to be controlled, thus mitigating the risk of forming grainy images.

When the repeat 20 includes the at least three adjacent stripes 24, 24′, 26, 26′, 28, 28′, the width W of the repeat 20 may be equal to the sum of the widths W₂₄, W_{24′}, W₂₆, W_{26′}, W₂₈, W_{28′} of the at least three adjacent stripes 24, 24′, 26, 26′, 28, 28′. While the width W of the repeat 20 is shown in FIG. 2A to be equal to the widths W₂₂, W_{22′}, W₂₄, W_{24′}, W₂₆, W_{26′}, W₂₈, W_{28′} of four adjacent stripes 22, 22′, 24, 24′, 26, 26′, 28, 28′, it is to be understood that this is one example, and in other examples the width W of the repeat 20 may be equal to the widths W₂₄, W_{24′}, W₂₆, W_{26′}, W₂₈, W_{28′} of three adjacent stripes 24, 24′, 26, 26′, 28, 28′ or the widths W₂₂, W_{22′}, W₂₄, W_{24′}, W₂₆, W_{26′}, W₂₈, W_{28′} of five or more adjacent stripes 22, 22′, 24, 24′, 26, 26′, 28, 28′. As examples, the at least three adjacent stripes 24, 24′, 26, 26′, 28, 28′ may each have a width W₂₄, W_{24′}, W₂₆, W_{26′}, W₂₈, W_{28′} of: 1/300^{th} of an inch or smaller; 1/600^{th} of an inch or smaller; or 1/1200^{th} of an inch or smaller. As another example, the at least three adjacent stripes 24, 24′, 26, 26′, 28, 28′ may each have a width W₂₄, W_{24′}, W₂₆, W_{26′}, W₂₈, W_{28′} equal to the width of a row of thermal resistors of a thermal printhead.

In an example, each of the at least three adjacent stripes 24, 24′, 26, 26′, 28, 28′ has a width W₂₄, W_{24′}, W₂₆, W_{26′}, W₂₈, W_{28′} of 1/300^{th} of an inch or smaller. In another example, the at least three adjacent stripes 24, 24′, 26, 26′, 28, 28′ includes four adjacent stripes 22, 22′, 24, 24′, 26, 26′, 28, 28′; a fourth of the four adjacent stripes 22, 22′, 24, 24′, 26, 26′, 28, 28′ is a black stripe 22, 22′; and each stripe 22, 22′, 24, 24′, 26, 26′, 28, 28′ has a width W₂₂, W_{22′}, W₂₄, W_{24′}, W₂₆, W_{26′}, W₂₈, W_{28′} of 1/300^{th} of an inch or smaller. In this example, the repeat 20 may have a width W of 1/75^{th} of an inch or smaller. In still another example, the repeat 20 of the pattern includes the four adjacent stripes 22, 22′, 24, 24′, 26, 26′, 28, 28′, and each stripe 22, 22′, 24, 24′, 26, 26′, 28, 28′ has a width W₂₂, W_{22′}, W₂₄, W_{24′}, W₂₆, W_{26′}, W₂₈, W_{28′} of 1/600^{th} of an inch or smaller. In this example, the repeat 20 may have a width W of 1/150^{th} of an inch or smaller. In yet another example, the repeat 20 of the pattern includes the four adjacent stripes 22, 22′, 24, 24′, 26, 26′, 28, 28′, and each stripe 22, 22′, 24, 24′, 26, 26′, 28, 28′ has a width W₂₂, W_{22′}, W₂₄, W_{24′}, W₂₆, W_{26′}, W₂₈, W_{28′} of 1/1200^{th} of an inch or smaller. In this example, the repeat 20 may have a width W of 1/300^{th} of an inch or smaller. In yet another example, the repeat 20 of the pattern includes the four adjacent stripes 22, 22′, 24, 24′, 26, 26′, 28, 28′, and each stripe 22, 22′, 24, 24′, 26, 26′, 28, 28′ has a width W₂₂, W_{22′}, W₂₄, W_{24′}, W₂₆, W_{26′}, W₂₈, W_{28′} equal to the width of a row of thermal resistors of a thermal printhead. In this example, the repeat 20 may have a width W equal to four times the width of the row of thermal resistors of the thermal printhead.

In an example, the repeat 20 of the pattern includes the at least three adjacent stripes 22, 22′, 24, 24′, 26, 26′, 28, 28′, and each stripe 22, 22′, 24, 24′, 26, 26′, 28, 28′ has a length L ranging from about 2 inches to about 7 inches. The length L of each stripe 22, 22′, 24, 24′, 26, 26′, 28, 28′ is also the length of the repeat 20. In an example, the length L may be equal to the width of the imaging medium 10. As such, the length L of each stripe 22, 22′, 24, 24′, 26, 26′, 28, 28′ may be 2 inches, 3 inches, 4 inches, or 5 inches.

When the repeat 20′ includes the grid 30, the area of the grid 30 may be equal to the sum of the areas of the four sections 32, 32′, 34, 34′, 36, 36′, 38, 38′. In an example (as shown in FIG. 2B), the grid 30 includes the four sections 32, 32′, 34, 34′, 36, 36′, 38, 38′ in a 2 by 2 array. In some of these examples, the sections 32, 32′, 34, 34′, 36, 36′, 38, 38′ are squares or rectangles with equivalent dimensions, and thus the width W_{G} of the grid 30 may be equal to two times the width W₃₂, W_{32′}, W₃₄, W_{34′}, W₃₆, W_{36′}, W₃₈, W_{38′} of the four sections 32, 32′, 34, 34′, 36, 36′, 38, 38′, and the length L_{G} of the grid 30 may be equal to two times the length L₃₂, L_{32′}, L₃₄, L_{34′}, L₃₆, L_{36′}, L₃₈, L_{38′} of the four sections 32, 32′, 34, 34′, 36, 36′, 38, 38′. As mentioned above, the repeat 20′ of the pattern may include multiple grids 30 arranged in a square or rectangular pattern. In some of these examples, as shown in FIG. 2B, the repeat 20′ of the pattern includes four grids 30 arranged in a square pattern. In these examples, the area of the repeat 20′ may be equal to the sum of the areas of the four grids 30 (or the sum of the areas of the sixteen sections 32, 32′, 34, 34′, 36, 36′, 38, 38′ that make up the four grids 30). When the sections 32, 32′, 34, 34′, 36, 36′, 38, 38′ of the grids 30 are squares or rectangles with equivalent dimensions, the width W of the repeat 20′ may be equal to two times the width W_{G} of the grid 30 (or four times the width W₃₂, W_{32′}, W₃₄, W_{34′}, W₃₆, W_{36′}, W₃₈, W_{38′} of the four sections 32, 32′, 34, 34′, 36, 36′, 38, 38′), and the length L′ of the repeat 20′ may be equal to two times the length L_{G} of the grid 30 (or four times the length L₃₂, L_{32′}, L₃₄, L_{34′}, L₃₆, L_{36′}, L₃₈, L_{38′} of the four sections 32, 32′, 34, 34′, 36, 36′, 38, 38′).

While one example of the repeat 20′ including multiple grids 30 is shown, it is to be understood that multiple grids 30 may be configured in a different square or rectangular arrangement to form the repeat 20′. For example, the repeat 20′ may include nine grids 30 (each grid 30 including a 2×2 array of the sections 32, 32′, 34, 34′, 36, 36′, 38, 38′) arranged in a 3×3 array to form a square pattern. In these examples, the dimensions of the repeat 20′, the grids 30, and the sections 32, 32′, 34, 34′, 36, 36′, 38, 38′ may be adjusted so that the dimensions of the sections 32, 32′, 34, 34′, 36, 36′, 38, 38′ correspond with the dimensions of the thermal resistors to be used with the imaging medium 10.

In an example, each of the four sections 32, 32′, 34, 34′, 36, 36′, 38, 38′ has an area of 1/300^{th} of an inch by 1/300^{th} of an inch or smaller. In this example, the grid 30 may have an area of 1/150^{th} of an inch by 1/150^{th} of an inch or smaller. When four of these grids 30 are arranged in the square pattern to form the repeat 20′, the repeat 20′ may have an area of 1/75^{th} of an inch by 1/75^{th} of an inch or smaller. In another example, each of the four sections 32, 32′, 34, 34′, 36, 36′, 38, 38′ has an area of 1/600^{th} of an inch by 1/600^{th} of an inch or smaller. In this example, the grid 30 may have an area of 1/300^{th} of an inch by 1/300^{th} of an inch or smaller. When four of these grids 30 are arranged in the square pattern to form the repeat 20′, the repeat 20′ may have an area of 1/150^{th} of an inch by 1/150^{th} of an inch or smaller. In still another example, each of the four sections 32, 32′, 34, 34′, 36, 36′, 38, 38′ has an area of 1/800^{th} of an inch by 1/800^{th} of an inch or smaller. In this example, the grid 30 may have an area of 1/400^{th} of an inch by 1/400^{th} of an inch or smaller. When four of these grids 30 are arranged in the square pattern to form the repeat 20′, the repeat 20′ may have an area of 1/200^{th} of an inch by 1/200^{th} of an inch or smaller. In yet another example, each of the four sections 32, 32′, 34, 34′, 36, 36′, 38, 38′ has an area of 1/1200^{th} of an inch by 1/1200^{th} of an inch or smaller. In this example, the grid 30 may have an area of 1/600^{th} of an inch by 1/600^{th} of an inch or smaller. When four of these grids 30 are arranged in the square pattern to form the repeat 20′, the repeat 20′ may have an area of 1/300^{th} of an inch by 1/300^{th} of an inch or smaller. In still another example, each of the four sections 32, 32′, 34, 34′, 36, 36′, 38, 38′ has a width W₃₂, W_{32′}, W₃₄, W_{34′}, W₃₆, W_{36′}, W₃₈, W_{38′} equal to the width of each of the thermal resistors in a row of thermal resistors of a thermal printhead and a length L₃₂, L_{32′}, L₃₄, L_{34′}, L₃₆, L_{36′}, L₃₈, L_{38′} equal to the length of each of the thermal resistors. In this example, the grid 30 may have a width W_{G} equal to two times the width of each of the thermal resistors and a length L_{G} equal to two times the length of each of the thermal resistors, and the repeat 20′ may have a width W′ equal to four times the width of each of the thermal resistors and a length L′ equal to four times the length of each of the thermal resistors.

In some examples, each stripe 22, 22′, 24, 24′, 26, 26′, 28, 28′ has a width W₂₂, W_{22′}, W₂₄, W_{24′}, W₂₆, W_{26′}, W₂₈, W_{28′}, or each section 32, 32′, 34, 34′, 36, 36′, 38, 38′ has a width W₃₂, W_{32′}, W₃₄, W_{34′}, W₃₆, W_{36′}, W₃₈, W_{38′} that is greater than the width of a row of thermal resistors of a thermal printhead. In these examples, the line advance of the thermal resistors may be combined (during thermal imaging) to activate a dye from the entire width W₂₂, W₂₄, W₂₆, W₂₈ of a color-forming stripe 22, 24, 26, 28 or from the entire width W₃₂, W₃₄, W₃₆, W₃₈ of a color-forming section 32, 34, 36, 38 and/or to transfer at least the thermal transfer dye from the entire width W_{22′}, W_{24′}, W_{26′}, W_{28′} of a colored stripe 22′, 24′, 26′, 28′ or from the entire width W_{32′}, W_{34′}, W_{36′}, W_{38′} of a colored section 32′, 34′, 36′, 38′.

The repeated pattern is defined by a portion of the color-forming layer 14 of the image-receiving substrate 12 and a portion of the color layer 14′ of the donor ribbon 40. As such, it is to be understood that a portion of the repeated pattern is included in the color-forming layer 14 of the image-receiving substrate 12 and that a remaining portion of the repeated pattern is included in the color layer 14′ of the donor ribbon. In other words, at least one stripe 22, 24, 26, 28 or section 32, 34, 36, 38 of the repeat 20, 20′ is included in the color-forming layer 14, and at least one stripe 22′, 24′, 26′, 28′ or section 32′, 34′, 36′, 38′ of the repeat 20, 20′ is included in the color layer 14′.

In an example, the repeat 20 of the pattern includes one color-forming stripe 24, 26, 28 in the color-forming layer 14 and two colored stripes 24′, 26′, 28′ in the color layer 14′. In another example, the repeat 20 of the pattern consists of one color-forming stripe 24, 26, 28 in the color-forming layer 14 and two colored stripes 24′, 26′, 28′ in the color layer 14′. In still another example, the repeat 20 of the pattern includes two color-forming stripes 24, 26, 28 in the color-forming layer 14 and one colored stripe 24′, 26′, 28′ in the color layer 14′. In yet another example, the repeat 20 of the pattern consists of two color-forming stripes 24, 26, 28 in the color-forming layer 14 and one colored stripe 24′, 26′, 28′ in the color layer 14′.

In an example, the repeat 20 of the pattern includes two color-forming stripes 22, 24, 26, 28 in the color-forming layer 14 and two colored stripes 22′, 24′, 26′, 28′ in the color layer 14′. In another example, the repeat 20, 20′ of the pattern consists of two color-forming stripes 22, 24, 26, 28 in the color-forming layer 14 and two colored stripes 22′, 24′, 26′, 28′ in the color layer 14′. In still another example, the repeat 20 of the pattern includes one color-forming stripe 22, 24, 26, 28 in the color-forming layer 14 and three colored stripes 22′, 24′, 26′, 28′ in the color layer 14′. In yet another example, the repeat 20 of the pattern consists of one color-forming stripe 22, 24, 26, 28 in the color-forming layer 14 and three colored stripes 22′, 24′, 26′, 28′ in the color layer 14′. In still another example, the repeat 20 of the pattern includes three color-forming stripes 22, 24, 26, 28 in the color-forming layer 14 and one colored stripe 22′, 24′, 26′, 28′ in the color layer 14′. In yet another example, the repeat 20 of the pattern consists of three color-forming stripes 22, 24, 26, 28 in the color-forming layer 14 and one colored stripe 22′, 24′, 26′, 28′ in the color layer 14′.

In an example, the repeat 20′ of the pattern includes two color-forming sections 32, 34, 36, 38 in the color-forming layer 14 and two colored sections 32′, 34′, 36′, 38′ in the color layer 14′. In another example, the repeat 20′ of the pattern consists of two color-forming sections 32, 34, 36, 38 in the color-forming layer 14 and two colored sections 32′, 34′, 36′, 38′ in the color layer 14′. In still another example, the repeat 20′ of the pattern includes one color-forming section 32, 34, 36, 38 in the color-forming layer 14 and three colored sections 32′, 34′, 36′, 38′ in the color layer 14′. In yet another example, the repeat 20′ of the pattern consists of one color-forming section 32, 34, 36, 38 in the color-forming layer 14 and three colored sections 32′, 34′, 36′, 38′ in the color layer 14′. In still another example, the repeat 20′ of the pattern includes three color-forming section 32, 34, 36, 38 in the color-forming layer 14 and one colored section 32′, 34′, 36′, 38′ in the color layer 14′. In yet another example, the repeat 20′ of the pattern consists of three color-forming section 32, 34, 36, 38 in the color-forming layer 14 and one colored section 32′, 34′, 36′, 38′ in the color layer 14′.

As mentioned above, the repeated pattern is defined by a portion of the color-forming layer 14 of the image-receiving substrate 12 and a portion of the color layer 14′ of the donor ribbon 40. As such, it is further to be understood that a remaining portion of the color-forming layer 14 of the image-receiving substrate 12 and a remaining portion of the color layer 14′ of the donor ribbon 40 are not part of the repeated pattern. The remaining portion of the color-forming layer 14 may include blank stripe(s) 21 or section(s), which may be adjacent to the colored stripe(s) 22′, 24′, 26′, 28′ or section(s) 32′, 34′, 36′, 38′ of the color layer 14′. Similarly, the remaining portion of the color layer 14′ includes blank stripe(s) 21′ or section(s), which may be adjacent to the color-forming stripe(s) 22, 24, 26, 28 or section(s) 32, 34, 36, 38 of the color-forming layer 14.

In some examples, both the portion of the color-forming layer 14 that is part of the repeated pattern and the remaining portion of the color-forming layer 14 may be color-forming. In these examples, one stripe or one section of the repeated pattern may be part of the color-forming layer 14, and the rest of the stripes or sections may be part of the color layer 14′. In these examples, the remaining portion of the color-forming layer 14 may form (if activated) the same color as the color-forming stripe 22, 24, 26, or 28 or section 32, 34, 36, 38 that partially defines the repeat pattern. As such, in these examples, the entire color-forming layer 14 may be black-forming, cyan-forming, magenta-forming, or yellow-forming. For example, the entire color-forming layer 14 may be cyan-forming. In an example of this, the color-forming layer includes the cyan-forming stripes 24 and the remaining portion of the color-forming layer 14 is cyan-forming. A single color color-forming layer 14 may be used when the color transfer from the donor ribbon 40 occurs at a lower temperature than color formation in the color-forming layer 14. At the lower temperatures, colors from the donor ribbon 40 can be transferred to the image-receiving substrate 12, but the color will not be activated at the color-forming layer 14. As such, the color in the remaining portion of the color-forming layer 14 will not be activated. It is to be understood that in these examples, even though the remaining portion of the color-forming layer 14 is color-forming, the remaining portion is not part of the repeated pattern.

In FIG. 1, one example of the repeated pattern, the color-forming layer 14 and the color layer 14′ is shown. In this example, the color-forming layer 14 includes black-forming stripes 22, cyan-forming stripes 24, and blank stripes 21, and the color layer 14′ includes yellow stripes 28′, magenta stripes 26′, and blank stripes 21′.

The pattern shown in the color-forming layer 14, i.e., black-forming stripe 22, blank stripe 21, cyan-forming stripe 24, blank stripe 21, is repeated throughout the color-forming layer 14 (e.g., in the X and/or Y directions). As such, each black-forming stripe 22 (except for the black-forming stripe 22 at the edge of the imaging medium 10) is adjacent to a blank stripe 21 on one side and adjacent to another blank stripe 21 on another side; each cyan-forming stripe 24 is adjacent to a blank stripe 21 on one side and adjacent to another blank stripe 21 on another side; and each blank stripe 21 in the color-forming layer 14 (except for the blank stripe 21 at the edge of the imaging medium 10) is adjacent to a black-forming stripe 22 on one side and adjacent to a cyan-forming stripe 24 on another side. Further, each black-forming stripe 22 and each cyan-forming stripe 24 is adjacent (e.g., along the X-Y plane of the medium 10) to a blank stripe 21′ in the color layer 14′.

The pattern shown in the color layer 14′, i.e., blank stripe 21′, yellow stripe 28′, blank stripe 21′, magenta stripe 26′, is repeated throughout the color layer 14′ (e.g., in the X and/or Y directions). As such, each yellow stripe 28′ is adjacent to a blank stripe 21′ on one side and adjacent to another blank stripe 21′ on another side; each magenta stripe 26′ (except for the magenta stripe 26′ at the edge of the imaging medium 10) is adjacent to a blank stripe 21′ on one side and adjacent to another blank stripe 21′ on another side; and each blank stripe 21′ in the color layer 14′ (except for the blank stripe 21′ at the edge of the imaging medium 10) is adjacent to a yellow stripe 28′ on one side and adjacent to a magenta stripe 26′ on another side. Further, each yellow stripe 28′ and each magenta stripe 26′ is adjacent (e.g., along the X-Y plane of the medium 10) to a blank stripe 21 in the color-forming layer 14.

In this example, the repeat 20 includes the black-forming stripe 22, the yellow stripe 28′, the cyan-forming stripe 24, and the magenta stripe 26′, wherein the black-forming stripe 22 is adjacent to the yellow stripe 28′, the yellow stripe 28′ is adjacent to the cyan-forming stripe 24, and the cyan-forming stripe 24 is adjacent to the magenta stripe 26′. As such, in this example, the at least three adjacent stripes 22, 24, 26′, 28′ include four adjacent stripes 22, 24, 26′, 28′, and the four adjacent stripes 22, 24, 26′, 28′ are the black-forming stripe 22, the cyan-forming stripe 24, the magenta stripe 26′, and the yellow stripe 28′.

It is to be understood that the repeated pattern, the color-forming layer 14, and the color layer 14′ shown in FIG. 1 are one example, and that other color-forming stripe(s) 26, 28, other colored stripe(s) 22′, 24′, and/or other arrangements of the stripes 22, 22′, 24, 24′, 26, 26′, 28, 28′ may be used to form other examples of the repeated pattern, the color-forming layer 14 and the color layer 14′. Further, it is to be understood that color-forming section(s) 32, 34, 36, 38 and colored section(s) 32′, 34′, 36′, 38′ (in various arrangements) may be used to form still other examples of the repeated pattern, the color-forming layer 14 and the color layer 14′.

Image-Receiving Substrates

The image-receiving substrate 12 of the imaging medium 10 includes a base layer 11 and the color-forming layer 14. In other examples, the image-receiving substrate 12 may include additional components, such as the ink-receiving layer 13. In some of these examples, the image-receiving substrate 12 consists of the base layer 11, the ink-receiving layer 13 and the color-forming layer 14.

The image-receiving substrate 12 includes the color-forming layer 14, which includes dyes that may be activated in portions of the color-forming layer 14 when those portions are selectively exposed to heat. The image-receiving substrate 12 may also receive one or more of the thermal transfer dyes from portions of the color layer 14′ of the donor ribbon 40 when those portions are selectively exposed to heat. As such, the image-receiving substrate 12 may display a colored image after the imaging medium 10 is selectively exposed to heat. In some examples, the image-receiving substrate 12 may display a multicolored image after the imaging medium 10 is selectively exposed to heat.

Base Layers, Ink-Receiving Layers, and Barrier Layers

The base layer 11 of the image-receiving substrate 12 is shown as the top most layer of the imaging medium 10. After printing is performed, the image-receiving substrate 12 may be removed from the donor ribbon 40, and the image that is formed is visible at the surface of the image-receiving substrate 12 that had been in contact with the donor ribbon 40. As such, the base layer 11 may act as a bottom layer or a base of the printed on image-receiving substrate 12. The base layer 11 of the image-receiving substrate 12 may act as a bottom layer or a base of the image-receiving substrate 12, in that other layer(s) (e.g., the color-forming layer 14) of the image-receiving substrate 12 may be formed thereon. The terms top, bottom, lower, upper, on, etc. are used herein to describe the various components of the image-receiving substrate 12, the donor ribbon 40, the repeated pattern, and the imaging medium 10. It is to be understood that these directional terms are not meant to imply a specific orientation, but are used to designate relative orientation between components. The use of directional terms should not be interpreted to limit the examples disclosed herein to any specific orientation(s). As the bottom layer, the base layer 11 may provide structural integrity for the resultant (printed or unprinted) image-receiving substrate 12. In these examples, the image-receiving substrate 12 does not include a back coat.

In some examples (not shown), the image-receiving substrate 12 may include a back coat disposed on the back side (i.e., the side opposed to the side upon which the color-forming layer 14 is to be disposed). In these examples, the back coat may be the bottom layer. Examples of the back coat may reduce or prevent curling of the image-receiving substrate 12, reduce or prevent sticking of sheets of the imaging medium 10 together (e.g., when in a media stack before or after printing), and/or improve the ability of the imaging medium 10 to feed through a printer. In some examples, the back coat may include starch or a polymeric binder. In other examples, the back coat may include denatured polyvinyl alcohols, starch, oxidized starch, urea-phosphorylated starch, styrene-maleic anhydride copolymers, alkyl esters of styrene-maleic anhydride copolymers, styrene-acrylic acid copolymers, or a combination thereof. In still other examples, the denatured polyvinyl alcohols, starch, oxidized starch, urea-phosphorylated starch, styrene-maleic anhydride copolymers, alkyl esters of styrene-maleic anhydride copolymers, styrene-acrylic acid copolymers, or the combination thereof may be included in the back coat in an amount up to 100 wt %, based on the total weight of the back coat.

Examples of the base layer 11 may include natural cellulosic material, synthetic cellulosic material, and a material including one or more polymers. In an example, the base substrate 12 consists of natural cellulosic material, synthetic cellulosic material, or a polymeric material.

Natural cellulosic materials include cellulose fibers, alone or in combination with additives, such as internal sizing agents and fillers.

Synthetic cellulosic materials include, for example, cellulose esters, such as cellulose acetate, cellulose diacetate, cellulose triacetate, cellulose propionate, cellulose butyrate, cellulose acetate butyrate and nitrocellulose. These materials are clear/transparent films that may be suitable for a photobase image-receiving substrate 12.

Polymers that may be suitable for the base layer 11 include polyolefins (e.g., polyethylene, polypropylene), polyesters (e.g., polyethylene terephthalate), polyethers, polyamides, polyimides, ethylene copolymers, polycarbonates, polyurethanes, polyalkylene oxides, polyester amides, polyethylene terephthalate, polystyrene, poly(vinyl acetals), polyalkyloxazolines, polyphenyl oxazolines, polyethylene-imines, polyvinyl pyrrolidones, polyvinyl chloride, polysulfonamides, and combinations thereof. At least some of these materials may be suitable for a photobase type of base layer 11 or a transparent film type of base layer 11. The polymer materials may also be coated on natural or synthetic cellulose materials, and used as a photobase. Further, opaque photographic materials may be used as the base layer 11, including baryta paper, polyethylene-coated papers, and voided polyester.

The base layer 11 may be a non-coated base layer, and may include any of the previously described materials without additional layer(s). In these examples, the ink-receiving layer 13 is not included in the imaging medium 10.

In an example, the base layer 11 may have a substantially uniform thickness. For example, the thickness along substantially the entire length and/or width of the base layer 11 may range from about 20 μm to about 450 μm.

As shown in FIG. 1, the base layer 11 may also be coated. In this example, the image-receiving substrate 12 may include an ink-receiving layer 13 coated on the base layer 11. When the image-receiving substrate 12 includes the ink-receiving layer 13 coated on the base layer 11, the ink-receiving layer 13 may receive the color-forming layer 14. When the image-receiving substrate 12 includes the ink-receiving layer 13 coated on the base layer 11, the ink-receiving layer 13 may also receive one or more of the thermal transfer dye(s) from portions of the color layer 14′, when those portions are exposed to heat. In one example, the image-receiving substrate 12 is a photographic paper that includes the ink-receiving layer 13 coated on the base layer 11.

The ink-receiving layer 13 may include an inorganic pigment, a polymeric co-pigment, a binder, a surfactant, a rheology modifier, a defoamer, an optical brightener, a biocide, a pH controlling agent, or a combination thereof. Other suitable ink-receiving layer additives, such as a dye, a mordant, a binder crosslinking agent, etc. may also be included. The composition that is applied to form the ink-receiving layer 13 may include water, alone or in combination with an organic solvent (e.g., thio diethylene glycol, or the like).

Examples of the inorganic pigment include calcined clay, modified calcium carbonate (MCC), fine and/or ultra-fine ground calcium carbonate (GCC), precipitated calcium carbonate (PCC), silica, and combinations thereof. In an example, the inorganic pigment is selected from the group consisting of calcined clay, modified calcium carbonate (MCC), ultra-fine ground calcium carbonate (GCC), and combinations thereof. An example of the silica is a stable dispersion of fumed silica with its surface modified by an inorganic treating agent (e.g., aluminum chlorohydrate) and a monoaminoorganosilane treating agent (e.g., 3-aminopropyltriethoxysilane, 3-aminopropyltrimethoxysilane, N-butylaminopropyltrimethoxysilane, etc.).

The inorganic pigment may have a median particle size ranging from about 0.05 μm to about 5 μm. In another example, the inorganic pigment has a median particle size ranging from about 0.5 μm to about 2 μm. In still another example, fumed silica may aggregate and have an aggregate size ranging from about 50 to 1000 nm in size. As used herein, the term “particle size”, refers to the diameter of a substantially spherical particle (i.e., a spherical or near-spherical particle having a sphericity of >0.84), or the average diameter of a non-spherical particle (i.e., the average of multiple diameters across the particle).

In an example, the inorganic pigment may be present in the ink-receiving layer 13 in an amount ranging from about 70 wt % to about 90 wt %, based on the total weight of the ink-receiving layer 13.

Examples of the polymeric co-pigment include plastic pigments (e.g., polystyrene, polymethacrylates, polyacrylates, copolymers thereof, and/or combinations thereof). Suitable solid spherical plastic pigments are commercially available from The Dow Chemical Company, e.g., DPP 756A or HS 3020. The amount of polymeric co-pigment that may be present in the ink-receiving layer 13 may range from about 1 part to 10 parts based on 100 parts of inorganic pigments. The amount of polymeric co-pigment may be present in the ink-receiving layer 13 in an amount ranging from about 0.5 wt % to about 8.5 wt %, based on the total dry weight of the ink-receiving layer 13.

Examples of the binder include latex polymers, polyvinyl alcohols and polyvinyl pyrrolidones. The latex polymer may be derived from a number of monomers such as, by way of example and not limitation, vinyl monomers, allylic monomers, olefins, and unsaturated hydrocarbons, and mixtures thereof. Classes of vinyl monomers include, but are not limited to, vinyl aromatic monomers (e.g., styrene), vinyl aliphatic monomers (e.g., butadiene), vinyl alcohols, vinyl halides, vinyl esters of carboxylic acids (e.g., vinyl acetate), vinyl ethers, (meth)acrylic acid, (meth)acrylates, (meth)acrylamides, (meth)acrylonitriles, and mixtures of two or more of the above, for example. The term “(meth) acrylic latex” includes polymers of acrylic monomers, polymers of methacrylic monomers, and copolymers of the aforementioned monomers with other monomers.

Examples of vinyl aromatic monomers that may form the latex polymeric binder include, but are not limited to, styrene, 3-methylstyrene, 4-methylstyrene, styrene-butadiene, p-chloro-methylstyrene, 2-chlorostyrene, 3-chlorostyrene, 4-chlorostyrene, divinyl benzene, vinyl naphthalene and divinyl naphthalene. Vinyl halides that may be used include, but are not limited to, vinyl chloride and vinylidene fluoride. Vinyl esters of carboxylic acids that may be used include, but are not limited to, vinyl acetate, vinyl butyrate, vinyl methacrylate, vinyl 3,4-dimethoxybenzoate, vinyl malate and vinyl benzoate. Examples of vinyl ethers that may be employed include, but are not limited to, butyl vinyl ether and propyl vinyl ether.

In some examples, the binder may be a styrene/butadiene latex copolymer. In some other examples, the binder may be a styrene/butadiene/acrylonitrile latex copolymer. Some examples of the latex polymer/copolymer include aqueous, anionic carboxylated styrene/butadiene copolymer dispersions commercially available under the tradenames LITEX® PX 9710, LITEX® 9720, LITEX® 9730 and LITEX® PX 9740, from Synthomer (Essex, UK), styrene/butadiene/acrylonitrile copolymers commercially available under the tradenames GENCRYL® 9525 and GENCRYL® 9750, from RohmNova (Akron, Ohio), a styrene/butadiene copolymer commercially available under the tradename STR 5401, from Dow Chemical Company (Midland, Mich.), poly(vinyl alcohol) commercially available under the tradenames MOWIOL® 4-98 and MOWIOL®6-98, from Kuraray America, Inc. (Houston, Tex.), and/or combination(s) thereof.

In an example, the binder is present in the ink-receiving layer 13 in an amount ranging from about 5 wt % to about 20 wt %, based on the total weight of the ink-receiving layer 13. In another example, the amount of binder that may be present in the ink-receiving layer 13 may range from about 10 parts to 15 parts based on 100 parts of inorganic pigments.

Suitable surfactants include nonionic surfactants, such as Surfactant 10G (a glycidol surfactant). As examples, the amount of surfactant in the ink-receiving layer 13 may be in the range of about 0.1 parts to about 5 parts based on 100 parts of inorganic pigments and/or may range from about 0.25 wt % to about 1 wt %, based on the total weight of the ink-receiving layer 13.

Suitable rheology modifiers include polycarboxylate-based compounds, polycarboxylated-based alkaline swellable emulsions, or their derivatives. The rheology modifier is helpful for building up the viscosity at certain pH or low shear. In certain examples, a rheology modifier is added to produce a thixotropic and/or pseudoplastic coating formulation. As such, the rheology modifier may maintain a relatively high viscosity under low shear, and to reduce viscosity under high shear. It may be desirable to provide a coating formulation that is relatively more viscous during storage stages and after application (i.e., under low shear), and relatively less viscous during the mixing, pumping, and coating application (i.e., under high shear). Some examples of rheology modifiers include STEROCOLL® FS (from BASF), CARTOCOAT® RM 12 (from Clariant), ACRYSOL® TT-615 (from Rohm and Haas) and ACUMER® 9300 (from Rohm and Haas). The amount of rheology modifier in the ink-receiving layer 13 may be in the range of about 0.1 parts to about 2 parts, or in the range of about 0.1 part to about 0.5 parts, based on 100 parts of inorganic pigments. In another example, the rheology modifier is present in the ink-receiving layer 13 in an amount ranging from about 0.1 wt % to about 0.4 wt %, based on the total weight of the ink-receiving layer 13.

Any suitable defoamer may be used. Suitable defoamers include those commercially available from BASF Corp. under the tradename FOAMMASTER®. The amount of defoamer in the ink-receiving layer 13 may be in the range of about 0.1 parts to about 1 part, or in the range of about 0.1 parts to about 0.5 parts, based on 100 parts of inorganic pigments. In another example, the defoamer is present in the ink-receiving layer 13 in an amount ranging from about 0.2 wt % to about 0.4 wt %, based on the total weight of the ink-receiving layer 13.

Any suitable optical brighteners may be used, such as those commercially available from BASF Corp. under the tradename TINOPAL®. The amount of optical brighteners in the ink-receiving layer 13 may be in the range of about 0.1 parts to about 2 parts, or in the range of about 0.1 parts to about 1 part, based on 100 parts of inorganic pigments. In another example, the optical brightener is present in the ink-receiving layer 13 in an amount ranging from about 0.1 wt % to about 0.4 wt %, based on the total weight of the ink-receiving layer 13.

The ink-receiving layer 13 may also include biocides (i.e., fungicides, anti-microbials, etc.). Example biocides may include the NUOSEPT™ (Troy Corp.), UCARCIDE™ (Dow Chemical Co.), ACTICIDE® B20 (Thor Chemicals), ACTICIDE® M20 (Thor Chemicals), ACTICIDE® MBL (blends of 2-methyl-4-isothiazolin-3-one (MIT), 1,2-benzisothiazolin-3-one (BIT) and Bronopol) (Thor Chemicals), AXIDE™ (Planet Chemical), NIPACIDE™ (Clariant), blends of 5-chloro-2-methyl-4-isothiazolin-3-one (CIT or CMIT) and MIT under the tradename KATHON™ (Dow Chemical Co.), and combinations thereof. Examples of suitable biocides include an aqueous solution of 1,2-benzisothiazolin-3-one (e.g., PROXEL® GXL from Arch Chemicals, Inc.), quaternary ammonium compounds (e.g., BARDAC® 2250 and 2280, BARQUAT® 50-65B, and CARBOQUAT® 250-T, all from Lonza Ltd. Corp.), and an aqueous solution of methylisothiazolone (e.g., KORDEK® MLX from Dow Chemical Co.). In an example, the ink-receiving layer 13 may include a total amount of biocides that ranges from about 0.05 wt % to about 1 wt %, based on the total weight of the ink-receiving layer 13.

Suitable pH controlling agents include metal hydroxide bases, such as sodium hydroxide (NaOH), potassium hydroxide (KOH), etc. The amount of the pH controlling agent may depend upon the desired pH of the composition used to form the ink receiving-layer 13.

In an example, ink-receiving layer 13 may have a substantially uniform thickness. For example, the thickness along substantially the entire length and/or width of the ink-receiving layer 13 may range from about 0.5 μm to about 50 μm.

When the image-receiving substrate 12 includes the ink-receiving layer 13 coated on the base layer 11, the image-receiving substrate 12 may or may not include a barrier layer (e.g., polyethylene) between the base layer 11 and the ink-receiving layer 13 to prevent the color-forming layer 14 from penetrating into the base layer 11. The barrier layer (when included) may also prevent thermal transfer dye(s) from the color layer 14′ from penetrating into the base layer 11, when they are transferred from the color layer 14′ (or portions thereof) to the ink-receiving layer 13 of the image-receiving substrate 12.

In some examples, the barrier layer may include a polyolefin resin, such as high density polyethylene (which has a density ranging from about 0.93 g/mL to about 0.97 g/mL, and may be abbreviated as HDPE), low density polyethylene (which has a density ranging from about 0.91 g/mL to about 0.94 g/mL, and may be abbreviated as LDPE), or polypropylene; copolymers of ethylene with other alkenes, such as linear low density polyethylene; polylactic acid (PLA); polyethylene terephthalate (PET); or a combination thereof. In some of these examples the polyolefin resin, the copolymer of ethylene with other alkenes, polylactic acid, polyethylene terephthalate, or the combination thereof may be included in the barrier in an amount up to 100 wt %, based on the total weight of the barrier layer.

In other examples, the barrier layer may further include an inorganic filler material. Some examples of inorganic filler materials include calcium carbonate, talc, barium sulfate, clay, silica, and TiO₂. In an example, the inorganic filler material is present in the barrier layer in an amount less than 40 wt %, based on the total weight of the barrier layer. In another example, the inorganic filler material is present in the barrier layer in an amount ranging from about 5 wt % to about 15 wt %, based on the total weight of the barrier layer.

The total basis weight of the base layer 11, the ink-receiving layer 13 (when included), and the barrier layer (when included) together may be dependent on the nature of the application of the imaging medium 10, where lighter weights are employed for magazines and tri-folds and heavier weights are employed for postcards, for signage, etc. In some examples, the base layer 11, the ink-receiving layer 13 (when included), and the barrier layer (when included) together have a total basis weight ranging from about 60 grams per square meter (g/m² or gsm) to about 400 gsm, or from about 100 gsm to about 250 gsm.

In an example, the base layer 11, the ink-receiving layer 13 (when included), and the barrier layer (when included) together may have a substantially uniform total thickness. For example, the total thickness along substantially the entire length and/or width of the base layer 11, the ink-receiving layer 13 (when included), and the barrier layer (when included) together may range from about 0.025 mm to about 0.5 mm.

Color-Forming Layers

The color-forming layer 14 is disposed on one side of the base layer 11, as shown in FIG. 1. It is to be understood that, as used herein, the terms “on,” “disposed on”, “formed on”, “deposited on”, “established on”, and the like are broadly defined to encompass a variety of divergent layering arrangements and assembly techniques. These arrangements and techniques include i) the direct attachment of a layer (e.g., the color-forming layer 14) to another layer (e.g., the base layer 11) with no intervening layers therebetween and ii) the attachment of a layer (e.g., the color-forming layer 14) to another layer (e.g., the base layer 11) with one or more layers (e.g., the ink-receiving layer 13) therebetween, provided that the one layer being “on,” “deposited on”, “formed on”, “disposed on”, or “established on” the other layer is somehow supported by the other layer (notwithstanding the presence of one or more additional material layers therebetween). Further, the phrases “directly on,” “disposed directly on”, “formed directly on”, “deposited directly on”, “established directly on” and/or the like are broadly defined herein to encompass a situation(s) wherein a given layer (e.g., the color-forming layer 14) is secured to another layer (e.g., the base layer 11) without any intervening layers therebetween. It is to be understood that the characterizations recited above are to be effective regardless of the orientation of the imaging medium materials under consideration.

In an example of the image-receiving substrate 12, the color-forming layer 14 is on the base layer 11. In another example of the image-receiving substrate 12, the color-forming layer 14 is directly on the base layer 11. In still another example of the image-receiving substrate 12, the color-forming layer 14 is on the ink-receiving layer 13. In yet another example of the image-receiving substrate 12, the color-forming layer 14 is directly on the ink-receiving layer 13.

In some examples, the color-forming layer 14 is at least partially absorbed into the base layer 11, a portion of the base layer 11, the ink-receiving layer 13, or a portion of the ink-receiving layer 13. When the color-forming layer 14 is partially or fully absorbed into the base layer 11, the color-forming layer 14 is still considered to be on the base layer 11. Similarly, when the color-forming layer 14 is partially or fully absorbed into the ink-receiving layer 13, the color-forming layer 14 is still considered to be on the ink-receiving layer 13.

In some examples, the color-forming layer 14 includes at least one color-forming stripe 24, 26, 28 selected from the group consisting of a cyan-forming stripe 24, a magenta-forming stripe 26, and a yellow-forming stripe 28. In other examples, the color-forming layer 14 includes at least one color-forming stripe 22, 24, 26, 28 selected from the group consisting of a black-forming stripe 22, a cyan-forming stripe 24, a magenta-forming stripe 26, and a yellow-forming stripe 28. The color-forming stripe(s) 22, 24, 26, 28 of the color-forming layer 14 may be any of the color-forming stripe(s) 22, 24, 26, 28 described above in reference to the repeated pattern.

In some examples, the color-forming layer 14 includes at least one color-forming section 34, 36, 38 selected from the group consisting of a cyan-forming section 34, a magenta-forming section 36, and a yellow-forming section 38. In other examples, the color-forming layer 14 includes at least one color-forming section 32, 34, 36, 38 selected from the group consisting of a black-forming section (an example of the color-forming section 32), a cyan-forming section 34, a magenta-forming section 36, and a yellow-forming section 38. In still other examples, the color-forming layer 14 includes at least one color-forming section 32, 34, 36, 38 selected from the group consisting of a black-forming section (an example of the color-forming section 32), a cyan-forming section 34, a light cyan-forming section (an example of the color-forming section 32), a magenta-forming section 36, a light magenta-forming section (an example of the color-forming section 32), and a yellow-forming section 38. The color-forming section(s) 32, 34, 36, 38 of the color-forming layer 14 may be any of the color-forming section(s) 32, 34, 36, 38 described above in reference to the repeated pattern.

It is to be understood that in some examples, the color-forming layer 14 may also include blank stripes 21 or sections so that thermal transfer dye(s) from the color layer 14′ of the donor ribbon 40 may be transferred to the base layer 11 or the ink-receiving layer 13. These blank stripes 21 or sections may be devoid of the components of the color-forming layer 14, and may have the same dimensions of the colored stripes 22′, 24′, 26′, 28′ or colored sections 32′, 34′, 36′, 38′ of the color layer 14′ that are to be in contact therewith when the imaging medium 10 is assembled. As such, the color-forming layer 14 may be non-continuous.

As briefly mentioned above, in some examples, the color-forming layer 14 may be a continuous layer of a single color-forming material. In these examples, the color-forming material may be activatable at a temperature higher than the temperature at which the colored stripes 22′, 24′, 26′, 28′ or colored sections 32′, 34′, 36′, 38′ of the color layer 14′ are transferrable. As such, the portion of the color-forming layer 14 in contact with the colored stripes 22′, 24′, 26′, 28′ or colored sections 32′, 34′, 36′, 38′ of the color layer 14′ may remain non-activated when the colored stripes 22′, 24′, 26′, 28′ or colored sections 32′, 34′, 36′, 38′ of the color layer 14′ are transferred to the image-receiving substrate 12.

In some examples, the color-forming layer 14 of the image-receiving substrate 12 includes a leuco dye. In an example, the leuco dye may be selected from the group consisting of triphenylmethane dyes, sulfur dyes, indigo dyes, and combinations thereof. The total amount of leuco dye(s) present in the color-forming layer 14 may range from about 10 wt % to about 70 wt %, based on the total weight of the color-forming layer 14. In another example, the total amount of leuco dye(s) present in the color-forming layer 14 may range from about 10 wt % to about 40 wt %, based on the total weight of the color-forming layer 14.

When the color-forming layer 14 includes more than one color-forming stripe 22, 24, 26, 28 or section 32, 34, 36, 38, one or more color-forming stripe 22, 24, 26, 28 or section 32, 34, 36, 38 may include a higher or lower amount of leuco dye than one or more of the other color-forming stripes 22, 24, 26, 28 or sections 32, 34, 36, 38 in the color-forming layer 14. For example, when the repeat 20′ of the pattern includes the grid 30, the grid includes the color-forming section(s) 32, and the color-forming section(s) 32 is/are light cyan-forming, the color-forming section(s) 32 may include a lower amount of leuco dye than the cyan-forming section(s) 34. As another example, when the repeat 20′ of the pattern includes the grid 30, the grid includes the color-forming section(s) 32, and the color-forming section(s) 32 is/are light magenta-forming, the color-forming section(s) 32 may include a lower amount of leuco dye than the magenta-forming section(s) 36.

When the color-forming layer 14 includes the leuco dye, a portion of the repeated pattern may be formed by one or more leuco dyes that turn, respectively, black, cyan, magenta, and yellow in color when activated. As such, when included in the color-forming layer 14, the black-forming stripe(s) 22 or section(s) may include a leuco dye that turns black when activated, the cyan-forming stripe(s) 24 or section(s) 34 may include a leuco dye that turns cyan when activated, the magenta-forming stripe(s) 26 or section(s) 36 may include a leuco dye that turns magenta when activated, and the yellow-forming stripe(s) 28 or section(s) 38 may include a leuco dye that turns yellow when activated. When the repeat 20′ of the pattern includes the grid 30, the grid 30 includes the color-forming section 32, and the color-forming section 32 is cyan-forming or light cyan-forming, the color-forming section 32 may include the colorless to cyan dye. When the repeat 20′ of the pattern includes the grid 30, the grid 30 includes the color-forming section 32, and the color-forming section 32 is yellow-forming, the color-forming section 32 may include the colorless to yellow dye. When the repeat 20′ of the pattern includes the grid 30, the grid 30 includes the color-forming section 32, and the color-forming section 32 is magenta-forming or light magenta-forming, the color-forming section 32 may include the colorless to magenta dye.

It is to be understood that a combination of leuco dyes may be used together in any one stripe 22, 24, 26, 28 or section 32, 34, 36, 38 in the color-forming layer 14. The leuco dyes of a combination may individually exhibit different colors/hues (when activated), but when used together in the combination exhibit the desired color/hue (when activated). For example, a combination of blue, red, and/or violet leuco dyes may be included in the magenta-forming stripe(s) 26 or section(s) 36, and those stripe(s) 26 or section(s) 36 turn magenta when activated. Prior to being activated, the leuco dyes in the color-forming layer 14 are colorless (i.e., achromatic). As such, the color-forming layer 14 may appear to be white, the color of the base layer 11, or the color of the ink-receiving layer 13 prior to activation.

In the examples disclosed herein, heat activates the leuco dye(s). Heat triggers a reaction that causes the otherwise colorless leuco dye to form color. In some examples, heat causes a separate developer molecule to diffuse to the leuco dye where an intermolecular reaction takes place between the developer molecule and the leuco dye to generate the color. In other examples, the heat may cause the leuco dye to undergo an intra-molecular reaction that generates the color. In these other examples, these leuco dyes may be used without a separate color-developer molecule. For example, the leuco dye molecule may include a group, such as an acid group, that undergoes the intra-molecular reaction when exposed to heat. This intra-molecular reaction activates the leuco dye and causes it to exhibit a color.

Since heat activates the leuco dye(s), heat also activates the corresponding color-forming stripe(s) 22, 24, 26, 28 or the corresponding color-forming section(s) 32, 34, 36, 38. The color-forming stripe(s) 22, 24, 26, 28 or the color-forming section(s) 32, 34, 36, 38 that is/are heat activated form a respective color. For example, when included in the color-forming layer 14, the black-forming stripe(s) 22 or the color-forming section(s) 32 (when black-forming) turn black when activated by the heat, the cyan-forming stripe(s) 24, or the cyan-forming section(s) 34 and the color-forming section(s) 32 (when cyan-forming or light cyan-forming) turn cyan (or light cyan) when activated by the heat, the magenta-forming stripe(s) 26, or the magenta-forming section(s) 36 and the color-forming section(s) 32 (when magenta-forming or light magenta-forming) turn magenta (or light magenta) when activated by the heat, and the yellow-forming stripe(s) 28, or the yellow-forming section(s) 38 and the color-forming section(s) 32 (when yellow-forming) turn yellow when activated by the heat.

In some examples, the color-forming layer 14 includes more than one color-forming stripe 22, 24, 26, 28 or section 32, 34, 36, 38, and each color-forming stripe 22, 24, 26, 28 or section 32, 34, 36, 38 forms a respective color under the same heat exposure conditions. In some of these examples, each color-forming stripe 22, 24, 26, 28 or section 32, 34, 36, 38 forms a respective color under the same heat exposure conditions under which the colored stripes 22′, 24′, 26′, 28′ or sections 32′, 34′, 36′, 38′ in the color layer 14′ transfer to the image-receiving substrate 12. In these examples, the heat exposure conditions include heating to a temperature ranging from about 70° C. to about 300° C. for a time period ranging from about 10 μs to about 200 μs. In some other of these examples, the heat exposure conditions include heating to a temperature ranging from about 70° C. to about 200° C. for a time period ranging from about 10 μs to about 200 μs. In still some other of these examples, the heat exposure conditions include heating to a temperature ranging from about 70° C. to about 100° C. for a time period ranging from about 10 μs to about 200 μs. In yet some other of these examples, the heat exposure conditions include heating for a time period of about 100 μs. The low end of the temperature range for dye activation (i.e., the low end of the heating conditions) may be high enough to prevent premature color activation (e.g., to prevent the dyes from activating during shipping and/or handling). The heat exposure conditions may also include heating to a temperature low enough (e.g., 100° C.) for fast, low energy thermal imaging.

In other examples, one color-forming stripe 22, 24, 26, 28 or one section 32, 34, 36, 38 forms a color at a higher temperature than the temperature(s) at which the colored stripes 22′, 24′, 26′, 28′ or colored sections 32′, 34′, 36′, 38′ in the color layer 14′ transfer to the image-receiving substrate 12. In these examples, the heat exposure conditions include heating predetermined colored stripe(s) 22′, 24′, 26′, 28′ or colored section 32′, 34′, 36′, 38′ to a first lower temperature for a time period sufficient to transfer dye(s) from the colored stripe(s) 22′, 24′, 26′, 28′ or section(s) 32′, 34′, 36′, 38′ to adjacent area(s) of the image-receiving substrate 12, and then heating predetermined color-forming stripe(s) 22, 24, 26, 28 or section(s) 32, 34, 36, 38 to a second higher temperature for a time period sufficient to activate dye(s) in the color-forming stripe(s) 22, 24, 26, 28 or section(s) 32, 34, 36, 38. In these examples, the entire color-forming layer 14 may be the same composition as the one color-forming stripe 22, 24, 26, 28 or one section 32, 34, 36, 38, but is not activated due to the higher activation temperature.

As noted above, in some examples, the leuco dye develops color as the result of an intermolecular reaction upon heat exposure. In these examples, the color-forming layer 14 further includes a color-developer (e.g., a phenol derivative). As discussed herein, the color-developer (in response to heat exposure) may facilitate the activation of the leuco dye to its colored form. In an example, the total amount of color-developer(s) present in the color-forming layer 14 may range from about 10 wt % to about 65 wt %, based on the total weight of the color-forming layer 14. It is believed that an amount of the color-developer within this range may be sufficient to facilitate the activation of the leuco dye to its colored form. The color-developer may be separated from the leuco dye in the color-forming layer 14 prior to activation of the leuco dye, for example, by microencapsulation. The color-developer may be brought into contact with the leuco dye through diffusion, which may occur when the color-forming layer 14 is exposed to heat. In these examples, the leuco dye may be considered to be activated by heat.

Examples of leuco dyes that may be used in combination with a color-developer include fluoran compounds, phthalide compounds, phenothiazine compounds, indolylphthalide compounds, leuco-auramine compounds, rhodamine-lactam compounds, triphenylmethane compounds, triazene compounds, spiropyran compounds, pyridine compounds, pyrazine compounds, and fluorene compounds.

Examples of fluoran compounds include 2-(dibenzylamino)fluoran, 2-anilino-3-methyl-6-diethylaminofluoran, 2-anilino-3-methyl-6-dibutylaminofluoran, 2-anilino-3-methyl-6-N-ethyl-N-isoamylaminofluoran, 2-anilino-3-methyl-6-N-methyl-N-cyclohexylaminofluoran, 2-anilino-3-chloro-6-diethylaminofluoran, 2-anilino-3-methyl-6-N-ethyl-N-isobutylaminofluoran, 2-anilino-6-dibutylaminofluoran, 2-anilino-3-methyl-6-N-ethyl-N-tetrahydrofurfurylaminofluoran, 2-anilino-3-methyl-6-piperidinoaminofluoran, 3-piperidino-6-methyl-7-anilinofluoran, 2-(o-chloroanilino)-6-diethylaminofluoran, and 2-(3,4-dichloroanilino)-6-diethylaminofluoran, etc.

When the leuco dye is a fluoran compound, the leuco dye may undergo a ring opening reaction when activated. An example of a fluoran compound undergoing a ring opening reaction (e.g., in the presence of an acidic color-developer) is shown below:

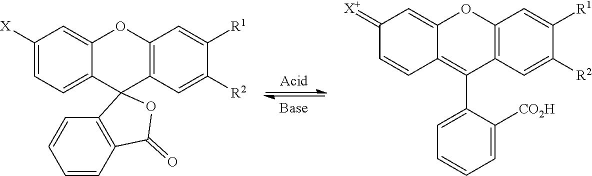

In this example, the fluoran compound is colorless prior to the ring opening reaction, and exhibits a color (e.g., black, cyan, magenta, or yellow) after the ring opening reaction. The color that develops depends, in part, on the substituent(s) attached to the compound.

The fluoran compound may be yellow after the ring opening reaction when the fluoran compound is a dialkoxy fluoran (e.g., X=OR, R¹=OR, and R²=CH₃, where R is H or a hydrocarbon, or X=NR³R⁴ where R²-R⁴ may also form a ring structure, R¹=OR, and R is H or a hydrocarbon). The fluoran compound may be orange after the ring opening reaction when the fluoran compound is a mono-alkylamine derivative (e.g., X=NHcyclohexyl, R¹=Cl, and R²=H). The fluoran compound may be red after the ring opening reaction when the fluoran compound is a mono-dialkylamine (e.g., X=NEt₂, R¹=CH₃, and R²=H). The fluoran compound may be blue after the ring opening reaction when the fluoran compound is a bis-diarylamine (e.g., X=NAr₂, R¹=NAr₂, and R²=H).

The fluoran compound may be green after the ring opening reaction when, e.g., X=NEt₂, R¹=H, and R²=NEt₂. One specific example of a colorless to green fluoran compound is 2-(dibenzylamino)fluoran. Another specific example of a colorless to green fluoran compound is 2′-di(phenylmethyl)amino-6′-(diethylamino)spiro(isobenzofuran-1(3H),9′-(9H)xanthen)-3-one (also known as copikem 5 green). Copikem 5 green (C₃₈H₃₄N₂O₃) has a molecular weight of 566.4 g/mol, and a chemical structure of:

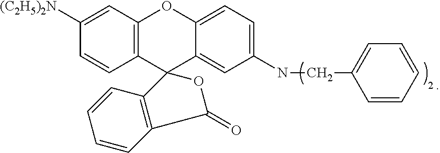

In some examples, the fluoran compound may be black after the ring opening reaction when, e.g., X=NEt₂, R¹=H, and R²=NHAr. In an example, a colorless to black fluoran compound may be synthesized by reacting 4-alkoxydiphenylamines with the keto acids in sulfuric acid to give the intermediate phthalides, which may be converted into the fluorans by reaction with sodium hydroxide. Specific examples of colorless to black fluoran compounds include 2-anilino-3-methyl-6-diethylaminofluoran and 2-anilino-3-methyl-6-dibutylaminofluoran. Another specific example of a colorless to black fluoran compound is 2′phenylamino-3′-methyl-6′-(dibutylamino)-spiro[isobenzofuran-1 (3H), 9′-(9H)-xanthen]-3-one (also known as specialty black 34). Specialty black 34 (C₃₅H₃₂N₂O₃) has a molecular weight of 532 g/mol, a melting point of 179° C., and a chemical structure of:

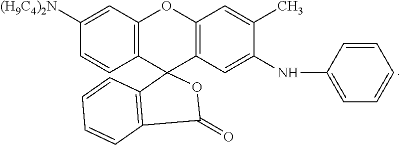

Still another specific example of a colorless to black fluoran compound is 6-(diethylamino)-3′-methyl-2′-(phenylamino)spiro(isobenzofuran-1 (3H),9′-(9H)xanthen)-3-one (also known as copikem 4 black, N102). Copikem 4 black (C₃₁H₂₈N₂O₃) has a molecular weight of 776.6 g/mol, a melting point of 193° C., and a chemical structure of:

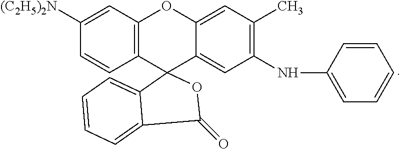

In some examples, the activation (i.e., the ring opening reaction) of the fluoran compound may be facilitated with a phenol derivative color-developer. An example of the fluoran compound (i.e., triarylmethane type dyes), such as aminotriarylmethane, undergoing a ring opening reaction in the presence of a phenol derivative and heat is shown below:

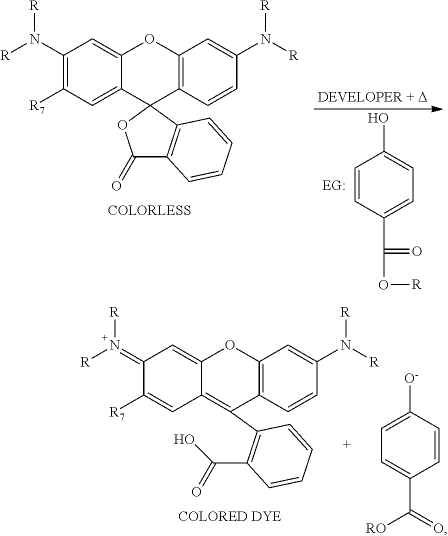

where each R is H or a hydrocarbon, and R₇ is H.

Examples of phthalide compounds include 3,3-bis(p-dimethylaminophenyl)-6-dimethylaminophthalide, 3,3-bis(p-diethylamino-o-butoxyphenyl)-4-azaphthalide, 3-(p-diethylamino-o-butoxyphenyl)-3-(1-pentyl-2-methylindol-3-yl)-4-azaphthalide, 3-(p-dipropylamino-o-methylphenyl)-3-(1-octyl-2-methylindol-3-yl)-5-aza (or -6-aza, or -7-aza)phthalide, etc.

Examples of phenothiazine compounds include benzoylleucomethylene blue, p-nitrobenzylleucomethylene blue, aminophenothiazine, etc.

Examples of leuco-auramine compounds include 4,4′-bisdimethylaminobenzhydrin benzyl ether, N-halophenyl-leucoauramine, N-2,4,5-trichlorophenyl-leucoauramine, etc.

Examples of rhodamine-lactam compounds include rhodamine-B-anilinolactam, rhodamine-(p-nitrino)lactam, etc.

Examples of spiropyran compounds include 3-methyl-spiro-dinaphthopyran, 3-ethyl-spiro-dinaphthopyran, 3,3′-dichlcoro-spiro-dinaphthopyran, 3-benzylspiro-dinaphthopyran, 3-methyl-naphtho-(3-methoxybenzo)spiropyran, 3-propyl-spiro-dibenzopyran, etc.

An example of a triphenylmethane compound includes 4-di(4′-dimethylaminophenyl)methyl-N,N-dimethylbenzenamine (also known as leuco crystal violet). Leuco crystal violet (C₂₅H₃₁N₃) has a molecular weight of 373.54 g/mol, a melting range from 173.0° C. to 180.0° C., and a chemical structure of:

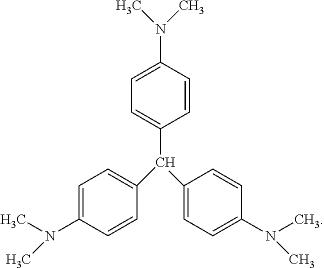 [SMILES: CN(C)c1ccc(C(c2ccc(N(C)C)cc2)c2ccc(N(C)C)cc2)cc1]

An example of a pyridine compound includes copikem 37 yellow. Copikem 37 yellow has a chemical structure of:

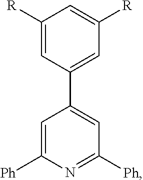

wherein each Ph is a phenyl group, and each R is H or a hydrocarbon.

Examples of black leuco dyes that can be used with a color-developer include spiro[isobenzofuran-1(3H),9′-[9H]xanthen]-3-one, 6′-(dipentylamino)-3′-methyl-2′-(phenylamino)—(also known as Black 305); spiro[isobenzofuran-1(3H),9′-[9H]xanthen]-3-one,6′-[ethyl(4-methylphenyl)amino]-3′-methyl-2′-(phenylamino)—(also known as ODB-250, ETAC); spiro[isobenzofuran-1(3H),9′-[9H]xanthen]-3-one, 6′-[ethyl(3-methylbutyl)amino]-3′-methyl-2′-(phenylamino)—(also known as S-205); 1(3H)-Isobenzofuranone,4,5,6,7-tetrachloro-3,3-bis[2-[4-(dimethylamino)phenyl]-2-(4-methoxyphenyl)ethenyl]—(also known as NIR Black 78); and spiro[isobenzofuran-1(3H),9′-[9H]xanthen]-3-one, 6′-[(3-ethoxypropyl)ethylamino]-3′-methyl-2′-(phenylamino)-(93071-94-4) (also known as Black 500).

Another example of a black leuco dye is spiro[isobenzofuran-1(3H),9′-[9H]xanthen]-3-one, 6′-(diethylamino)-3′-methyl-2′-(phenylamino)—(also known as 2-Anilino-6-diethylamino-3-methylfluoran and ODB). ODB (C₃₁H₂₈N₂O₃) has a chemical structure of:

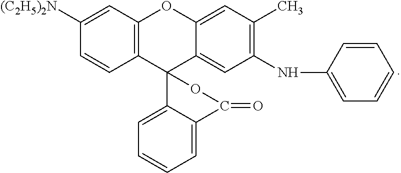

Still another example of a black leuco dye is spiro[isobenzofuran-1(3H),9′-[9H]xanthen]-3-one, 6′-(dibutylamino)-3′-methyl-2′-(phenylamino)—(also known as 2-Anilino-6-dibutylamino-3-methylfluoran and ODB-2). ODB-2 (C₃₅H₃₆N₂O₃) has a chemical structure of:

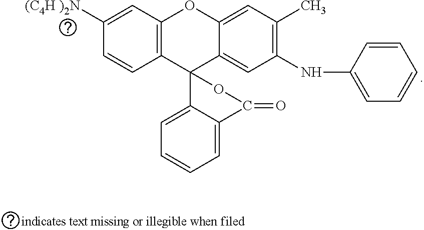

Yet another example of a black leuco dye is spiro[isobenzofuran-1(3H),9′-[9H]xanthen]-3-one, 6′-(diethylamino)-3′-methyl-2′-[(3-methylphenyl)amino]—(also known as 6-diethylamino-3-methyl-2-(3-toluidino)-fluoran and ODB-7). ODB-7 (C₃₂H₃₀N₂O₃) has a chemical structure of:

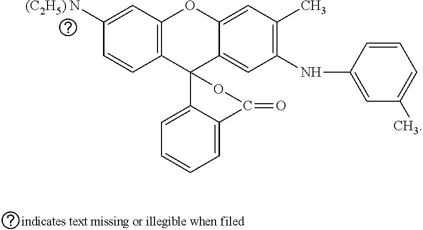

Yet another example of a black leuco dye is 6-diethylamino-3-methyl-2-(2,4-xylidino)-fluoran (also known as Black-15). Black-15 (C₃₃H₃₂N₂O₃) has a chemical structure of:

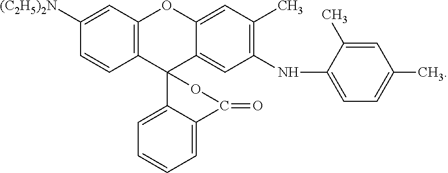

Yet another example of a black leuco dye is 6-diethylamino-3-methyl-2-(2,6-xylidino)-fluoran (also known as Black-173). Black-173 (C₃₃H₃₂N₂O₃) has a chemical structure of:

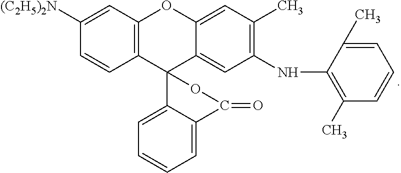

Examples of green leuco dyes that can be used with a color-developer include furo[3,4-b]pyridin-5(7H)-one, 7,7-bis[4-(diethylamino)-2-ethoxyphenyl]—(also known as 3,3-Bis(4-diethylamino-2-ethoxyphenyl)-4-azaphthalide GN-2); and spiro[isobenzofuran-1(3H),9′-[9H]xanthen]-3-one, 6′-[ethyl(4-methylphenyl)amino]-2′-(methylphenylamino)—(also known as ATP).

Examples of magenta or red leuco dyes that can be used with a color-developer include copikem 16 magenta; spiro[12H-benzo[a]xanthene-12,1′(3′H)-isobenzofuran]-3′-one, 9-[ethyl(3-methylbutyl)amino]—(also known as Red 500); and spiro[isobenzofuran-1(3H),9′-[9H]xanthen]-3-one, 6′-[ethyl(4-methylphenyl)amino]-2′-methyl-(also known as Red 520). Another example of a magenta leuco dye is 3,3-Bis(1-ethyl-1-2-methyl-1H-indol-3-yl)-1-(3H)-isobenzofuranone (also known as specialty magenta 3). Specialty magenta 3 (C₃₀H₂₈O₂) has a molecular weight of 449 g/mol, and a chemical structure of:

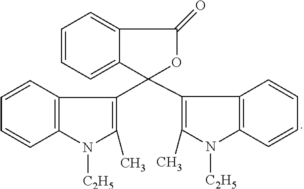 [SMILES: CCn1c(C)c(C2(c3c(C)n(CC)c4ccccc34)OC(=O)c3ccccc32)c2ccccc21]

Still another example of a magenta leuco dye is 3,3-bis(1-butyl-2-methyl-1H-indol-3-yl)-1-(3H)-isobenzofuranone (also known as copikem 20 magenta). Copikem 20 magenta (C₃₄H₃₆N₂O₂) has a molecular weight of 468.3 g/mol, and a chemical structure of:

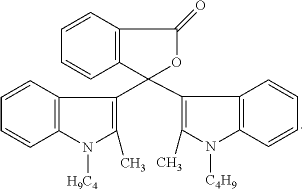

Yet another example of a magenta leuco dye is 3-(1-butyl-2-methylindol-3-yl)-3-(1-octyl-2-methylindol-3-yl)-1 (3H)-isobenzofuranone (also known as copikem 35 magenta). Copikem 35 magenta (C₃₈H₄₄N₂O₂) has a molecular weight of 544.4 g/mol, and a chemical structure of:

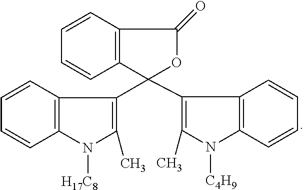

Examples of cyan, blue, violet, or grape leuco dyes that can be used with a color-developer include 3-(4-diethylamino-2-methylphenyl)-3-(1-ethyl-2-methyl-1H-indol-3-yl)-4-azaphthalide (also known as Blue 220); and 7-[4-(diethylamino)-2-hexoxyphenyl]-7-(1-ethyl-2-methylindol-3-yl)furo[3,4-b]pyridin-5-one (also known as Blue 203). Another example of a violet leuco dye is 1(3H)-isobenzofuranone, 6-(dimethylamino)-3,3-bis[4-(dimethylamino)phenyl]—(also known as 3,3-bis(4-dimethylaminophenyl)-6-dimethylaminophthalide, crystal violet lactone, and CVL). Crystal violet lactone (C₂₆H₂₉N₃O₂) has a molecular weight of 415.6 g/mol, and a chemical structure of:

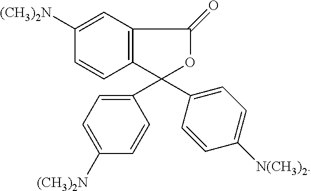

Another example of a cyan leuco dye is copikem 36 cyan. Copikem 36 cyan has a melting point of 134° C., and a chemical structure of:

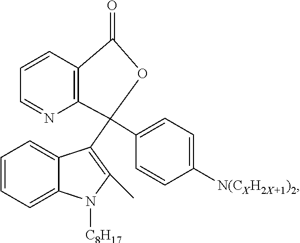

wherein x is varied to control melting point of the leuco dye, and, for example, is an integer ranging from 1 to 10. Another example of a grape leuco dye is copikem 7 grape. Copikem 7 grape has a chemical structure of:

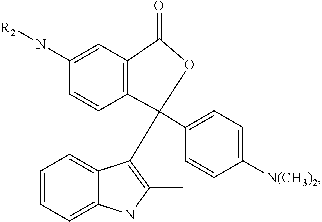

wherein R is C₃H₇. Another example of a blue leuco dye is 3-(4-diethylamino-2-ethoxyphenyl)-3-(1-ethyl-2-methylindol-3-yl)-4-azaphthalide (also known as Blue-63). Blue-63 (C₃₀H₃₃N₃O₃) has a chemical structure of:

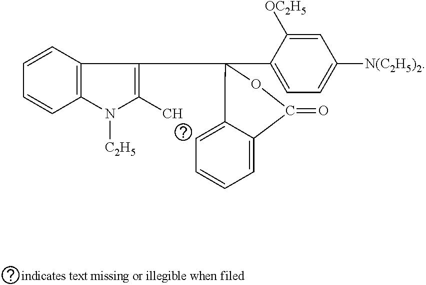

Still another example of a blue leuco dye is 3-(4-diethylaminophenyl)-3-(1-ethyl-2-methylindol-3-yl)phthalide (also known as Blue-502). Blue-502 (C₂₉H₃₀N₂O₂) has a chemical structure of:

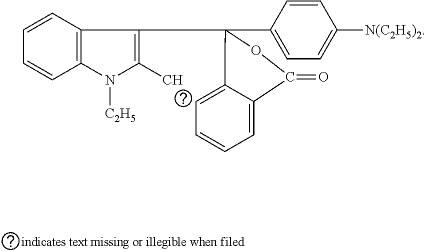

Examples of the color-developer that can be used with the leuco dyes include phenolic derivatives, salicylic acid derivatives, metal salts of aromatic carboxylic acids, acid clay activators (e.g., bentonite, Japanese Acid Clay, other montmorillonite containing clays, etc.), novolac resins (i.e., phenol-formaldehyde resins), metal-processed novolac resins, metal complexes, etc. Some specific examples of the color-developer include 2,2′-methylenebis(6-tert-butyl-4-methylphenol), 2,2′-methylenebis(6-tert-Butyl-4-Ethyl-Phenol), 2,2′-ethylidenebis(4,6-di-tert-butylphenol), bis[2-hydroxy-5-methyl-3-(1-methylcyclohexyl)phenyl]-methane, 1,3,5-tris(2,6-dimethyl-3-hydroxy-4-tert-butylbenzyl) isocyanurate, 2,6-bis[[3-(1,1-dimethylethyl)-2-hydroxy-5-methylphenyl]methyl]-4-methyl-phenol, 2,2′-butylidenebis[6-(1,1-dimethylethyl)-4-methyl-phenol, trimethylhexylidene)bis[4,6-dimethyl-phenol], 2,2′-methylenebis[4,6-bis(1,1-dimethylethyl)-phenol, 2,2′-(2-methylpropylidene)bis[4,6-dimethyl-phenol], 1,1,3-tris(2-methyl-4-hydroxy-5-t-butylphenyl)butane, tris(3,5-di-t-butyl-4-hydroxybenzyl)isocyanurate, 2,2′-thiobis(4-tert-octylphenol), 3-tert-butyl-4-hydroxy-5-methylphenyl sulfide, p-tert-butylphenol, p-phenylphenol, 4,4′-thiodiphenol, 2,2-bis(p-hydroxyphenyl) propane (also known as bisphenol A and BPA), bis(4-hydroxyphenyl)methane (also known as bisphenol F and BPF), 2′-Bis(4-hydroxy-3-methylphenyl)propane (also known as bisphenol C and BPC), 4,4′-(1-phenylethylidene)bisphenol (also known as bisphenol AP and BPAP), 4-hydroxyphenyl sulfone (also known as bisphenol S), 2,4′-bis(hydroxyphenyl)sulfone (also known as 2,4,-BPS), bis-(3-allyl-4-hydroxyphenyl) sulfone (also known as TGSA), phenol, 4-[[4-(2-propen-1-yloxy)phenyl]sulfonyl]—(also known as BPS-MAE), 4-hydroxy-4′-benzyloxydiphenylsulfone (also known as BPS-MPE), 4-hydroxyphenyl 4-isoprooxyphenylsulfone, 4-[4′-[(1′-methylethyloxy)phenyl]sulfonyl]phenol, 4,4′-isopropyllidenebis(2-phenylphenol) (also known as BisOPP-A), 1,1-bis(p-hydroxyphenyl) pentane, 1,7-bis(4-Hydroxyphenylthio)-3,5-dioxaheptane, N-(p-toluenesulfonyl)-N′-(3-p-toluenesulfonyloxyphenyl)urea, 4,4′-bis(N-carbamoyl-4-methylbenzenesulfonamide)diphenylmethane, methyl bis(4-hydroxyphenyl)acetate (also known as MBHA), dimethyl-4-hydroxyphthalate (also known as DMP-OH), benzyl 4-hydroxybenzoate (also known as PHBB), ethyl-p-hydroxybenzoate ethyl paraben, p-hydroxybenzoic acid, benzoic acid, gallic acid, boric acid, ethanedioic acid (also known as oxalic acid), octadecanoic acid (also known as stearic acid), p-octadecylphosphonic acid, and 3,5-di-tert-butylsalicylic acid.

While several examples of leuco dyes and developers have been provided, it is to be understood that any suitable leuco dyes and developers known in the art may be used. Some example combinations of leuco dyes and developers include the following. One specific example of a cyan leuco dye is 7-(1-butyl-2-methyl-1H-indol-3-yl)-7-(4-diethylamino-2-methyl-phenyl)-7H-furo[3,4-b]pyridin-5-one (available from Hilton-Davis Co., Cincinnati, Ohio). This cyan leuco dye may be used with a color-developer selected from the group consisting of a zinc salt of 3,5-di-t-butyl salicylic acid (available from Aldrich Chemical Co., Milwaukee, Wis.), bis(3-allyl-4-hydroxyphenyl)sulfone (available from Nippon Kayaku Co., Ltd, Tokyo, Japan), and a combination thereof. One specific example of a magenta leuco dye is 3,3-bis(1-n-butyl-2-methyl-indol-3-yl)phthalide (Red 40, available from Yamamoto Chemical Industry Co., Ltd., Wakayama, Japan). This magenta leuco dye may be used with a color-developer selected from the group consisting of bis(3-allyl-4-hydroxyphenyl)sulfone, PHS-E, a grade of poly(hydroxy styrene (available from TriQuest, LP, a subsidiary of ChemFirst Inc., Jackson, Miss.), and a combination thereof. Specific examples of yellow leuco dyes include 1-(2,4-dichloro-phenylcarbamoyl)-3,3-dimethyl-2-oxo-1-phenoxy-butyl]-(4-diethylamino-phenyl)-carbamic acid isobutyl ester and Pergascript Yellow I-3R (available from Ciba Specialty Chemicals Corporation, Tarrytown, N.Y.). The yellow leuco dye, 1-(2,4-dichloro-phenylcarbamoyl)-3,3-dimethyl-2-oxo-1-phenoxy-butyl]-(4-diethylamino-phenyl)-carbamic acid isobutyl ester, may be used without a color-developer. The yellow leuco dye, Pergascript Yellow I-3R, may be used with a zinc salt of 3-octyl-5-methyl salicylic acid as the color-developer.

Examples of leuco dyes that may be used without a color-developer (and thus can undergo an intra-molecular reaction when exposed to heat) include amorphochromic dyes. In an example of the imaging medium 10, the leuco dye is an amorphochromic dye.

Amorphochromic dyes may undergo a ring opening reaction when activated with heat to produce a colored tautomer. An example of an amorphochromic dye undergoing a ring opening reaction in the presence of heat is shown below:

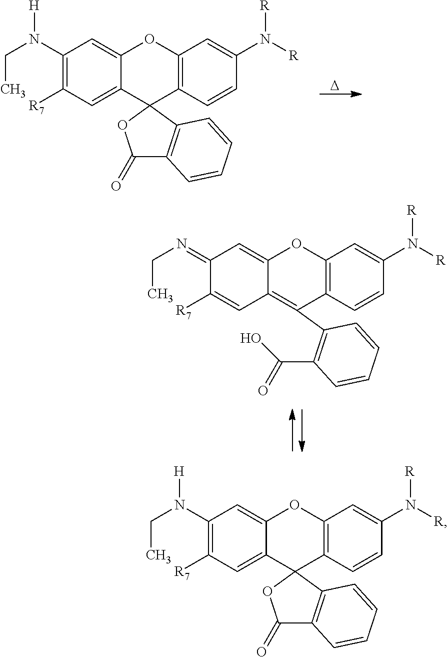

where each R is H or a hydrocarbon, and R₇ is H. In this example, the amorphochromic dye is colorless prior to the ring opening reaction, and exhibits a color after the ring opening reaction. The color that develops depends, in part, on the substituent(s) attached to the compound.

As shown in the reaction, after activation by heat, the amorphochromic dye maintains an equilibrium between its colorless form (i.e., closed ring) and colored form (i.e., open ring). While the amorphochromic dye may be used without the color-developer, it is to be understood that amorphochromic dyes may also be used with the color-developer. The color-developer may shift the equilibrium of the amorphochromic dye towards its colored form. When the color-developer is used with the amorphochromic dye, the color-developer may be any of the color-developers listed above.

Examples of amorphochromic dyes include rhodol dyes, rhodamine dyes, and fluorescein dyes.

An example of a suitable rhodol dye (in its colorless form) has the following structure:

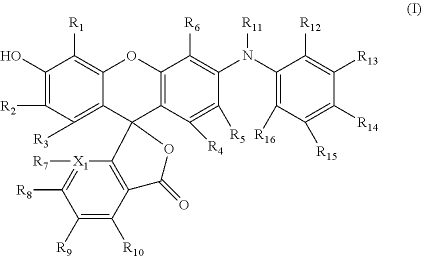

wherein:

R₁, R₂, R₃, R₄, R₅ and R₆ are each independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₇ is absent or selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₈, R₉, R₁₀, R₁₃, R₁₄, R₁₅ and R₁₆ are each independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₁₁ is selected from the group consisting of hydrogen, alkyl, preferably having from 1 to 18 carbon atoms, substituted alkyl, alkenyl, substituted alkenyl, alkynyl, substituted alkynyl, heterocycloalkyl, substituted heterocycloalkyl, substituted carbonyl, sulfonyl, aryl, substituted aryl, heteroaryl, substituted heteroaryl, substituted oxygen and substituted nitrogen;

R₁₂ is selected from the group consisting of hydrogen, alkyl, preferably having from 1 to 18 carbon atoms, substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

or R₁₁ and R₁₂ taken together represent the carbon atoms necessary to form a 5 or 6 membered substituted or unsubstituted heterocycloalkyl or heteroaryl group;

and

X₁ is carbon or nitrogen.

This rhodal dye undergoes a ring opening reaction in which the 5-membered oxygen containing ring opens and forms a carboxyl group. The colored form should be yellow (blue-absorbing), magenta (green-absorbing), cyan (red absorbing), or black, depending upon the substituent(s).

Symmetrical or unsymmetrical rhodamine dyes may be used. Symmetrical rhodamine dyes can be prepared in one step from 3′,6′-dichlorofluorans by reacting two equivalents of an aromatic or aliphatic amine. An example of a suitable unsymmetrical rhodamine dye (in its colorless form) has the following structure:

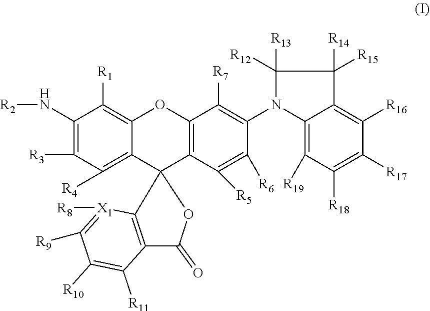

wherein:

R₁, R₃, R₄, R₅, R₆, and R₇ are each independently selected from the group consisting of hydrogen, alkyl (e.g., having from 1 to 18 carbon atoms), substituted alkyl, alkenyl, substituted alkenyl, alkynyl, substituted, alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₂ is selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, sulfonyl, aryl, substituted aryl, heteroaryl, substituted heteroaryl, substituted oxygen, substituted nitrogen and substituted sulfur;

R₈ is absent or selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₉, R₁₀, and R₁₁ are independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur;

R₁₂, R₁₃, R₁₄, and R₁₅ are independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, aryl, substituted aryl, heteroaryl, and substituted heteroaryl;

R₁₆, R₁₇, R₁₈, and R₁₉ are independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, oxygen, substituted oxygen, nitrogen, substituted nitrogen, sulfur and substituted sulfur; and

X₁ is carbon or nitrogen.

This rhodamine dye undergoes a ring opening reaction in which the 5-membered oxygen containing ring opens and forms a carboxyl group. The colored form should be yellow (blue-absorbing), magenta (green-absorbing), cyan (red absorbing), or black, depending upon the substituent(s).

An example of a suitable fluorescein (in its colorless form) has the following structure:

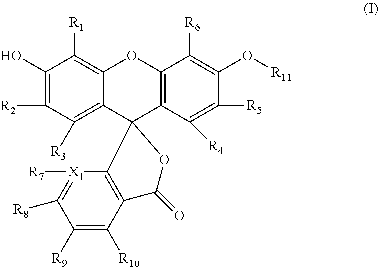

wherein:

R₁, R₂, R₅, R₆, R₈, R₉, and R₁₀ are each independently selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, substituted oxygen, substituted nitrogen, substituted sulfur, unsubstituted oxygen, unsubstituted nitrogen and unsubstituted sulfur;

R₃ and R₄ are each independently selected from the group consisting of hydrogen, alkyl having from 1 to 3 carbon atoms, substituted alkyl having from 1 to 3 carbon atoms, alkenyl having from 1 to 3 carbon atoms, substituted alkenyl having from 1 to 3 carbon atoms, alkynyl having from 1 to 3 carbon atoms, substituted alkynyl having from 1 to 3 carbon atoms, substituted oxygen, substituted nitrogen, and substituted sulfur;

R₇ is absent or selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, halogen, nitro, nitrilo, sulfonyl, aryl, substituted aryl, heteroaryl, substituted heteroaryl, substituted oxygen, substituted nitrogen, substituted sulfur, unsubstituted oxygen, unsubstituted nitrogen and unsubstituted sulfur;

R₁₁ is selected from the group consisting of hydrogen, alkyl (e.g., having from 1 to 18 carbon atoms), substituted alkyl, alkenyl, substituted alkenyl, alkynyl, substituted alkynyl, heterocycloalkyl, substituted heterocycloalkyl, substituted carbonyl, acylamino, sulfonyl, aryl, substituted aryl, heteroaryl and substituted heteroaryl; and

X₁ is carbon or nitrogen;

provided that at least one of R₁, R₂, R₅ and R₆ is selected from the group consisting of alkyl, preferably having from 1 to 18 carbon atoms, substituted alkyl, alkenyl, substituted alkenyl, alkynyl, substituted alkynyl, heterocycloalkyl, substituted heterocycloalkyl, aryl, substituted aryl, heteroaryl and substituted heteroaryl.

This fluorescein dye undergoes a ring opening reaction in which the 5-membered oxygen containing ring opens and forms a carboxyl group. The colored form should be yellow (blue-absorbing), magenta (green-absorbing), cyan (red absorbing), or black, depending upon the substituent(s).

While several examples of leuco dyes that may be used without developers have been provided, it is to be understood that any suitable leuco dyes known in the art may be used.

In some examples, the color-forming layer 14 may include, in addition to the leuco dye (and in some cases the color-developer), a sensitizer, a stabilizer, a binder, or a combination thereof. In some of these examples, the color-forming layer 14 consists of the leuco dye, the color-developer, the sensitizer, the stabilizer, the binder, or a combination thereof. In others of these examples, the color-forming layer 14 may include additional components, such as the registration mark 16. Other examples of additional components include surfactant(s), coating aid(s), wax(es), anti-oxidant(s), thermal solvent(s), humectant(s), and combinations thereof. In still others of these examples, the color-forming layer 14 consists of the leuco dye, the color-developer, the sensitizer, the stabilizer, the binder, the registration mark 16 or a combination thereof.

A sensitizer may be included in the color-forming layer 14 to cause the leuco dye to be activated more readily (e.g., with exposure to heat at a lower temperature and/or for a shorter time period than the temperature or time period sufficient to activate the leuco dye without the sensitizer). The sensitizer may effectively lower the melting point of the leuco dye and/or the color-developer by acting as a solvent in which the leuco dye and/or the color-developer is able to dissolve below its/their melting point(s). Examples of the sensitizer include ethanedioic acid, 1,2-bis[(4-chlorophenyl)methyl] ester (also known as di(P-chlorobenzyl) oxalate); ethanedioic acid, 1,2-bis[(4-methylphenyl)methyl] ester (also known as di(P-Methylbenzyl) oxalate); ethanedioic acid, 1,2-bis(phenylmethyl) ester (also known as dibenzyl oxalate); octadecanamide (also known as stearamide (waxy)); hexanedioic acid and a polymer with 1,4-butanediol and 1,2-ethanediol (also known as oligoethylene butylene glycol adipate, hexanedioic acid and Kemamide S); benzene, 1,1′-[1,2-ethanediylbis(oxy)]bis—(also known as (2-Phenoxyethoxy)benzene and 1,2-Diphenoxyethane). Other examples of the sensitizer include stearyl urea, p-benzylbiphenyl, di(2-methylphenoxy)ethane, di(2-methoxyphenoxy)ethane, naphthol-(p-methylbenzyl) ether, α-naphthylbenzyl ether, 1,4-butanediol-p-methylphenyl ether, 1,4-butanediol-p-isopropylphenyl ether, 1,4-butanediol-p-tert-octylphenyl ether, 1-phenoxy-2-(4-ethylphenoxy)ethane, 1-phenoxy-2-(chlorophenoxy)ethane, 1,4-butanediol-phenyl ether, diethylene glycol-bis(4-methoxyphenyl) ether, m-terphenyl, methyl oxalate benzyl ether, 1,2-diphenoxymethylbenzene, 1,2-bis(3-methylphenoxy)ethane, and 1,4-bis(phenoxymethyl)benzene, etc.

In an example, the sensitizer may be included in the color-forming layer 14 in an amount ranging from about 75 wt % to about 200 wt %, based on the weight of the leuco dye. In another example, the sensitizer may be included in the color-forming layer 14 in an amount ranging from about 100 wt % to about 150 wt %, based on the weight of the color-developer.

A stabilizer may be included in the color-forming layer 14 to increase the stability of the color-forming layer 14 (as compared to the stability of the color-forming layer 14 without the stabilizer). Examples of the stabilizer include 1,1,3-tris(2-methyl-4-hydroxy-5-tert-butylphenyl)butane, 1,1,3-tris(2-ethyl-4-hydroxy-5-cyclohexylphenyl)butane, 1,1,3-tris(3,5-di-tert-butyl-4-hydroxyphenyl)butane, 1,1,3-tris(2-methyl-4-hydroxy-5-tert-butylphenyl)propane, 2,2″-methylene-bis(6-tert-butyl-4-methylphenol), 2,2″-methylene-bis(6-tert-butyl-4-ethylphenol), 4,4″-butylidene-bis(6-tert-butyl-3-methylphenol), and 4,4″-thio-bis(3-methyl-6-tert-butylphenol).

In an example, the stabilizer may be included in the color-forming layer 14 in an amount ranging from about 10 wt % to about 100 wt %, based on the weight of the leuco dye. In another example, the stabilizer may be included in the color-forming layer 14 in an amount ranging from about 10 wt % to about 60 wt %, based on the weight of the color-developer.

A binder may be included in the color-forming layer 14 to bind the leuco dyes so that the portion of the repeated pattern defined by the color-forming layer 14 is maintained. As such, the binder may prevent a leuco dye from one stripe 22, 24, 26, 28 or section 32, 34, 36, 38 from migrating to another stripe 22, 24, 26, 28 or section 32, 34, 36, 38 or to a blank stripe 21 or section. The binder may also maintain the component(s) of the color-forming layer 14 within the layer 14 and/or bind it/them to the base layer 11 or the ink-receiving layer 13. Additionally, the binder may encapsulate the color-developer so that it does not react with the leuco dye prior to exposure to heat. Examples of the binder include polyvinyl alcohol, hydroxyethyl cellulose, etc. Other examples of the binder include methyl cellulose, carboxymethyl cellulose, starches (including denatured starches), gelatin, arabic gum, casein, and saponified styrene-maleic anhydride copolymers. Still other examples of the binder include synthetic polymer latex binders of, for example, styrene-butadiene copolymers, vinyl acetate copolymers, acrylonitrile-butadiene copolymers, methyl acrylate-butadiene copolymers, and polyvinylidene chloride.

In an example, the total amount of binder(s) present in the color-forming layer 14 may range from about 5 wt % to about 40 wt %, based on the total weight of the color-forming layer 14. In another example, the total amount of binder(s) present in the color-forming layer 14 may range from about 5 wt % to about 25 wt %, based on the total weight of the color-forming layer 14.

In an example, the color-forming layer 14 may have a substantially uniform thickness. For example, the thickness along substantially the entire length and/or width of the color-forming layer 14 may range from about 1 μm to about 20 μm. In another example, the thickness along substantially the entire length and/or width of the color-forming layer 14 may range from about 0.5 μm to about 4 μm.

In an example, the color-forming layer 14 may have a basis weight (after being dried) ranging from about 1 gsm to about 10 gsm.

Donor Ribbons

As mentioned above, the imaging medium 10 also includes the donor ribbon 40. The donor ribbon 40 is attached to the image-receiving substrate 12. By “attach,” “attached,” “attachment,” or the like, it is meant that the donor ribbon 40 and the image-receiving substrate 12 are secured or held together. Attachment between the donor ribbon 40 and the image-receiving substrate 12 may occur across the entire surface of the medium 10, or at one or more ends/edges, or at one or more of the corners. When attachment occurs at one or more ends/edges or at one or more of the corners, it is to be understood that the donor ribbon 40 and the image-receiving substrate 12 are still in contact with one another in accordance with the examples disclosed herein (even though attachment does not occur across the entire surface). Moreover, the mechanism for attaching the donor ribbon 40 and the image-receiving substrate 12 may enable the release of the image receiving substrate 12 from the donor ribbon 40 after imaging. In an example, the donor ribbon 40 is attached to the image-receiving substrate 12 by lamination, with an adhesive (e.g., spray adhesive at the edge(s)), via static cling, with an adhesion agent and warm lamination, or via any other suitable mechanism. The attachment point or area may also include a perforated tear tab allowing for easy removal of the donor ribbon 40 from the image-receiving substrate 12 after printing/thermal imaging.

When an adhesive is used to attach the donor ribbon 40 and the image-receiving substrate 12, the adhesive may be a pressure sensitive adhesive (PSA). For example, the adhesive may include AROSET® 3240 (a pressure-sensitive acrylate polymer available from Ashland Chemical Co.) and low glass transition temperature (Tg) styrene-butadiene latex polymers, such as GENFLO® 3003 and GENFLO® 3056 (available from Omnova Chemical Co.). The pressure sensitive adhesive may be a low tack pressure sensitive adhesive, such as an acrylic-based adhesives (formulated from cross-linked acrylic polymers, and which may be an emulsion-based adhesive), polyvinyl acetate (PVA), ethylene vinyl acetate.

In an example of the image imaging medium 10, the color layer 14′ of the donor ribbon 40 is in contact with the color-forming layer 14 of the image-receiving substrate 12. As such, the donor ribbon 40 may be attached to the image-receiving substrate 12 so that the color layer 14′ is in contact with the color-forming layer 14. When referring to the layers 14, 14′ being “in contact”, it is meant that the donor ribbon 40 may be attached to the image-receiving substrate 12 so that the blank stripe(s) 21′ or section(s) of the color layer 14′ is/are in contact with the color-forming stripe(s) 22, 24, 26, 28 or section(s) 32, 34, 36, 38 of the color-forming layer 14 and the blank stripe(s) 21 or section(s) of the color-forming layer 14 is/are in contact with the colored stripe(s) 22′, 24′, 26′, 28′ or section(s) 32′, 34′, 36′, 38′ of the color layer 14′. As previously mentioned herein, if the color-forming layer 14 and the color layer 14′ were superimposed, the repeats 20, 20′ would be formed, but the various color-forming and color stripes or sections of the repeats 20, 20′ would not overlap one another.

As mentioned above, the donor ribbon 40 includes the color layer 14′. In an example of the image imaging medium 10, the donor ribbon 40 further includes a donor ribbon substrate 42 and a release layer 44 disposed between the donor ribbon substrate 42 and the color layer 14′. In some examples, the donor ribbon 40 consists of the donor ribbon substrate 42, the release layer 44, and the color layer 14′, with no other components. In other examples, the donor ribbon 40 may include additional components, such as a topcoat 18 and/or a back coat 46. In still other examples, the donor ribbon 40 consists of the donor ribbon substrate 42, the release layer 44, the color layer 14′, the topcoat 18 and the back coat 46, with no other components.

Donor Ribbon Substrates

In some examples, the donor ribbon substrate 42 may act as a bottom layer or a base of the donor ribbon 40, in that other layer(s) of the donor ribbon 40 may be formed thereon. As the bottom layer, the donor ribbon substrate 42 may provide structural integrity for the resultant donor ribbon 40.

The donor ribbon substrate 42 may be any substrate: i) on which the release layer 44, the color layer 14′, etc. may be applied, and ii) through which the release layer 44, the color layer 14′, etc. may be selectively exposed to heat so that the thermal transfer dyes in portions of the color layer 14′ may be transferred to the image-receiving substrate 12 without melting the donor ribbon substrate 42. Examples of the donor ribbon substrate 42 include a polyethylene terephthalate (PET) film, a polyamide film, a polycarbonate film, a cellulose ester film (e.g., cellulose acetate or any of the other examples set forth herein), etc. Other examples of the donor ribbon substrate 42 include polyesters, polyamides, polycarbonates, glassine paper, condenser paper, fluorine polymers (e.g., polyvinylidene fluoride, and poly(tetrafluoroethylene-cohexafluoropropylene)), polyethers (e.g., polyoxymethylene), polystyrene, polyacetals, and polyolefins (e.g., polystyrene, polyethylene, polypropylene, and methylpentane polymers).

In an example, the donor ribbon substrate 42 may have a substantially uniform thickness. For example, the thickness along substantially the entire length and/or width of the donor ribbon substrate 42 may range from about 2 μm to about 30 μm. In other examples, the thickness along substantially the entire length and/or width of the donor ribbon substrate 42 may range from about 2 μm to about 10 μm; or from about 3 μm to about 8 μm; or about 4 μm to about 6 μm.

Release Layers

The release layer 44 is disposed on one side of the donor ribbon substrate 42, as shown in FIG. 1. In an example of the donor ribbon 40, the release layer 44 is disposed on the donor ribbon substrate 42. As shown in FIG. 1, the release layer 44 may be disposed directly on the donor ribbon substrate 42. In still another example, the release layer 44 is disposed on a front side 48 of the donor ribbon substrate 42. As used herein, the term “front side” may refer to the side upon which the color layer 14′ is to be disposed.

The release layer 44 may enable portions of the color layer 14′ (e.g., the thermal transfer dyes) and portions of any layers between the release layer 44 and the color layer 14′ (e.g., the clear and colorless topcoat 18) to be readily transferred to the image-receiving substrate 12. The release layer 44 has a sharp melting transition (i.e., small difference between the softening temperature and the melting temperature), which allows for a crisp transfer of portions of the color layer 14′. As an example, the release layer 44 may include a material that does not absorb the activated dyes, and thus prevents the activated dyes from migrating toward the donor ribbon substrate 42.

Examples of the release layer 44 include polyethylene wax and paraffin wax. In some of these examples, the polyethylene wax and/or the paraffin wax may be included in the release layer 44 in an amount up to 100 wt %, based on the total weight of the release layer 44.

In an example, the release layer 44 may have a substantially uniform thickness. For example, the thickness along substantially the entire length and/or width of the release layer 44 may range from about 0.20 μm to about 1.0 μm.

Color Layers

As shown in FIG. 1 the color layer 14′ is disposed on the release layer 44. In an example of the donor ribbon 40, the color layer 14′ is disposed on the release layer 44. In some instances, the color layer 14′ is disposed directly on the release layer 44.

In some examples, the color layer 14′ includes at least one colored stripe 24′, 26′, 28′ selected from the group consisting of a cyan stripe 24′, a magenta stripe 26′, and a yellow stripe 28′. In other examples, the color layer 14′ includes at least one colored stripe 22′, 24′, 26′, 28′ selected from the group consisting of a black stripe 22′, a cyan stripe 24′, a magenta stripe 26′, and a yellow stripe 28′. The colored stripe(s) 22, 24, 26, 28 of the color layer 14′ may be any of the colored stripe(s) 22, 24, 26, 28 described above in reference to the repeated pattern.

In some examples, the color layer 14′ includes at least one colored section 34′, 36′, 38′ selected from the group consisting of a cyan section 34′, a magenta section 36′, and a yellow section 38′. In other examples, the color layer 14′ includes at least one colored section 32′, 34′, 36′, 38′ selected from the group consisting of a black section (an example of the colored section 32′), a cyan section 34′, a magenta section 36′, and a yellow section 38′. In still other examples, the color layer 14′ includes at least one colored section 32′, 34′, 36′, 38′ selected from the group consisting of a black section (an example of the colored section 32′), a cyan section 34′, a light cyan section (an example of the colored section 32′), a magenta section 36′, a light magenta section (an example of the colored section 32′), and a yellow section 38′. The colored section(s) 32′, 34′, 36′, 38′ of the color layer 14′ may be any of the colored section(s) 32′, 34′, 36′, 38′ described above in reference to the repeated pattern.

It is to be understood that the color layer 14′ may also include blank stripes 21′ or sections so that activated dyes in the color-forming layer 14 of the image-receiving substrate 12 may be exhibited without dyes from the color layer 14′ being transferred thereto. In some examples, these blank stripes 21′ or sections may be devoid of the components of the color layer 14′, and may have the same dimensions of the color-forming stripes 22, 24, 26, 28 or color-forming sections 32, 34, 36, 38 of the color-forming layer 14 that are to be in contact therewith when the imaging medium 10 is assembled. As such, the color layer 14′ may be non-continuous. In other examples, these blank stripes 21′ or sections may be devoid of any dye, but may include the components of the color layer 14′ (e.g., binder(s), surfactant(s), coating aid(s), wax(es), anti-oxidant(s), UV light stabilizer(s), thermal solvent(s), humectant(s), etc.). In these examples, the blank stripes 21′ or sections may have the same dimensions of the color-forming stripes 22, 24, 26, 28 or color-forming sections 32, 34, 36, 38 of the color-forming layer 14 that are to be in contact therewith when the imaging medium 10 is assembled. As such, when a color-forming stripe 22, 24, 26, 28 or section 32, 34, 36, 38 or portion thereof is activated, the blank stripe 21′ or section or portions thereof in contact with the activated portion may transfer to image-receiving substrate 12.

In some examples, the color layer 14′ includes at least one thermal transfer dye selected from the group consisting of a cyan thermal transfer dye, a magenta thermal transfer dye, and a yellow thermal transfer dye. In other examples, the color layer 14′ includes at least one thermal transfer dye selected from the group consisting of a black thermal transfer dye, a cyan thermal transfer dye, a magenta thermal transfer dye, and a yellow thermal transfer dye.

One or more thermal transfer dyes may form a portion of the repeated pattern. As such, when included in the color layer 14′, the cyan stripe(s) 24′ or section(s) 34′ may include the cyan thermal transfer dye, the magenta stripe(s) 26′ or section(s) 36′ may include the magenta thermal transfer dye, and the yellow stripe(s) 28′ or section(s) 38′ may include the yellow thermal transfer dye. When the repeat 20, 20′ of the pattern includes the black stripe(s) 22′ or section(s), the black stripe(s) 22′ or section(s) may include the black thermal transfer dye. When the repeat 20′ of the pattern includes the grid 30, the grid 30 includes the colored section 32′, and the colored section 32′ is cyan or light cyan, the colored section 32′ may include the cyan thermal transfer dye. When the repeat 20′ of the pattern includes the grid 30, the grid 30 includes the colored section 32′, and the colored section 32′ is yellow, the colored section 32′ may include the yellow thermal transfer dye. When the repeat 20′ of the pattern includes the grid 30, the grid 30 includes the colored section 32′, and the colored section 32′ is magenta or light magenta, the colored section 32′ may include the magenta thermal transfer dye.

It is to be understood that a combination of thermal transfer dyes may be used together in any one stripe 22′, 24′, 26′, 28′ or section 32′, 34′, 36′, 38′. The thermal transfer dyes of a combination may individually exhibit different colors/hues, but when used together in the combination exhibit the desired color/hue. For example, a combination of blue, red, and/or violet thermal transfer dyes may be included in the magenta stripe(s) 26′ or section(s) 36′, and those stripe(s) 26′ or section(s) 36′ exhibit magenta.

Prior to being selectively transferred, the thermal transfer dyes are all present in the color layer 14′. Due to the small dimensions of the stripes 22′, 24′, 26′, 28′ or sections 32′, 34′, 36′, 38′, the color layer 14′ may appear to the naked eye (i.e., without magnification) to be black, gray, light cyan, light magenta, light yellow, purple, orange, or green prior to being selectively transferred. The color that color layer 14′ appears to be may depend, in part, on the colored stripes 22′, 24′, 26′, 28′ or sections 32′, 34′, 36′, 38′ that are present in the color layer 14′. For example, if the color layer 14′ includes cyan stripes 24′ or sections 34′ and magenta stripes 26′ or sections 36′ without any other colored stripes or sections, the color layer 14′ may appear to be purple.

The thermal transfer dyes may be any dye transferable by heat. In an example, the total amount of the thermal transfer dye(s) present in the color layer 14′ may range from about 10 wt % to about 40 wt %, based on the total weight of the color layer 14′. When the color layer 14′ includes more than one colored stripe 22′, 24′, 26′, 28′ or section 32′, 34′, 36′, 38′, one or more colored stripe 22′, 24′, 26′, 28′ or section 32′, 34′, 36′, 38′ may include a higher or lower amount of thermal transfer dye than one or more of the other colored stripes 22′, 24′, 26′, 28′ or sections 32′, 34′, 36′, 38′. For example, when the repeat 20′ of the pattern includes the grid 30, the grid 30 includes the colored section 32′, and the colored section(s) 32′ is/are light cyan, the colored section(s) 32′ may include a lower amount of thermal transfer dye than the cyan section(s) 34′. As another example, when the repeat 20′ of the pattern includes the grid 30, the grid 30 includes the colored section 32′, and the colored section(s) 32′ is/are light magenta, the colored section(s) 32′ may include a lower amount of thermal transfer dye than the magenta section(s) 36′.

In some examples, the thermal transfer dye(s) of the color layer 14′ is/are sublimable dye(s). A sublimable dye is a dye that may vaporize (i.e., transform directly from a solid state to a gaseous state without going through a liquid state) when exposed to heat. The sublimable dye may have an enthalpy of vaporization that is high enough to prevent premature vaporization (e.g., to prevent the dyes from transferring during shipping and/or handling) and low enough for fast, low energy thermal imaging. In some examples, the sublimable dye may have an enthalpy of vaporization that is less than or equal to 90 kJ per mole; or less than or equal to 75 kJ per mole; or less than or equal to 60 kJ per mole. It is to be understood, however, that the enthalpy of vaporization is not so low that the dyes can evaporate quickly at ambient temperatures (e.g., 18° C.-25° C.).

Examples of sublimable dyes include anthraquinone dyes, azo dyes, direct dyes, acid dyes, basic dyes, quinhydrone dyes, etc. Examples of anthraquinone dyes include Sumikalon Violet RS® (from Sumitomo Chemical Co., Ltd.), Dianix Fast Violet 3R-FS® (from Mitsubishi Chemical Corp.), Kayalon Polyol Brilliant Blue N-BGM® (from Nippon Kayaku Co., Ltd.), and KST Black 146® (from Nippon Kayaku Co., Ltd.). Examples of azo dyes include Kayalon Polyol Brilliant Blue BM® (from Nippon Kayaku Co., Ltd.), Kayalon Polyol Dark Blue 2BM® (from Nippon Kayaku Co., Ltd.), KST Black KR® (from Nippon Kayaku Co., Ltd.), Sumickaron Diazo Black 5G® (from Sumitomo Chemical Co., Ltd.), and Miktazol Black 5GH® (from Mitsui Toatsu Chemicals, Inc.). Examples of direct dyes include Direct Dark Green B® (from Mitsubishi Chemical Corp.), Direct Brown Mg (from Nippon Kayaku Co., Ltd.), and Direct Fast Black D® (from Nippon Kayaku Co., Ltd.). An example of an acid dye includes Kayanol Milling Cyanine 5R® (from Nippon Kayaku Co., Ltd.). Examples of basic dyes include Sumicacryl Blue 6G® (from Sumitomo Chemical Co., Ltd.), and Aizen Malachite Green® (from Hodogaya Chemical Co., Ltd.).

Other examples of sublimation dyes include RIAPLAS® Yellow 3GL-TP (color index number (CI No) Y54), RIAPLAS® Yellow 8G-TP (CI No Y82), RIAPLAS® Yellow 5G-TP (CI No Y64), RIAPLAS® Orange 2RL-TP (CI No 025), RIAPLAS® Brown RL-TP (CI No Br27), RIAPLAS® Red 2BL-TP (CI No R60), RIAPLAS® Red GL-TP (CI No R4), RIAPLAS® Pink 5B-TP (CI No R364), RIAPLAS® Violet 2RL-TP (CI No V28), RIAPLAS® Blue 5RLN-TP (CI No B72), RIAPLAS® Violet GL-TP (CI No B72), RIAPLAS® Blue 3GL-TMP (CI No B359), RIAPLAS® Blue DB-TP (B360), RIAPLAS® Blue G-TP (CI No B14), RIAPLAS® Blue 2R-TP (CI No B19), RIAPLAS® Blue 2GN-TP (CI No B60), RIAPLAS® Green 5B-TP (CI No Sol Gr 3), and mixtures thereof. Still other examples of sublimation dyes include intratherm yellow P-1343NT, intratherm yellow P-1346NT, intratherm yellow P-346, intratherm brilliant yellow P-348, intratherm yellow P-343NT, intratherm brilliant orange P-365, intratherm orange P-367, intratherm brown P-1301, intratherm dark brown P-1303, intratherm pink P-1335NT, intratherm brilliant red P-1314NT, intratherm red P-1339, Vat Red 41, intratherm blue P-1305NT, intratherm blue P-1404, intratherm brilliant blue P-1309, Vat Blue 3, Vat Blue 1, and mixtures thereof.

Disperse sublimation dyes may also be used. Examples of disperse sublimation dyes include carboxyl- and/or sulfo-free nitro, nitroarylamine, amino, amino ketone, ketone imine, methine, polymethine, diphenylamine, quinoline, benzimidazole, xanthene, oxazine or coumarin dyes, some anthraquinone dyes and azo dyes, such as monoazo or disazo dyes. Yellow disperse dyes may include disperse yellow 54, disperse yellow 64, disperse yellow 71, disperse yellow 86, disperse yellow 114, disperse yellow 153, disperse yellow 233, disperse yellow 245, disperse yellow 1, disperse yellow 3, disperse yellow 7, disperse yellow 9, disperse yellow 16, disperse yellow 23, disperse yellow 41, disperse yellow 51, disperse yellow 60, disperse yellow 77, disperse yellow 79, disperse yellow 82, disperse yellow 141, disperse yellow 116, and mixtures thereof. Magenta disperse dyes may include disperse red 60, disperse red 82, disperse red 86, disperse red 86:1, disperse red 167:1, disperse red 279, disperse red 1, disperse red 4, disperse red 6, disperse red 9, disperse red 11, disperse red 13, disperse red 15, disperse red 17, disperse red 55, disperse red 59, disperse red 73, disperse red 83, disperse red 135, disperse red 146, and mixtures thereof. Cyan disperse dyes may include disperse blue 27, disperse blue 60, disperse blue 73, disperse blue 77, disperse blue 87, disperse blue 257, disperse blue 291:1, disperse blue 359, disperse blue 360, disperse blue 367, disperse blue 3, disperse blue 14, disperse blue 19, disperse blue 24, disperse blue 26, disperse blue 55, disperse blue 56, disperse blue 64, disperse blue 72, disperse blue 99, disperse blue 108, disperse blue 134, disperse blue 154, disperse blue 165, disperse blue 180, disperse blue 287, disperse blue 301, disperse blue 334, and mixtures thereof.

A black disperse dye may include disperse black 3. Black disperse dye dispersions often include a blend of disperse dyes, such as, for example, blends of blue, brown and yellow disperse dyes, or blends of blue, orange and violet disperse dyes, or blends of blue, orange and yellow disperse dyes, or blue, magenta, and yellow dyes. An example of a suitable blue, brown and yellow disperse dye blend includes disperse blue 360 (DB360), disperse brown 27, and disperse yellow 54 (DY54). Some examples of suitable blue, orange and violet disperse dye blends include disperse blue 291:1 (DB291:1), disperse orange 29 (D029) and disperse violet 63, or DB291:1, D029 and disperse violet 99. An example of a suitable blue, orange and yellow dye blend includes DB360, disperse orange 25, and DY54. An example of a suitable blue, magenta, and yellow dye blend includes disperse blue 77 (DB77), disperse red 92, and disperse yellow 114 (DY 114).

Other examples of disperse sublimation dyes include disperse orange 3, disperse orange 25, disperse orange 7, disperse orange 1, disperse violet 1, disperse violet 4, disperse violet 13, disperse violet 36, disperse violet 56, disperse violet 31, and mixtures thereof or mixtures with any of the other dyes disclosed herein.

Still other suitable sublimation dyes that may be used in the examples disclosed herein include oil-soluble dyes, such as solvent yellow 14, solvent yellow 16, solvent yellow 29, solvent yellow 56, solvent yellow 77, solvent yellow 116, solvent red 18, solvent red 19, solvent red 23, solvent red 24, solvent red 25, solvent red 27, solvent red 81, solvent red 135, solvent red 143, solvent red 146, solvent red 182, solvent blue 11, solvent blue 35, solvent blue 36, solvent blue 49, solvent blue 50, solvent blue 63, solvent blue 70, solvent blue 83, solvent blue 97, solvent blue 105, solvent blue 111, solvent black 3, solvent violet 13, solvent green 3, and mixtures thereof or mixtures with any of the other dyes disclosed herein.

While several examples of thermal transfer dyes have been provided, it is to be understood that any suitable thermal transfer dye known in the art may be used.

Heat transfers the thermal transfer dyes (and the other components of the color layer 14′). As such, the portions of the colored stripes 22′, 24′, 26′, 28′ or the colored sections 32′, 34′, 36′, 38′ that are selectively exposed to heat transfer to the image-receiving substrate 12. In some examples, the heat actually causes the dye to diffuse into the image-receiving substrate 12. In other examples, the heat actually sublimates the dye so that it converts to a gas and penetrates into the image-receiving substrate 12.

In some examples, the color layer 14′ includes more than one thermal transfer dye, and each thermal transfer dye is transferable under the same heat exposure conditions as each other thermal transfer dye in the color layer 14′. In some of these examples, each thermal transfer dye is transferable under the same heat exposure conditions under which the dyes in the color-forming layer 14 are activatable. In others of these examples, each thermal transfer dye is transferable at a lower temperature than the temperature at which the dyes in the color-forming layer 14 are activatable. In others of these examples, the heat exposure conditions include heating to a temperature ranging from about 70° C. to about 300° C. for a time period ranging from about 10 μs to about 200 μs. In some other of these examples, the heat exposure conditions include heating to a temperature ranging from about 70° C. to about 200° C. for a time period ranging from about 10 μs to about 200 μs. In still some other of these examples, the heat exposure conditions include heating to a temperature ranging from about 70° C. to about 100° C. for a time period ranging from about 10 μs to about 200 μs. In yet some other of these examples, the heat exposure conditions include heating for a time period of about 100 μs. The low end of the temperature range for dye transfer (i.e., the low end of the heating conditions) may be high enough to prevent premature color transfer (e.g., to prevent the dyes from transferring during shipping and/or handling). The heat exposure conditions may also include heating to a temperature low enough (e.g., ≤100° C.) for fast, low energy thermal imaging.

In some examples, the color layer 14′ may include, in addition to the thermal transfer dyes, a binder. In some of these examples, the color layer 14′ consists of the thermal transfer dyes, the binder, or a combination thereof. In others of these examples, the color layer 14′ may include additional components, such as the registration mark 16. Other examples of additional components include surfactant(s), coating aid(s), wax(es), anti-oxidant(s), UV light stabilizer(s), thermal solvent(s), humectant(s), and combinations thereof. In still others of these examples, the color layer 14′ consists of the thermal transfer dyes, the binder, the registration mark 16 or a combination thereof.

A binder may be included in the color layer 14′ to bind the thermal transfer dyes so that the portion of the repeated pattern defined by the color layer 14′ is maintained. As such, the binder may prevent a thermal transfer dye from one stripe 22′, 24′, 26′, 28′ or section 32′, 34′, 36′, 38′ from migrating to another stripe 22′, 24′, 26′, 28′ or section 32′, 34′, 36′, 38′ or to a blank stripe 21′ or section. The binder may also maintain the component(s) of the color layer 14′ within the layer 14′ and/or bind it/them to the image-receiving substrate 12 after its/their transfer. In an example, the binder may be an acrylic, styrene acrylic, polyethylene, or polyurethane binder. Other examples of the binder include polycarbonate, poly(styrene-co-acrylonitrile), polysulfone, polyphenylene oxide, cellulose acetate hydrogen phthalate, cellulose acetate, cellulose acetate butyrate, etc.

In an example, the total amount of binder(s) present in the color layer 14′ may range from about 5 wt % to about 40 wt %, based on the total weight of the color layer 14′. In another example, the total amount of binder(s) present in the color layer 14′ may range from about 5 wt % to about 25 wt %, based on the total weight of the color layer 14′.

In an example, the color layer 14′ may have a substantially uniform thickness. For example, the thickness along substantially the entire length and/or width of the color layer 14′ may range from about 1 μm to about 20 μm. In another example, the thickness along substantially the entire length and/or width of the color layer 14′ may range from about 0.5 μm to about 4 μm.

In an example, the color layer 14′ may have a basis weight (after being dried) ranging from about 1 gsm to about 10 gsm.

Clear and Colorless Topcoats

In some examples, the donor ribbon 40 further includes a clear and colorless topcoat 18 disposed on the release layer 44; and the color layer 14′ is disposed on the clear and colorless topcoat 18. In one of these examples, the clear and colorless topcoat 18 is disposed directly on the release layer 44; and the color layer 14′ is disposed directly on the clear and colorless topcoat 18. As used herein, “clear,” means that 80% or more of visible light (i.e., light with a wavelength ranging from 390 nm to 700 nm) can be transmitted through the topcoat 18. As used herein, “colorless,” means that the topcoat 18 is achromatic and does not include a colorant.

As shown in FIG. 1, the clear and colorless topcoat 18 may be a continuous, porous layer positioned between the release layer 44 and the color layer 14′. Portions of the clear and colorless topcoat 18 may be transferred (e.g., as a result of heat exposure) to the image-receiving substrate 12 when portions (e.g., the thermal transfer dyes) of the color layer 14′ are transferred to the image-receiving substrate 12. Additional portions of the clear and colorless topcoat 18 may be transferred (e.g., as a result of heat exposure) to the image-receiving substrate 12 when portions (e.g., the dyes) of the color-forming layer 14 are activated. These additional portions of the clear and colorless topcoat 18 may be positioned adjacent to blank stripes 21′ or sections of the color layer 14′. As such, the additional portions of the clear and colorless topcoat 18 may be transferred to the image-receiving substrate 12 without transferring portions of the color layer 14′.

It is to be understood that the portions of the clear and colorless topcoat 18 that are selectively exposed to heat will transfer to the image-receiving substrate 12, and that the portions of the clear and colorless topcoat 18 that are not selectively exposed to heat will not transfer to the image-receiving substrate 12. As such, once transferred to the image-receiving substrate 12, the clear and colorless topcoat 18 will no longer be a continuous layer.

The portions of the clear and colorless topcoat 18 that are transferred to the image-receiving substrate 12 will be disposed on the portions of the color layer 14′ that have transferred to the image-receiving substrate 12 and/or portions of the color-forming layer 14 that have been activated. Thus, when the image-receiving substrate 12 is separated from the donor ribbon 40, the transferred portions of the clear and colorless topcoat 18 may act as a protective coating over the image formed from the transferred portions of the color layer 14′ and/or the activated portions of the color-forming layer 14. The clear and colorless topcoat 18, acting as a protective coating, may improve the robustness or durability of the colored image formed on the image-receiving substrate 12 (as compared to the robustness or durability of a colored image formed without the clear and colorless topcoat 18). Since the topcoat 18 is clear and colorless, the colored image formed using the color layer 14′ and/or the color-forming layer 14 may be seen through the clear and colorless topcoat 18.

The clear and colorless topcoat 18 may be any material that is: i) clear and colorless, ii) capable of acting as a protective coating, and iii) capable of having portions thereof be transferred upon the selective exposure to heat. In an example, the clear and colorless topcoat 18 may include a polymeric binder. In another example, the clear and colorless topcoat 18 may consist of the polymeric binder. In still other examples, the clear and colorless topcoat 18 may include polyvinyl alcohol (e.g., AIRVOL™ 540, available from Air Products and Chemicals, Inc., Allentown, Pa.), a surfactant (e.g., ZONYL® FSA and/or ZONYL® FSN, available from DuPont Corporation, Wilmington, Del.), zinc stearate (e.g., HYMICRON™ ZK-349, available from Cytech Products, Inc., Elizabethtown, Ky.), silica (e.g., KLEBOSOL® 30V-25, available from Clariant Corporation, Muttenz, Switzerland), and glyoxal (OCHCHO, available from Aldrich Chemical Co., Milwaukee, Wis.). In yet another example, the clear and colorless topcoat 18 may include from about 30 wt % to about 35 wt % of the polyvinyl alcohol, from about 3 wt % to about 5 wt % of the surfactant, from about 30 wt % to about 35 wt % of the zinc stearate, from about 20 wt % to about 25 wt % of the silica, and from about 7 wt % to about 10 wt % of glyoxal.

In an example, the clear and colorless topcoat 18 may have a substantially uniform thickness. For example, the thickness along substantially the entire length and/or width of the clear and colorless topcoat 18 may range from about 0.50 μm to about 5.0 μm. In another example, the thickness along substantially the entire length and/or width of the clear and colorless topcoat 18 is about 1 μm.

Back Coats

In some examples, the donor ribbon 40 further includes a back coat 46 disposed on a back side 50 of the donor ribbon substrate 42. For example, the back coat 46 may be disposed directly on the back side 50 of the donor ribbon substrate 42. As used herein in reference to the donor ribbon substrate 42, the term “back side” may refer to the side opposed to the front side 48. The back side 50 may be the side that is placed into contact with the thermal printhead during printing/imaging, and the side upon which the color layer 14′ is not to be disposed.

As shown in FIG. 1, the back coat 46 may be a continuous layer on the back side 50 of the donor ribbon substrate 42. As such, the back coat 46 may provide support to the donor ribbon substrate 42 and/or improve the ability of the imaging medium 10 to feed through a printer. Additionally or alternatively, the back coat 46 may prevent the donor ribbon 40 from sticking to a thermal printhead and/or prevent the donor ribbon 40 from contaminating a thermal printhead.

The back coat 46 may be any material that is capable of providing support to the donor ribbon substrate 42, improving the ability of the imaging medium 10 to feed through a printer, preventing the donor ribbon 40 from sticking to a thermal printhead, and/or preventing the donor ribbon 40 from contaminating a thermal printhead. In an example, the back coat 46 may include heat resistant materials. In another example, the back coat 46 may include a polymeric binder. In still another example, the back coat 46 may consist of the polymeric binder. In yet another example, the back coat 46 may include denatured polyvinyl alcohols, starch, oxidized starch, urea-phosphorylated starch, styrene-maleic anhydride copolymers, alkyl esters of styrene-maleic anhydride copolymers, styrene-acrylic acid copolymers, or a combination thereof. In yet another example, the denatured polyvinyl alcohols, starch, oxidized starch, urea-phosphorylated starch, styrene-maleic anhydride copolymers, alkyl esters of styrene-maleic anhydride copolymers, styrene-acrylic acid copolymers, or the combination thereof may be included in the back coat 46 in an amount up to 100 wt %, based on the total weight of the back coat 46.

In an example, the back coat 46 may have a substantially uniform thickness. For example, the thickness along substantially the entire length and/or width of the back coat 46 may be less than or equal to 1 μm. In another example, the thickness along substantially the entire length and/or width of the back coat 46 may be about 0.1 μm.

Registration Marks

In some examples, the imaging medium 10 further comprises a registration mark 16. The registration mark 16 enables a particular area of the repeated pattern to be accurately aligned with a particular thermal resistor or a plurality of thermal resistors (e.g., a column and/or row of thermal resistors). Accurate alignment enables the desired color-forming stripes 22, 24, 26, 28, or sections 32, 34, 36, 38, or portions thereof to be activated to form a printed image. Accurate alignment also enables the desired colored stripes 22′, 24′, 26′, 28′, or sections 32′, 34′, 36′, 38′, or portions thereof to be transferred from the donor ribbon 40 to the image-receiving substrate 12 to form a printed image. Further, accurate alignment enables the color-forming stripes 22, 24, 26, 28, or sections 32, 34, 36, 38, or portions thereof that are to remain non-activated to remain non-activated, and enables the colored stripes 22′, 24′, 26′, 28′, or sections 32′, 34′, 36′, 38′, or portions thereof that are to remain non-transferred to remain non-transferred.

The registration mark(s) 16 may be detected by a printer. Upon detecting the registration mark(s) 16, the printer can de-skew the path of the imaging medium 10, and can determine the locations of each stripe 22, 22′, 24, 24′, 26, 26′, 28, 28′ or each section 32, 32′, 34, 34′, 36, 36′, 38, 38′ with respect to the location(s) of the registration mark(s) 16. As such, the registration mark 16 may be any mark that is capable of being detected by a printer. Examples of the registration mark(s) 16 include electronic marks (e.g., conductive traces), marks that emit or react to near-infrared (NIR) radiation, and marks that emit or react to ultraviolet (UV) radiation.

The registration mark(s) 16 may be located anywhere on the imaging medium 10 that enables the registration mark(s) 16 to be detected. As such, the registration mark 16 may be disposed on (directly or indirectly) any component of the donor ribbon 40 or the image-receiving substrate 12. As examples, the registration mark(s) 16 may be disposed on (directly or indirectly) the donor ribbon substrate 42, disposed on (directly or indirectly) the back coat 46 (as shown in FIG. 1), disposed on (directly or indirectly) the release layer 44, disposed on (directly or indirectly) the clear and colorless topcoat 18, disposed on (directly or indirectly) the color layer 14′, disposed on (directly or indirectly) the color-forming layer 14, disposed on (directly or indirectly) the ink-receiving layer 13, or disposed (directly or indirectly) on the base layer 11.

In some examples, the registration mark(s) 16 may be included in the color-forming layer 14. In these examples, the registration mark(s) 16 may be present in one or more of the color-forming stripes 22, 24, 26, 28 or the color-forming sections 32, 34, 36, 38 in one or more of the repeats 20, 20′. In these examples, the registration mark(s) 16 may be considered to be disposed on or disposed directly on the base layer 11 or disposed on or disposed directly on the ink-receiving layer 13.

In some other examples, the registration mark(s) 16 may be included in the color layer 14′. In these examples, the registration mark(s) 16 may be present in one or more of the colored stripes 22′, 24′, 26′, 28′ or the colored sections 32′, 34′, 36′, 38′ in one or more of the repeats 20, 20′. In these examples, the registration mark(s) 16 may be considered to be disposed on or disposed directly on the release layer 44 or disposed on or disposed directly on the clear and colorless topcoat 18.

The imaging medium 10 may include one registration mark 16 or multiple registration marks 16. The example of the imaging medium 10 shown in FIG. 1 incudes multiple registration marks 16.

Methods of Making the Imaging Medium

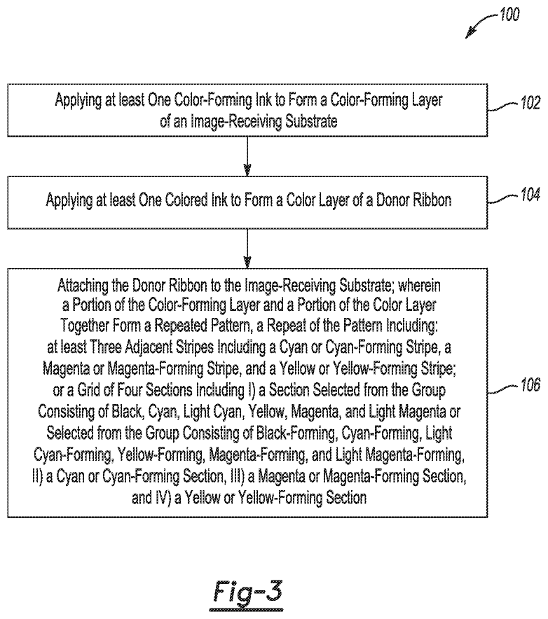

Referring now to FIG. 3, a method 100 of making the imaging medium 10 is depicted. In one example, the method 100 of making the imaging medium 10 comprises: applying at least one color-forming ink to form a color-forming layer 14 of an image-receiving substrate 12 (reference numeral 102); applying at least one colored ink to form a color layer 14′ of a donor ribbon 40 (reference numeral 104); and attaching the donor ribbon 40 to the image-receiving substrate 12; wherein a portion of the color-forming layer 14 and a portion of the color layer 14′ together form a repeated pattern, a repeat 20, 20′ of the pattern including: at least three adjacent stripes 24, 24′, 26, 26′, 28, 28′ including a cyan or cyan-forming stripe 24, 24′, a magenta or magenta-forming stripe 26, 26′, and a yellow or yellow-forming stripe 28, 28′; or a grid 30 of four sections 32, 32′, 34, 34′, 36, 36′, 38, 38′ including i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′ (reference numeral 106).

In another example, the method 100 of making the imaging medium 10 comprises: applying at least one color-forming ink to form a color-forming layer 14 of an image-receiving substrate 12; applying at least one colored ink to form a color layer 14′ of a donor ribbon 40; and attaching the donor ribbon 40 to the image-receiving substrate 12; wherein a portion of the color-forming layer 14 and a portion of the color layer 14′ together form a repeated pattern, a repeat 20, 20′ of the pattern including: four adjacent stripes 22, 22′, 24, 24′, 26, 26′, 28, 28′ including a black or black-forming stripe 22, 22′, a cyan or cyan-forming stripe 24, 24′, a magenta or magenta-forming stripe 26, 26′, and a yellow or yellow-forming stripe 28, 28′; or a grid 30 of four sections 32, 32′, 34, 34′, 36, 36′, 38, 38′ including a black or black forming section, a cyan or cyan-forming section 34, 34′, a magenta or magenta-forming section 36, 36′, and a yellow or yellow-forming section 38, 38′.

In still another example, the method 100 of making the imaging medium 10 comprises: applying at least one color-forming ink including a leuco dye to form a color-forming layer 14 of an image-receiving substrate 12; applying at least one colored ink including a thermal transfer dye to form a color layer 14′ of a donor ribbon 40; and attaching the donor ribbon 40 to the image-receiving substrate 12; wherein a portion of the color-forming layer 14 and a portion of the color layer 14′ together form a repeated pattern, a repeat 20, 20′ of the pattern including: at least three adjacent stripes 24, 24′, 26, 26′, 28, 28′ including a cyan or cyan-forming stripe 24, 24′, a magenta or magenta-forming stripe 26, 26′, and a yellow or yellow-forming stripe 28, 28′; or a grid 30 of four sections 32, 32′, 34, 34′, 36, 36′, 38, 38′ including i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′.

In some examples of the method 100, the repeat of the pattern includes the at least three stripes 24, 24′, 26, 26′, 28, 28′; a first of the at least three adjacent stripes 24, 24′, 26, 26′, 28, 28′ is a color-forming stripe 24, 26, 28 in the color-forming layer 14 of the image-receiving substrate 12; a second of the at least three adjacent stripes 24, 24′, 26, 26′, 28, 28′ is a colored stripe 24′, 26′, 28′ in the color layer 14′ of the donor ribbon 40; and a third of the at least three adjacent stripes 24, 24′, 26, 26′, 28, 28′ is either a second color-forming stripe 24, 26, 28, in the color-forming layer 14 or a second colored stripe 24′, 26′, 28′ in the color layer 14′ of the donor ribbon 40.

In some other examples of the method 100, the repeat of the pattern includes the grid 30; a first of the four sections 32, 32′, 34, 34′, 36, 36′, 38, 38′ is a color-forming section 32, 34, 36, 38 in the color-forming layer 14 of the image-receiving substrate 12; a second of the four sections 32, 32′, 34, 34′, 36, 36′, 38, 38′ is a colored section 32′, 34′, 36′, 38′ in the color layer 14′ of the donor ribbon 40; and a third and a fourth of the four sections 32, 32′, 34, 34′, 36, 36′, 38, 38′ are one of: a second color-forming section 32, 34, 36, 38 in the color-forming layer 14 of the image-receiving substrate 12, and a second colored section 32′, 34′, 36′, 38′ in the color layer 14′ of the donor ribbon 40; or a second color-forming section 32, 34, 36, 38 in the color-forming layer 14 of the image-receiving substrate 12, and a third color-forming section 32, 34, 36, 38 in the color-forming layer 14 of the image-receiving substrate 12; or a second colored section 32′, 34′, 36′, 38′ in the color layer 14′ of the donor ribbon 40, and a third colored section 32′, 34′, 36′, 38′ in the color layer 14′ of the donor ribbon 40.

The method 100 of making the imaging medium 10 may be less complex and/or less expensive than the construction of a medium with a layer for each color to be formed (i.e., a black-forming layer, a cyan-forming layer, a magenta-forming layer, and a yellow-forming layer) with thermal barrier layers between each color-forming layer. The method 100 of making the imaging medium 10 may also be less complex and/or less expensive than the construction of a separate donor ribbon and image-receiving substrate.

As shown at reference numeral 102, the method 100 includes applying at least one color-forming ink to form a color-forming layer 14 of an image-receiving substrate 12. In an example, the at least one color-forming ink is applied directly on the base layer 11 to form the color-forming layer 14 directly on the base layer 11. In another example, the at least one color-forming ink is applied directly on the ink-receiving layer 13 to form the color-forming layer 14 directly on the ink-receiving layer 13.

In an example, the method 100 further includes coating the ink-receiving layer 13 on the base layer 11. Each of the base layer 11 and the ink-receiving layer 13 may be as described above.

In an example, the applying of the at least color-forming ink is accomplished with offset printing, inkjet printing, or flexographic printing.

In some examples, the at least color-forming ink is selected from the group consisting of a black-forming ink, a cyan-forming ink, a light cyan-forming ink, a magenta-forming ink, light magenta-forming ink, and a yellow-forming ink.

The at least one color-forming ink is applied to form the color-forming layer 14 of the image-receiving substrate 12. As such, the cyan-forming ink is applied where the cyan-forming stripe(s) 24, or the cyan-forming section(s) 34 and the color-forming section(s) 32 (when cyan-forming) are to be formed; the magenta-forming ink is applied where the magenta-forming stripe(s) 26, or the magenta-forming section(s) 36 and the color-forming section(s) 32 (when magenta-forming) are to be formed; and the yellow-forming ink is applied where the yellow-forming stripe(s) 28, or the yellow-forming section(s) 38 and the color-forming section(s) 32 (when yellow-forming) are to be formed. Additionally, the black-forming ink may be applied where the black-forming stripe(s) 22 or the color-forming section(s) 32 (when black-forming) are to be formed; the light cyan-forming ink may be applied where the color-forming section(s) 32 (when light cyan-forming) are to be formed; and the light magenta-forming ink may be applied where the color-forming section(s) 32 (when light magenta-forming) are to be formed. It is to be understood that when a color-forming stripe 22, 24, 26, 28 or section 32, 34, 36, 38 is not to be included in the color-forming layer 14 (but rather is to be included in the color layer 14′), the corresponding color-forming ink is not applied.

In some examples, one color-forming ink is applied across the entire base layer 11 or ink-receiving layer 13 to form the color-forming layer 14. In these examples, the color-forming layer 14 is a continuous layer of a single color-forming material that has a higher activation temperature than the transfer temperature of the transferable dyes used to form the color layer 14′. As such, the one color-forming ink is applied where the color-forming stripe(s) 22, 24, 26, 28 or sections 32, 34, 36, 38 are to be formed, and where the remaining portion of the color-forming layer 14 is to be formed.

Each of the inks may include a leuco dye that turns, respectively, black, cyan, magenta, and yellow in color when activated. As such, the black-forming ink may include a leuco dye that turns black in color when activated, the cyan-forming ink (and the light cyan-forming ink when used) may include a leuco dye that turns cyan in color when activated, the magenta-forming ink (and the light magenta-forming ink when used) may include a leuco dye that turns magenta in color when activated, and the yellow-forming ink may include a leuco dye that turns yellow in color when activated. Prior to being activated, the leuco dyes in the inks are colorless (i.e., achromatic). The leuco dyes may be any of the leuco dyes described above. The total amount of the leuco dye(s) present in each of the inks may range from about 1 wt % to about 10 wt %, based on the total weight of the ink. In another example, the total amount of the leuco dye(s) present in each of the inks may range from about 4 wt % to about 6 wt %, based on the total weight of the ink. In some examples, the light cyan-forming ink may include a lower amount (e.g., by weight) of leuco dye than the cyan-forming ink, and/or the light magenta-forming ink may include a lower amount (e.g., by weight) of leuco dye than the magenta-forming ink.

Each of the inks may additionally include the color-developer, the sensitizer, the stabilizer, the binder, or a combination thereof. Each of the color-developer, the sensitizer, the stabilizer, and the binder may be as described above. In an example, the total amount of color-developer(s) present in each of the inks may range from about 10 wt % to about 65 wt %, based on the total weight of the ink. In another example, the total amount of sensitizer(s) present in each of the inks may range from about 75 wt % to about 200 wt %, based on the weight of the color-developer(s). In still another example, the total amount of stabilizer(s) present in each of the inks may range from about 10 wt % to about 100 wt %, based on the total weight of leuco dye(s). In yet another example, the total amount of binder(s) present in each of the inks may range from about 0.5 wt % to about 10 wt %, based on the total weight of the ink. Higher binder amounts may be used, depending upon the type of ink.

Additionally, each of the inks may include a liquid vehicle. The liquid vehicle may enable the inks to be applied. As mentioned above, in some example, the inks may be applied via offset printing, inkjet printing, or flexographic printing. In these examples, the liquid vehicle may be formulated to enable the inks to be applied by the desired printing process. As such, the formulation of the liquid vehicle of each of the inks may depend, in part, upon the technique used to form the color-forming layer 14.

In some examples, the liquid vehicle of each of the inks may include water and one or more co-solvents. The co-solvent(s) may be present in an amount ranging from about 1 to about 25 wt % (based on the total weight of the ink). In some other examples, the vehicle may be a non-aqueous vehicle. In these examples, the vehicle solvent may be isopropyl alcohol or methyl ethyl ketone.

The liquid vehicle may also contain one or more surfactants present in an amount ranging from about 0.1 to about 8 wt % (based on the total weight of the ink).

The liquid vehicle may further include other components common to some inks, such as humectants, viscosity control agents, antimicrobial agents (e.g., biocides and fungicides), anti-kogation agents (for thermal inkjet printing), etc.

An example of a flexographic printing ink formulation includes at least 50 wt % water, a leuco dye dispersion, a developer dispersion, a binder (e.g., methacrylic resins), and a wax selected from the group consisting of polyolefin waxes, paraffin waxes, and mixed polyolefin and paraffin waxes dispersed in the water. The leuco dye dispersion may include the leuco dye, a water-soluble binder (e.g., polyvinyl alcohol, hydroxyethyl cellulose, or any of the other examples set forth herein for the color-forming layer 14), a surfactant, and water. The leuco dye dispersion may be present in an amount ranging from about 1 wt % to about 10 wt % based on a total weight of the flexographic printing ink formulation. The developer dispersion may include the developer, a water-soluble binder (e.g., polyvinyl alcohol, hydroxyethyl cellulose, or any of the other examples set forth herein for the color-forming layer 14), a surfactant, and water. The developer dispersion may be present in an amount ranging from about 2 wt % to about 20 wt % based on a total weight of the flexographic printing ink composition. The binder may be present in an amount ranging from about 4 wt % to about 20 wt %, and the wax may be present in an amount ranging from about 0.5 wt % to about 10 wt %. Additionally, the flexographic printing ink formulation may include the sensitizer and/or the stabilizer in the amounts given. Other suitable additives may include defoaming agents, softening or coalescing agents, rheology modifiers, and/or combinations thereof, wherein each is present in an amount of less than 0.2% by weight. The total solids in the flexographic printing ink formulation may be 30% or less.

An example of an offset printing ink formulation includes a leuco dye dispersion, a developer dispersion, a binder (e.g., phenolic resins, maleic acid resins, ester resins, petroleum resins, etc.), and water. The leuco dye dispersion may include the leuco dye, a water-soluble binder (e.g., polyvinyl alcohol, hydroxyethyl cellulose, or any of the other examples set forth herein for the color-forming layer 14), a surfactant, and water. The leuco dye dispersion may be present in an amount ranging from about 1 wt % to about 10 wt % based on a total weight of the offset printing ink formulation. The developer dispersion may include the developer, a water-soluble binder (e.g., polyvinyl alcohol, hydroxyethyl cellulose, or any of the other examples set forth herein for the color-forming layer 14), a surfactant, and water. The developer dispersion may be present in an amount ranging from about 2 wt % to about 20 wt % based on a total weight of the offset printing ink composition. The binder may be present in an amount ranging from about 40 wt % to about 95 wt %, and in some instances, the water may be present in amounts of 50 wt % or less. Additionally, the offset printing ink formulation may include the sensitizer and/or the stabilizer in the amounts given. Other suitable additives for offset inks include wax compounds, drying agents, dispersants, rheology modifiers, lubricants, fillers, and/or anti-oxidants.

An example of an inkjet printing ink formulation includes a leuco dye dispersion, a developer dispersion, a co-solvent, a surfactant, an anti-kogation agent (if to be thermally inkjetted), a binder, and a balance of water. The leuco dye dispersion may include the leuco dye, a water-soluble binder (e.g., polyvinyl alcohol, hydroxyethyl cellulose, or any of the other examples set forth herein for the color-forming layer 14), a surfactant, and water. The leuco dye dispersion may be present in an amount ranging from about 1 wt % to about 8 wt % based on a total weight of the ink composition. The developer dispersion may include the developer, a water-soluble binder (e.g., polyvinyl alcohol, hydroxyethyl cellulose, or any of the other examples set forth herein for the color-forming layer 14), a surfactant, and water. The developer dispersion may be present in an amount ranging from about 1 wt % to about 8 wt % based on a total weight of the ink composition. The surfactant in each of the leuco dye dispersion and the developer dispersion may be non-ionic and may be the same or different than the other surfactant included in the inkjet ink composition. The co-solvent may be any water-soluble organic solvent, such as 1,3-Bis(2-hydroxyethyl)-5,5-dimethylhydantoin, 1,2-hydroxyethyl-2-pyrollidone, 2-pyrrolidone, another like organic solvent, or combinations thereof. Whether used alone or in combination, each co-solvent (may be present in an amount ranging from about 0.5 wt % to about 5 wt % based on a total weight of the ink composition. The surfactant may be any suitable non-ionic surfactant, such as SURFYNOL® SEF (an acetylenic diol surface active agent from Evonik, Ind.). Whether used alone or in combination, each surfactant may be present in an amount ranging from about 0.1 wt % to about 2 wt % based on a total weight of the ink composition. The anti-kogation agent may include oleth-3-phosphate (commercially available as CRODAFOS™ O3A or CRODAFOS™ N-3 acid) or dextran 500k. The anti-kogation agent may be present in an amount ranging from about 0.25 wt % to about 2 wt % based on a total weight of the ink composition. The binder may be any suitable ink jettable binder, such as water-soluble sytrene acrylics, polyurethanes, polyvinyl alcohol, etc. An example of a suitable binder is JONCRYL® 683 (styrene acrylic from BASF Corp.). The binder may be present in an amount ranging from about 0.5 wt % to about 2 wt % based on a total weight of the ink composition.

As the inks dry, they form the color-forming stripe(s) 22, 24, 26, 28 or the color-forming section(s) 32, 34, 36, 38. As such, if applied, the cyan-forming ink forms the cyan-forming stripe(s) 24, or the cyan-forming section(s) 34 and the color-forming section(s) 32 (when cyan-forming) when it dries; if applied, the magenta-forming ink forms the magenta-forming stripe(s) 26, or the magenta-forming section(s) 36 and the color-forming section(s) 32 (when magenta-forming) when it dries; and, if applied, the yellow-forming ink forms the yellow-forming stripe(s) 28, or the yellow-forming section(s) 38 and the color-forming section(s) 32 (when yellow-forming) when it dries. Additionally, if applied, the black-forming ink may form the black-forming stripe(s) 22 or the color-forming section(s) 32 (when black-forming) when it dries; if applied, the light cyan-forming ink may form the color-forming section(s) 32 (when light cyan-forming) when it dries; and, if applied, the light magenta-forming ink may form the color-forming section(s) 32 (when light magenta-forming) when it dries. The portion of the repeat 20, 20′ of the pattern defined by the color-forming layer 14 may be formed to be as described above.

As shown at reference numeral 104, the method 100 may continue by applying at least one colored ink to form the color layer 14′ of the donor ribbon 40. In an example, the at least one colored ink is applied directly on the release layer 44 to form the color layer 14′ directly on the release layer 44. In another example, the at least one colored ink is applied directly on the clear and colorless topcoat 18 to form the color layer 14′ directly on the clear and colorless topcoat 18.

In an example, the applying of the at least one colored ink is accomplished with offset printing, inkjet printing, or flexographic printing.

In some examples, the at least one colored ink is selected from the group consisting of a black ink, a cyan ink, a light cyan ink, a magenta ink, light magenta ink, and a yellow ink.

The at least one colored ink is applied to form the color layer 14′ of the donor ribbon. As such, the cyan ink is applied where the cyan stripe(s) 24′, or the cyan section(s) 34′ and the colored section(s) 32′ (when cyan) are to be formed; the magenta ink is applied where the magenta stripe(s) 26′, or the magenta section(s) 36′ and the colored section(s) 32′ (when magenta) are to be formed; and the yellow ink is applied where the yellow stripe(s) 28′, or the yellow section(s) 38′ and the colored section(s) 32′ (when yellow) are to be formed. Additionally, the black ink may be applied where the black stripe(s) 22′ or the colored section(s) 32′ (when black) are to be formed; the light cyan ink may be applied where the colored section(s) 32′ (when light cyan) are to be formed; and the light magenta ink may be applied where the colored section(s) 32′ (when light magenta) are to be formed. It is to be understood that when a colored stripe 22′, 24′, 26′, 28′ or section 32′, 34′, 36′, 38′ is not to be included in the color layer 14′, the corresponding colored ink is not applied.

In an example, the cyan ink includes a cyan thermal transfer dye, the magenta ink includes a magenta thermal transfer dye, and the yellow ink includes a yellow thermal transfer dye. In another example, the black ink includes a black thermal transfer dye, the light cyan ink includes a cyan thermal transfer dye, and the light magenta ink includes a magenta thermal transfer dye. Each of the black thermal transfer dye, the cyan thermal transfer dye, the magenta thermal transfer dye, and the yellow thermal transfer dye may be a sublimable dye. The sublimable dyes may be any of the sublimable dyes described above. The total amount of the sublimable dye(s) present in each of the inks may range from about 1 wt % to about 10 wt %, based on the total weight of the ink. In another example, the total amount of the sublimable dye(s) present in each of the inks may range from about 4 wt % to about 6 wt %, based on the total weight of the ink. In some examples, the light cyan ink may include a lower amount (e.g., by weight) of sublimable dye than the cyan ink, and/or the light magenta ink may include a lower amount (e.g., by weight) of sublimable dye than the magenta ink.

Each of the inks may additionally include the binder. The binder may be as described above. In an example, the total amount of binder(s) present in each of the inks may range from about 0.5 wt % to about 10 wt %, based on the total weight of the ink. Higher binder amounts may be used, depending upon the type of ink.

Additionally, each of the inks may include a liquid vehicle. The liquid vehicle may enable the inks to be applied. As mentioned above, in some examples, the inks may be applied via offset printing, inkjet printing, or flexographic printing. In these examples, the liquid vehicle may be formulated to enable the inks to be applied by the desired printing process. As such, the formulation of the liquid vehicle of each of the inks may depend, in part, upon the technique used to form the color layer 14′.

In some examples, the liquid vehicle of each of the inks may include water and one or more co-solvents. The co-solvent(s) may be present in an amount ranging from about 1 to about 25 wt % (based on the total weight of the ink). In some other examples, the vehicle may be a non-aqueous vehicle. In these examples, the vehicle solvent may be isopropyl alcohol or methyl ethyl ketone.

The liquid vehicle may also contain one or more surfactants present in an amount ranging from about 0.1 to about 8 wt % (based on the total weight of the ink).

The liquid vehicle may further include other components common to some inks, such as humectants, viscosity control agents, antimicrobial agents (e.g., biocides and fungicides), anti-kogation agents (for thermal inkjet printing), etc.

An example of an offset ink formulation includes the thermal transfer dye, a binder (e.g., phenolic resins, maleic acid resins, ester resins, petroleum resins, etc.), and a high boiling point (160° C. or higher) solvent. The thermal transfer dye may be present in an amount ranging from about 1 wt % to about 10 wt % based on a total weight of the offset ink composition. The binder may be present in an amount ranging from about 40 wt % to about 95 wt %. Examples of the solvent include a paraffinic solvent, an isoparaffinic solvent, naphthenic solvent, alpha-olefin solvents, light oil, spindle oil, machine oil, cylinder oil, turpentine oil, mineral spirits, liquid paraffin, and the like. The solvent may be present in an amount ranging from about 5 wt % to about 50 wt %. Other suitable additives for offset inks include wax compounds, drying agents, dispersants, rheology modifiers, lubricants, fillers, and/or anti-oxidants.

A flexographic ink may include a solvent, the thermal transfer dye, and a binder. Examples of suitable solvents include hydrocarbons such as toluene or xylene, alcohols, for example ethanol, 1-propanol, 2-propanol, ethylene glycol, propylene glycol, or diethylene glycol, substituted alcohols, such as ethoxypropanol, esters, for example ethyl acetate, isopropyl acetate, n-propyl or n-butyl acetate. The solvent(s) may be present in an amount ranging from about 50 wt % to about 80 wt %, of the total weight of the flexographic ink. The thermal transfer dye may be present in an amount ranging from about 1 wt % to about 10 wt % based on a total weight of the flexographic ink composition. Examples of suitable binders include polyvinylbutyral, nitrocellulose, polyamides, polyacrylates, and polyacrylate copolymers. Another suitable binder is a hyperbranched polymer having functional groups. The binder(s) may account for from about 5 wt % to about 30 wt % based on a total weight of the flexographic ink composition.

An inkjet ink may also be used. This inkjet ink may include water, a water-soluble organic solvent and/or a humectant, and the thermal transfer dye. Examples of the water-soluble organic solvent include alkylene glycol. Specific examples include ethylene glycol, propylene glycol, 1,3-propanediol, 1,2-butanediol, 1,3-butanediol, 1,4-butanediol, 2,3 butanediol, 3-methyl-1,3-butanediol, 1,2-pentanediol, 1,5-pentanediol, 2-methyl-2,4-pentanediol, 3-methyl-1,5-pentanediol, 1,2-hexanediol, 1,6 monoalkylene glycol typified hexanediol diethylene glycol, triethylene glycol, polyalkylene glycol represented by dipropylene glycol. Other examples of the water-soluble organic solvent include acetone, ethanol, and methanol. The water-soluble organic solvent may be present in an amount ranging from about 1 wt % to about 20 wt % or in an amount ranging from about 1 wt % to about 10 wt %. Examples of the humectant include a high-boiling organic solvent, such as glycols (e.g., glycerin or polyethylene glycol), sugar alcohols, and saccharides. The humectant may be present in an amount ranging from about 15 wt % to about 40 wt %. The thermal transfer dye may be present in dispersed form in an amount ranging from about 1 wt % to about 10 wt % based on a total weight of the inkjet ink composition. Some example inkjet inks also include a dispersant.

Some examples the inkjet inks may also include a decap control agent to improve the decap performance of the inkjet ink. The term “decap performance,” as referred to herein, means the ability of the inkjet ink to readily eject from the printhead, upon prolonged exposure to air. Examples of the decap control agent include modified perfluoropolyethers, such as FLUOROLINK® A10, a dialkyl amide perfluoropolyether derivative with the chemical structure CH₃(CH₂)₁₇HNOCCF₂O(CF₂CF₂O)ₚ(CF₂O)_{q}CF₂CONH(CH₂)₁₇CH₃ available from Solvay-Solexis. The decap control agent may be present in an amount ranging from 0 wt % to about 1 wt %.

As the inks dry, they form the colored stripe(s) 22′, 24′, 26′, 28′ or the colored section(s) 32′, 34′, 36′, 38′. As such, if applied, the cyan ink forms the cyan stripe(s) 24′, or the cyan section(s) 34′ and the colored section(s) 32′ (when cyan) when it dries; if applied, the magenta ink forms the magenta stripe(s) 26′, or the magenta section(s) 36′ and the colored section(s) 32′ (when magenta) when it dries; and, if applied, the yellow ink forms the yellow stripe(s) 28′, or the yellow section(s) 38′ and the colored section(s) 32′ (when yellow) when it dries. Additionally, if applied, the black ink may form the black stripe(s) 22′, or the colored section(s) 32′ (when black) when it dries; if applied, the light cyan ink may form the colored section(s) 32′ (when light cyan) when it dries; and, if applied, the light magenta ink may form the colored section(s) 32′ (when light magenta) when it dries. The portion of the repeat 20, 20′ of the pattern defined by the color layer 14′ may be formed to be as described above.

In some examples, prior to the applying of the at least one colored ink, the method 100 may further include applying the release layer 44 on the front side 48 of the donor ribbon substrate 42; applying the back coat 46 on the back side 50 of the donor ribbon substrate 42; and/or applying the clear and colorless topcoat 18 on the release layer 44. In some other examples of the method 100, the donor ribbon substrate 42 may be obtained (e.g., purchased) with the release layer 44 and the back coat 46 already applied thereon. In these examples, the method 100 may further include applying a clear and colorless topcoat 18 on the release layer 44. The donor ribbon substrate 42 may be as described above.

In an example, the release layer 44 may be applied directly on the front side 48 of the donor ribbon substrate 42. The release layer 44 may be as described above.

In an example, the back coat 46 is applied directly on the back side 50 of the donor ribbon substrate 42. The back coat 46 may be as described above.

In another example, the clear and colorless topcoat 18 is applied directly on the release layer 44. In this example, the clear and colorless topcoat 18 may be formed before the color layer 14′, and thus the at least one colored ink may be applied directly on the clear and colorless topcoat 18 to form the color layer 14′ directly on the clear and colorless topcoat 18. In another example of the method 100, the application of the clear and colorless topcoat 18 is accomplished with offset printing, inkjet printing, or flexographic printing. The clear and colorless topcoat 18 may be as described above.

As shown at reference numeral 106, the method 100 may continue by attaching the donor ribbon 40 to the image-receiving substrate 12. In some examples, the donor ribbon 40 is attached to the image-receiving substrate 12 so that the color layer 14′ is in contact with the color-forming layer 14 so that the stripes or sections of the respective layers 14, 14′ are positioned to form the desired repeated pattern, but do not directly overlap one another. In one of these examples, the donor ribbon 40 is attached to the image-receiving substrate 12 so that the blank stripe(s) 21′ or section(s) of the color layer 14′ is/are in contact with the color-forming stripe(s) 22, 24, 26, 28 or section(s) 32, 34, 36, 38 of the color-forming layer 14 and the blank stripe(s) 21 or section(s) of the color-forming layer 14 is/are in contact with the colored stripe(s) 22′, 24′, 26′, 28′ or section(s) 32′, 34′, 36′, 38′ of the color layer 14′. In another of these examples, the donor ribbon 40 is attached to the image-receiving substrate 12 so that the blank stripe(s) 21′ or section(s) of the color layer 14′ is/are in contact with the color-forming stripe(s) 22, 24, 26, 28 or section(s) 32, 34, 36, 38 of the color-forming layer 14 and a remaining portion of the color-forming layer 14 is in contact with the colored stripe(s) 22′, 24′, 26′, 28′ or section(s) 32′, 34′, 36′, 38′ of the color layer 14′. In this example, the remaining portion of the color-forming layer 14 does not include blank stripes and/or sections, but rather has the same composition as the color-forming stripe 22, 24, 26, or 28 or section 32, 34, 36, 38, which includes a dye that is activatable at a higher temperature than the transfer temperature of the dyes in the colored stripe(s) 22′, 24′, 26′, 28′ or section(s) 32′, 34′, 36′, 38′. As such, in this example, the remaining portion of the color-forming layer 14 functions as the blank stripes and/or sections because they are not activated.

In an example of the method 100, the attaching of the donor ribbon 40 to the image-receiving substrate 12 is accomplished by lamination.

In some examples, the method 100 further comprises applying a registration mark 13 on a component of the donor ribbon 40 or the image-receiving substrate 12. The registration mark 16 may be as described above.

In an example, the registration mark 16 is applied on the donor ribbon substrate 42, on the back coat 46, on the release layer 44, on the clear and colorless topcoat 18, on the color layer 14′, on the color-forming layer 14, on the base layer 11, or the ink-receiving layer 13. In another example, the registration mark 16 is applied directly on the donor ribbon substrate 42, directly on the back coat 46, directly on the release layer 44, directly on the clear and colorless topcoat 18, directly on the color layer 14′, directly on the color-forming layer 14, directly on the base layer 11, or directly on the ink-receiving layer 13.

In an example, the registration mark 16 is applied in the color-forming layer 14. In this example, the applying of the registration mark 16 may be accomplished during the applying of the at least one color-forming ink. In another example, the registration mark 16 is applied in the color layer 14′. In this example, the applying of the registration mark 16 may be accomplished during the applying of the at least one colored ink. When the registration mark 16 is applied in the color-forming layer 14 and/or the color layer 14′, a registration mark precursor (e.g., an electronic material, a material that emits or reacts to NIR radiation, or a material that emits or reacts to UV radiation) may be included in one or more of the inks used to form the repeated pattern.

In an example, the applying of the registration mark 16 may include applying a single registration mark 16 or multiple registration marks 16.

Printing Systems

Also disclosed herein is a printing system. In one example, the printing system comprises: a thermal printhead including a row of thermal resistors; and an imaging medium 10 including: an image-receiving substrate 12 including a color-forming layer 14; a donor ribbon 40 attached to the image-receiving substrate 12 and including a color layer 14′; and a repeated pattern defined by a portion of the color-forming layer 14 and a portion of the color layer 14′, a repeat 20 of the pattern including: at least three adjacent stripes 24, 24′, 26, 26′, 28, 28′ including a cyan or cyan-forming stripe 24, 24′, a magenta or magenta-forming stripe 26, 26′, and a yellow or yellow-forming stripe 28, 28′, wherein: a first of the at least three adjacent stripes 24, 24′, 26, 26′, 28, 28′ is a color-forming stripe 24, 26, 28 in the color-forming layer 14 of the image-receiving substrate 12; a second of the at least three adjacent stripes 24, 24′, 26, 26′, 28, 28′ is a colored stripe 24′, 26, 28′ in the color layer 14′ of the donor ribbon 40; and a third of the at least three adjacent stripes 24, 24′, 26, 26′, 28, 28′ is either a second color-forming stripe 24, 26, 28 in the color-forming layer 14 or a second colored stripe 24′, 26, 28′ in the color layer 14′ of the donor ribbon 40; and wherein a width W₂₄, W_{24′}, W₂₆, W_{26′}, W₂₈, W_{28′} of each stripe 24, 24′, 26, 26′, 28, 28′ is equal to a width of the row of thermal resistors.

In another example, the printing system comprises: a thermal printhead including a row of thermal resistors; and an imaging medium 10 including: an image-receiving substrate 12 including a color-forming layer 14; and a donor ribbon 40 attached to the image-receiving substrate 12 and including a color layer 14′; and a repeated pattern defined by a portion of the color-forming layer 14 and a portion of the color layer 14′, a repeat 20′ of the pattern including: a grid 30 of four sections 32, 32′, 34, 34′, 36, 36′, 38, 38′ including i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′; wherein: a first of the four sections 32, 32′, 34, 34′, 36, 36′, 38, 38′ is a color-forming section 32, 34, 36, 38 in the color-forming layer 14 of the image-receiving substrate 12; a second of the four sections 32, 32′, 34, 34′, 36, 36′, 38, 38′ is a colored section 32′, 34′, 36′, 38′ in the color layer 14′ of the donor ribbon 40; and a third and a fourth of the four sections 32, 32′, 34, 34′, 36, 36′, 38, 38′ are one of: a second color-forming section 32, 34, 36, 38 in the color-forming layer 14 of the image-receiving substrate 12, and a second colored section 32′, 34′, 36′, 38′ in the color layer 14′ of the donor ribbon 40; or a second color-forming section 32, 34, 36, 38 in the color-forming layer 14 of the image-receiving substrate 12, and a third color-forming section 32, 34, 36, 38 in the color-forming layer 14 of the image-receiving substrate 12; or a second colored section 32′, 34′, 36′, 38′ in the color layer 14′ of the donor ribbon 40, and a third colored section 32′, 34′, 36′, 38′ in the color layer 14′ of the donor ribbon 40; and wherein a width W₃₂, W_{32′}, W₃₄, W_{34′}, W₃₆, W_{36′}, W₃₈, W_{38′} of each section 32, 32′, 34, 34′, 36, 36′, 38, 38′ is equal to a width of each of the thermal resistors and a length L₃₂, L_{32′}, L₃₄, L_{34′}, L₃₆, L_{36′}, L₃₈, L_{38′} of each section 32, 32′, 34, 34′, 36, 36′, 38, 38′ is equal to a length of each of the thermal resistors.

The thermal printhead may be a component of a printer. The thermal printhead includes a row of thermal resistors. The thermal printhead may include one row of thermal resistors or multiple rows of thermal resistors.

The thermal resistors are capable of selectively exposing the imaging medium 10 to heat. In an example, the thermal resistors are capable of selectively exposing the imaging medium 10 to a temperature ranging from about 70° C. to about 300° C. for a time period ranging from about 10 μs to about 200 μs. In another example, the thermal resistors are capable of selectively exposing the imaging medium 10 to a temperature ranging from about 70° C. to about 200° C. for a time period ranging from about 10 μs to about 200 μs. In still another example, the thermal resistors are capable of selectively exposing the imaging medium 10 to a temperature ranging from about 70° C. to about 100° C. for a time period ranging from about 10 μs to about 200 μs.

As examples, the thermal resistors may have a width and/or length of 1/300^{th} of an inch or smaller, 1/600^{th} of an inch or smaller, or 1/1200^{th} of an inch or smaller. In some examples, the size of each thermal resistor is equivalent to the width W₂₂, W_{22′}, W₂₄, W_{24′}, W₂₆, W_{26′}, W₂₈, W_{28′} of each stripe 22, 22′, 24, 24′, 26, 26′, 28, 28′ or to the size of each section 32, 32′, 34, 34′, 36, 36′, 38, 38′, and thus a single thermal resistor may be used to activate or transfer a single section 32, 32′, 34, 34′, 36, 36′, 38, 38′ or a portion of the stripe 22, 22′, 24, 24′, 26, 26′, 28, 28′.

The thermal printhead may be part of the printer, which may also be able to detect the registration mark 16, optically or electronically. The printer may then use the registration mark 16 to determine the location(s) of particular stripe(s) 22, 22′, 24, 24′, 26, 26′, 28, 28′ or section(s) 32, 32′, 34, 34′, 36, 36′, 38, 38′ where heat should be selectively applied to the imaging medium 10 to form a colored image.

The imaging medium 10 may be as described above.

Methods of Making a Colored Image

Also disclosed herein are methods of making a colored image. Generally, the method includes selectively exposing an imaging medium to heat; wherein the imaging medium includes: an image-receiving substrate including a color-forming layer; a donor ribbon attached to the image-receiving substrate and including a color layer; and a repeated pattern, wherein a repeat of the pattern is defined by a portion of the color-forming layer and a portion of the color layer; and wherein the selectively exposing of the imaging medium to heat one of: activates a respective color-forming dye in the color-forming layer; or transfers a respective dye from the color layer to the color-forming layer.

In a more specific example, the method of making the colored image comprises: selectively exposing an imaging medium 10 to heat; wherein the imaging medium 10 includes: an image-receiving substrate 12 including a color-forming layer 14; a donor ribbon 40 attached to the image-receiving substrate 12 and including a color layer 14′; and a repeated pattern defined by a portion of the color-forming layer 14 and a portion of the color layer 14′, a repeat 20 of the pattern including: at least three adjacent stripes 24, 24′, 26, 26′, 28, 28′ including a cyan or cyan-forming stripe 24, 24′, a magenta or magenta-forming stripe 26, 26′, and a yellow or yellow-forming stripe 28, 28′, wherein: a first of the at least three adjacent stripes 24, 24′, 26, 26′, 28, 28′ is a color-forming stripe 24, 26, 28 in the color-forming layer 14 of the image-receiving substrate 12; a second of the at least three adjacent stripes 24, 24′, 26, 26′, 28, 28′ is a colored stripe 24′, 26, 28′ in the color layer 14′ of the donor ribbon 40; and a third of the at least three adjacent stripes 24, 24′, 26, 26′, 28, 28′ is either a second color-forming stripe 24, 26, 28 in the color-forming layer 14 or a second colored stripe 24′, 26, 28′ in the color layer 14′ of the donor ribbon 40; and wherein the selectively exposing of the imaging medium 10 to heat at least one of: activates a respective color-forming dye in the color-forming stripe or in the second color-forming stripe; or transfers, to the image-receiving substrate 12, a respective dye from the colored stripe or the second colored stripe.

In another more specific example, the method of making the colored image comprises: selectively exposing an imaging medium 10 to heat; wherein the imaging medium 10 includes: an image-receiving substrate 12 including a color-forming layer 14; and a donor ribbon 40 attached to the image-receiving substrate 12 and including a color layer 14′; and a repeated pattern defined by a portion of the color-forming layer 14 and a portion of the color layer 14′, a repeat 20′ of the pattern including: a grid 30 of four sections 32, 32′, 34, 34′, 36, 36′, 38, 38′ including i) a section 32, 32′ selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section 34, 34′, iii) a magenta or magenta-forming section 36, 36′, and iv) a yellow or yellow-forming section 38, 38′; wherein: a first of the four sections 32, 32′, 34, 34′, 36, 36′, 38, 38′ is a color-forming section 32, 34, 36, 38 in the color-forming layer 14 of the image-receiving substrate 12; a second of the four sections 32, 32′, 34, 34′, 36, 36′, 38, 38′ is a colored section 32′, 34′, 36′, 38′ in the color layer 14′ of the donor ribbon 40; and a third and a fourth of the four sections 32, 32′, 34, 34′, 36, 36′, 38, 38′ are one of: a second color-forming section 32, 34, 36, 38 in the color-forming layer 14 of the image-receiving substrate 12, and a second colored section 32′, 34′, 36′, 38′ in the color layer 14′ of the donor ribbon 40; or a second color-forming section 32, 34, 36, 38 in the color-forming layer 14 of the image-receiving substrate 12, and a third color-forming section 32, 34, 36, 38 in the color-forming layer 14 of the image-receiving substrate 12; or a second colored section 32′, 34′, 36′, 38′ in the color layer 14′ of the donor ribbon 40, and a third colored section 32′, 34′, 36′, 38′ in the color layer 14′ of the donor ribbon 40; and wherein the selectively exposing of the imaging medium 10 to heat at least one of: activates a respective color-forming dye in the color-forming section, in the second color-forming section, or in the third color-forming section; or transfers, to the image-receiving substrate 12, a respective dye from the colored section, the second colored section, or the third colored section.

The method includes selectively exposing the imaging medium 10 to heat. In some examples, the selectively exposing of the imaging medium 10 to heat is accomplished with a thermal printhead including a row of thermal resistors. In one of these examples, the selectively exposing of the imaging medium 10 to heat is accomplished in a single pass of the thermal printhead over the imaging medium 10. In this example, the printing speed of the method may be faster than the printing speed of a comparative method that uses a medium with a layer for each color to be formed, as the comparative method may involve multiple passes (e.g., to create multicolored images). In this example, the printing speed of the method may also be faster than the printing speed of another comparative method that uses a donor ribbon with successive patches of differently-colored or different color-forming material, as the other comparative method may involve multiple passes (e.g., to create multicolored images). In an example, the printing speed of the method may be faster than the comparative method and/or the other comparative method by 20% or more.

In an example, the heat may be selectively applied to the imaging medium 10 from the back of the donor ribbon 40. As such, the printhead and/or the thermal resistors may be in contact with the back side 50 of the donor ribbon substrate 42 or the back coat 46 during the selectively exposing of the imaging medium 10 to heat.

In some examples, the method further comprises aligning a thermal resistor of a thermal printhead at a location adjacent to a back side of the donor ribbon 40, where the location is aligned with the at least the portion of one or more of the stripes 22, 22′, 24, 24′, 26, 26′, 28, 28′ or the sections 32, 32′, 34, 34′, 36, 36′, 38, 38′ and wherein the selectively exposing of the imaging medium 10 to heat is accomplished with the thermal resistor. As used herein in reference to the donor ribbon 40, the term “back side” may refer to the side opposed to the side to which the image-receiving substrate 12 is be attached.

The selectively exposing of the imaging medium 10 to heat may activate at least a portion of one or more of the color-forming stripes 22, 24, 26, 28 or the color-forming sections 32, 34, 36, 38 in one or more of the repeats 20, 20′. The selectively exposing of the imaging medium 10 to heat may, additionally or alternatively, transfer (via diffusion or sublimation), to the image-receiving substrate 12, the thermal transfer dye from at least a portion of one or more of the colored stripes 22′, 24′, 26′, 28′ or the colored sections 32′, 34′, 36′, 38′ in one or more of the repeats 20, 20′.

It is to be understood that all or less than all of the dye(s) in the stripe(s) 22, 22′, 24, 24′, 26, 26′, 28, 28′ or section(s) 32, 32′, 34, 34′, 36, 36′, 38, 38′ may be activated or transferred during a single heating event, and this may depend upon the size of the stripe(s) 22, 22′, 24, 24′, 26, 26′, 28, 28′ or section(s) 32, 32′, 34, 34′, 36, 36′, 38, 38′, the size of the thermal resistor, and/or the number of thermal resistors that are activated during the heating event. For example, when the width of each thermal resistor 46 is equivalent to the width W₂₂, W_{22′}, W₂₄, W_{24′}, W₂₆, W_{26′}, W₂₈, W_{28′} of each stripe 22, 22′, 24, 24′, 26, 26′, 28, 28′ but the length of each thermal resistor 46 is less than the length L of each stripe 22, 22′, 24, 24′, 26, 26′, 28, 28′ several thermal resistors in a row may be activated in order to generate color along the stripe 22, 22′, 24, 24′, 26, 26′, 28, 28′. For another example, when the size of each thermal resistor is equivalent to the size of each section 32, 32′, 34, 34′, 36, 36′, 38, 38′, a single thermal resistor may be activated in order to generate color at a single section 32, 32′, 34, 34′, 36, 36′, 38, 38′, or any number of thermal resistors 46 may be activated in order to generate color at the same number of aligned sections 32, 32′, 34, 34′, 36, 36′, 38, 38′.

The activation of at least a portion of one or more of the color-forming stripes 22, 24, 26, 28 or the color-forming sections 32, 34, 36, 38 in one or more of the repeats 20, 20′ and/or the transfer to the image-receiving substrate 12 of the dye(s) in the at least a portion of one or more of the colored stripes 22′, 24′, 26′, 28′ or the colored sections 32′, 34′, 36′, 38′ in one or more of the repeats 20, 20′ forms the colored image.

In an example of the method, the dyes in at least a portion of at least two of the stripes 22, 22′, 24, 24′, 26, 26′, 28, 28′ or sections 32, 32′, 34, 34′, 36, 36′, 38, 38′ in one or more of the repeats 20, 20′ are activated or transferred. In another example of the method, the dyes in at least a portion of at least three of the stripes 22, 22′, 24, 24′, 26, 26′, 28, 28′ or sections 32, 32′, 34, 34′, 36, 36′, 38, 38′ in one or more of the repeats 20, 20′ is activated or transferred. In still another example of the method, the dyes in at least a portion of four of the stripes 22, 22′, 24, 24′, 26, 26′, 28, 28′ or sections 32, 32′, 34, 34′, 36, 36′, 38, 38′ in one or more of the repeats 20, 20′ is activated or transferred. In all of these examples, the activation or transfer of the dyes forms a multicolored image.

When the dye(s) are transferred to the image-receiving substrate 12, they may be disposed on the image-receiving substrate 12. In some of these examples, the dye(s) may be at least partially absorbed into the image-receiving substrate 12 or a portion of the image-receiving substrate 12 (e.g., the ink-receiving layer 13). In others of these examples, the dye(s) may form a film or layer (which may be non-continuous) on the image-receiving substrate 12.

In some examples, the selectively exposing of the imaging medium 10 to heat is accomplished such that each stripe 22, 22′, 24, 24′, 26, 26′, 28, 28′, section 32, 32′, 34, 34′, 36, 36′, 38, 38′, or portion thereof (or the dye therein) that is activated or transferred is exposed to the same heat exposure conditions. In other examples, the selectively exposing of the imaging medium 10 to heat is accomplished such that a lower temperature is used to transfer each colored stripe 22′, 24′, 26′, 28′ or section 32′, 34′, 36′, 38′, and a higher temperature is used to activate the color-forming stripe 22, 24, 26, 28 or section 32, 34, 36, 38.

In one example of the method of making the colored image, the heat exposure conditions include heating each stripe 22, 22′, 24, 24′, 26, 26′, 28, 28′, section 32, 32′, 34, 34′, 36, 36′, 38, 38′, or portion thereof (and thus the dye(s) therein) that is to be activated or transferred to a temperature ranging from about 70° C. to about 300° C. for a time period ranging from about 10 μs to about 200 μs. In another example, the heat exposure conditions include heating each stripe 22, 22′, 24, 24′, 26, 26′, 28, 28′, section 32, 32′, 34, 34′, 36, 36′, 38, 38′, or portion thereof (and thus the dye(s) therein) that is to be activated or transferred to a temperature ranging from about 70° C. to about 200° C. for a time period ranging from about 10 μs to about 200 μs. In still another example, the heat exposure conditions include heating each stripe 22, 22′, 24, 24′, 26, 26′, 28, 28′, section 32, 32′, 34, 34′, 36, 36′, 38, 38′, or portion thereof (and thus the dye(s) therein) that is to be activated or transferred to a temperature ranging from about 70° C. to about 100° C. for a time period ranging from about 10 μs to about 200 μs. In yet another, the heat exposure conditions include heating each stripe 22, 22′, 24, 24′, 26, 26′, 28, 28′, section 32, 32′, 34, 34′, 36, 36′, 38, 38′, or portion thereof (and thus the dye(s) therein) that is to be activated or transferred for a time period of about 100 μs.

Heating at the same conditions may simplify the temperature control process and may also consume less power than the comparative method that uses a medium with a stack of layers including an individual layer for each color to be formed (i.e., a black-forming layer, a cyan-forming layer, a magenta-forming layer, and a yellow-forming layer), as the comparative method may involve heating at a different temperature for a different time period to form each color.

It is to be understood that when the colored stripe(s) 22′, 24′, 26′, 28′ or section(s) 32′, 34′, 36′, 38′ is/are transferable at a lower temperature than the temperature at which the color-forming stripe(s) 22, 24, 26, 28 or section(s) 32, 34, 36, 38 is/are activatable, the heat exposure conditions may include heating each colored stripe 22′, 24′, 26′, 28′ or section 32′, 34′, 36′, 38′ to a first temperature, and then heating each color-forming stripe 22, 24, 26, 28 or section 32, 34, 36, 38 to a second temperature. The first temperature may be lower than the second temperature, and each of the first and second temperatures may be within the disclosed ranges.

When the colored stripe(s) 22′, 24′, 26′, 28′ or section(s) 32′, 34′, 36′, 38′ are transferable at a lower temperature than the temperature at which the color-forming stripe 22, 24, 26, 28 or section 32, 34, 36, 38 is activatable, the color-forming layer 14 to be a continuous layer of a single color-forming material (i.e., the stripe or section color-forming material). As such, the method of making the imaging medium 10 may be simplified.

In some examples, after making the colored image, the method may include removing the donor ribbon 40 from the image-receiving substrate 12. When the donor ribbon 40 is attached to the image-receiving substrate 12 by lamination, the donor ribbon 40 may be removed from the image-receiving substrate 12 by peeling the donor ribbon 40 from the image-receiving substrate 12. In an example, the imaging medium 10 may include a perforated tear tab at or near one end or both ends of the imaging medium 10. This perforated tear tab may allow for easy removal of the donor ribbon 40 from the image-receiving substrate 12 after printing/thermal imaging.

Separating the donor ribbon 40 from the image-receiving substrate 12 reveals the colored image on the surface of the image-receiving substrate 12 that had been in contact with the donor ribbon 40.

The colored image produced by the method may have better image quality than an image produced by the comparative method that uses a medium with a layer for each color to be formed (i.e., a black-forming layer, a cyan-forming layer, a magenta-forming layer, and a yellow-forming layer) and/or an image produced by the other comparative method that uses a donor ribbon with successive patches of differently-colored or different color-forming material. The image quality may be better due to higher resolution, which may be a result of the size (e.g., width, length, area, etc.) of the stripes 22, 22′, 24, 24′, 26, 26′, 28, 28′ or sections 32, 32′, 34, 34′, 36, 36′, 38, 38′ and/or the size (e.g., width, length, area, etc.) of the thermal resistors 46. The image quality may also be better due to reduced cross talk between colors as compared to the amount of cross talk between colors that may occur in the comparative method that uses a medium with a layer for each color to be formed.

Moreover, as thermal imaging using the imaging medium 10 disclosed herein does not use a donor ribbon that is separate from the image-receiving substrate 12, thermal imaging using the imaging medium 10 may use about ¼^{th} of the amount of a donor ribbon to produce a colored image than a comparative imaging medium that uses a separate donor ribbon. Additionally, a separate cartridge (for collecting the used separate donor ribbon) is not used. Thus, the imaging medium 10 may produce less waste than media that use a separate donor ribbon.

To further illustrate the present disclosure, a prophetic example is given herein. It is to be understood that this example is provided for illustrative purposes and is not to be construed as limiting the scope of the present disclosure.

### Prophetic Example

Examples of the imaging medium can be prepared in accordance with the examples disclosed herein.

Image-Receiving Substrates

An image-receiving substrate can be selected for the imaging medium. In this prophetic example, two image-receiving substrates (PE1 and PE2) include an ink-receiving layer, one image-receiving substrate (PE3) is a photopaper, and another image-receiving substrate (PE4) is a transparency sheet.

The ink-receiving layer compositions for PE1 and PE2 are shown in Table 1.

TABLE 1

| | | PE1 | PE2 |
|---|---|---|---|
| Component | Specific Component | Dry parts | Dry parts |
| Inorganic | Precipitated Calcium Carbonate | 50 | 55 |
| pigment | OPACARB ® A40 | | |
| | (Specialty Minerals) | | |
| | Modified calcium carbonate | 20 | 15 |
| | OMYAJET ® 5010 (Omya Inc.) | | |
| | Calcined clay | 30 | 30 |
| | ANSILEX ® 93 (BASF Corp.) | | |
| Plastic | DPP 756A (Dow Chemical Co.) | 5 | 5 |
| Pigment | | | |
| Binder | Styrene acrylic latex | 11 | 11 |
| | ACRONAL ® S728 (BASF Corp.) | | |
| | Polyvinyl alcohol | 0.5 | 0.5 |
| | MOWIOL ® 40-88 | | |
| | (Kuraray Europe) | | |
| Dispersant | Acrylic homopolymer | 0.2 | 0.2 |
| and/or | ACUMER ® 9300 | | |
| Rheology | (Dow Chemical Co.) | | |
| Modifier | acrylic acid/alkyl acrylate | 0.2 | 0.2 |
| | copolymer | | |
| | STEROCOLL ® FS (BASF Corp.) | | |
| pH modifier | KOH | 0.5 | 0.5 |
| Surfactant | Surfactant 10G | 0.3 | 0.3 |
| | (Dixie Chemical Co.) | | |
| Defoamer | FOAMMASTER ® VF | 0.3 | 0.3 |
| | (BASF Corp.) | | |
| Optical | TINOPAL ® ABP | 0.5 | 0.5 |
| Brightener | (BASF Corp.) | | |

The ink-receiving layer compositions can be mixed with water to obtain dispersions with 54% solids. Each coating composition can be applied onto an non-coated, lightly calendered paper base made from cellulosic fibers. The coatings can be applied using a blade coater to obtain a coating layer with a coat weight of about 20 gsm. The coated substrates PE1 and PE2 can be dried and then calendered at 2500 psi (pounds per square inch), 54° C., 1 pass.

The photopaper substrate PE3 can include an ink receiving layer coated on a photobase, which can include a highly sized cellulosic paper extruded with a polyethylene coating on both sides. The ink-receiving layer composition for PE3 is shown in Table 2.

TABLE 2

| | | Wt % of Total |
|---|---|---|
| Component | Specific Component | Composition* |
| Inorganic pigment | Silica Dispersion | 78.1 |
| Binder | Polyvinyl Alcohol | 16.8 |
| | (Mowiol 40-88) | |
| Co-solvent | Thio diethylene glycol | 1.9 |
| Binder Crosslinker | Boric acid | 3.0 |
| Surfactant | Surfactant 10G | 35 mg/100 g of |
| | | coating mixture |
| | Water | Balance |

*unless presented otherwise

This ink-receiving layer composition can be applied to the standard resin-coated photobase (a highly sized cellulosic paper extruded with a polyethylene coating on both sides) using a Meyer rod coater to 27 gsm coat weight.

The transparency sheet image-receiving substrate (PE4) can be prepared as follows: 180 grams of methanol can heated to near boiling and 20 grams of poly(methylvinylether/maleic anhydride) can be slowly added with continuous stirring. After 3 to 4 hours the milky, opaque solution can turn clear. The clear solution can be coated onto a 100 micrometer thick polyester sheet (which can be primed with polyvinylidene chloride) to a wet thickness of about 75 micrometers on a knife coater. The coated sheet can then be dried in an 80° C. oven for about 2 to 3 minutes to remove the solvent.

Color-Forming Layer

The color-forming layer can include the repeated pattern of two adjacent color-forming stripes and two adjacent blank stripes. A black-forming ink and a magenta-forming ink can be inkjet printed on the any of the substrates of this prophetic example to form the color-forming layer.

For each of the inks, a leuco dye dispersion and a developer dispersion are prepared separately and then combined to from the respective inks.

Magenta-forming ink: A leuco magenta dye, 3,3-bis(I-n-butyl-2-methyl-indol-3-yl)phthalide (Red 40), is dispersed in an aqueous mixture of a binder, e.g., AIRVOL® 205 (a grade of poly(vinyl alcohol) available from Air Products and Chemicals, Inc.; 4.5% of total solids), and a surfactant, e.g., PLURONIC® 25R2 (BASF Corp.; 1.5% of total solids) and/or AEROSOL® OT (The Dow Chemical Co.; 5.0% of total solids), in deionized water, using an attriter equipped with glass beads. Stirring can take place for a time ranging from about 24 hours to about 36 hours at a temperature ranging from about 2° C. to about room temperature (e.g., from 18° C. to about 22° C.). The average particle size of the resulting dispersion ranges from about 0.1 μm to about 0.15 μm. A developer, bis(3-allyl-4-hydroxyphenyl)sulfone, is dispersed in an aqueous mixture of a binder (e.g., AIRVOL® 205), a surfactant (e.g., PLURONIC® 25R2), and deionized water using an attriter equipped with glass beads. Stirring can take place for a time ranging from about 24 hours to about 36 hours at a temperature ranging from about 2° C. to about room temperature (e.g., from 18° C. to about 22° C.). The average particle size of the resulting dispersion ranges from about 0.1 μm to about 0.15 μm. The magenta dye dispersion and the developer dispersion can be mixed together with a co-solvent, a surfactant, a binder, an anti-kogation agent (e.g., if to be thermally inkjetted), and water to form the magenta-forming ink. Table 3 illustrates an example of the magenta ink formulation.

TABLE 3

| Component | Specific Component | Weight % |
|---|---|---|
| Co-solvent | 1,3-Bis(2-hydroxyethyl)-5,5- | 2.00 |
| | dimethylhydantoin | |
| | 1,2-Hydroxyethyl-2-Pyrollidone | 1.50 |
| Surfactant | SURFYNOL ® SEF (as is @75%) | 0.65 |
| | Evonik Ind. | |
| Anti-kogation | CRODAFOS ® N3 Acid Croda Int. | 0.75 |
| agent | | |
| Binder | JONCRYL ® 683 BASF Corp. | 1.50 |
| Leuco dye | Leuco dye dispersion* | 4.00 |
| Developer | Developer dispersion* | 6.00 |

*Selected based on color that is to be formed

Black-forming ink: A leuco black dye dispersion and a developer dispersion can be prepared the same way as the leuco magenta dye dispersion and its developer, except that 2-anilino-3-methyl-6-diethylaminofluoran is used as the black leuco dye and benzyl 4-hydroxybenzoate is used as the developer. The leuco black dye dispersion and its developer dispersion can be combined in a formulation similar to that shown in Table 3 (with the leuco black dye dispersion and its developer dispersion replacing the magenta dye dispersion and its developer dispersion).

As mentioned herein, each of the black-forming ink and the magenta-forming ink can be inkjet printed on the substrate in the two adjacent color-forming and two blank stripe pattern disclosed herein to form the color-forming layer. In this prophetic example, each color-forming stripe has a width of 1/300^{th} of an inch, and each blank stripe has a width of 1/300^{th} of an inch. The ink formulations include a polymeric binder, which can help adhere the ink to the substrate. Moreover, it is believed that the inks are likely to result in colorless stripes that when activated will develop to form the respective colors.

Donor Ribbon

The donor ribbon for the imaging medium can include the donor ribbon substrate, the release layer, and the color layer. The donor ribbon substrate can be a polyethylene terephthalate (PET) film, and the release layer can be a polyethylene wax deposited on the PET film.

Color Layer

The color layer can include the repeated pattern of two adjacent colored stripes and two adjacent blank stripes. A cyan ink and a yellow ink can be inkjet printed on the release layer in the two adjacent colored and two blank stripe pattern disclosed herein to form the color layer.

For each of the inks a thermal transfer dye is combined with a solvent mixture and a decap control agent to from the respective inks.

Cyan ink: Blue solvent dye (C. I. Solvent Blue 35) is combined with a solvent mixture and a decap control agent to form the cyan ink. The solvent mixture may include acetone and/or ethanol. The decap control agent may be a modified perfluoropolyether (such as FLUOROLINK® A10, a dialkyl amide perfluoropolyether derivative with the chemical structure CH₃(CH₂)₁₇HNOCCF₂O(CF₂CF₂O)ₚ(CF₂O)_{q}CF₂CONH(CH₂)₁₇CH₃ available from Solvay-Solexis). Table 4 illustrates examples of the cyan ink formulation.

TABLE 4

| Component | Specific Component | Wt % |
|---|---|---|
| Thermal | Solvent dye* | 3-7.5 |
| transfer dye | | |
| Decap | FLUOROLINK ® A10 | 0.1-1 |
| control agent | Solvay-Solexis | |
| Solvent | Acetone | 1-80 |
| mixture | Ethanol | Balance |

*Selected based on color that is to be formed

Yellow ink: A yellow ink can be prepared the same way as the cyan ink, except that yellow solvent dye (C. I. Solvent Yellow 56) is used as the yellow thermal transfer dye. The yellow solvent dye can be combined with a solvent mixture and a decap control agent to produce a formulation similar to that shown in Table 4 (with the yellow solvent dye replacing the magenta solvent dye).

As mentioned herein, each of the cyan ink and the yellow ink can be inkjet printed on the release layer of the donor ribbon in the two adjacent colored and two blank stripe pattern disclosed herein to form the color layer. In this prophetic example, each colored stripe has a width of 1/300^{th} of an inch, and each blank stripe has a width of 1/300^{th} of an inch.

Imaging Medium

The color layer of the donor ribbon and the color-forming layer of the image-receiving side of the selected image-receiving substrate can be placed into contact. The donor ribbon and the selected image-receiving substrate can be aligned so that the blank stripes of the color layer are in contact with the color-forming stripes of the color-forming layer 14 and the blank stripes of the color-forming layer 14 are in contact with the colored stripes of the color layer. A pressure sensitive adhesive may be applied to the edge between the donor ribbon and the image-receiving substrate to form the imaging medium.

It is to be understood that the ranges provided herein include the stated range and any value or sub-range within the stated range, as if the value(s) or sub-range(s) within the stated range were explicitly recited. For example, from about 70° C. to about 300° C. should be interpreted to include not only the explicitly recited limits of from about 70° C. to about 300° C., but also to include individual values, such as about 75° C., about 92.1° C., about 119.25° C., about 160.85° C., about 190.5° C., about 250° C., about 287° C., etc., and sub-ranges, such as from about 70° C. to about 225° C., from about 83.5° C. to about 123.35° C., from about 110.15° C. to about 190.5° C., from about 75° C. to about 280.5° C., etc. Furthermore, when “about” is utilized to describe a value, this is meant to encompass minor variations (up to +/−10%) from the stated value.

Reference throughout the specification to “one example”, “another example”, “an example”, and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. An imaging medium, comprising:
an image-receiving substrate including a color-forming layer;
a donor ribbon attached to the image-receiving substrate and including a color layer; and
a repeated pattern defined by a portion of the color-forming layer and a portion of the color layer, a repeat of the pattern including:
at least three adjacent stripes including a cyan or cyan-forming stripe, a magenta or magenta-forming stripe, and a yellow or yellow-forming stripe, wherein:
a first of the at least three adjacent stripes is a color-forming stripe in the color-forming layer of the image-receiving substrate;
a second of the at least three adjacent stripes is a colored stripe in the color layer of the donor ribbon; and
a third of the at least three adjacent stripes is either a second color-forming stripe in the color-forming layer or a second colored stripe in the color layer of the donor ribbon.

2. The imaging medium as defined in claim 1 wherein the at least three adjacent stripes includes four adjacent stripes, and a fourth of the four adjacent stripes is a black or black-forming stripe.

3. The imaging medium as defined in claim 1 wherein each of the at least three adjacent stripes has a width of 1/300^{th} of an inch or smaller.

4. The imaging medium as defined in claim 1, further comprising a registration mark.

5. The imaging medium as defined in claim 1 wherein the donor ribbon further includes a donor ribbon substrate and a release layer disposed between the donor ribbon substrate and the color layer.

6. The imaging medium as defined in claim 1 wherein the color layer of the donor ribbon is in contact with the color-forming layer of the image-receiving substrate.

7. An imaging medium, comprising:
an image-receiving substrate including a color-forming layer;
a donor ribbon attached to the image-receiving substrate and including a color layer; and
a repeated pattern defined by a portion of the color-forming layer and a portion of the color layer, a repeat of the pattern including:
a grid of four sections including i) a section selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section, iii) a magenta or magenta-forming section, and iv) a yellow or yellow-forming section;
wherein:
a first of the four sections is a color-forming section in the color-forming layer of the image-receiving substrate;
a second of the four sections is a colored section in the color layer of the donor ribbon; and
a third and a fourth of the four sections are one of:
a second color-forming section in the color-forming layer of the image-receiving substrate, and a second colored section in the color layer of the donor ribbon; or
a second color-forming section in the color-forming layer of the image-receiving substrate, and a third color-forming section in the color-forming layer of the image-receiving substrate; or
a second colored section in the color layer of the donor ribbon, and a third colored section in the color layer of the donor ribbon.

8. The imaging medium as defined in claim 7 wherein each of the four sections has an area of 1/300^{th} of an inch by 1/300^{th} of an inch or smaller.

9. The imaging medium as defined in claim 7, further comprising a registration mark.

10. The imaging medium as defined in claim 7 wherein the donor ribbon further includes a donor ribbon substrate and a release layer disposed between the donor ribbon substrate and the color layer.

11. The imaging medium as defined in claim 7 wherein the color layer of the donor ribbon is in contact with the color-forming layer of the image-receiving substrate.

12. A method of making a colored image, comprising:
selectively exposing an imaging medium to heat;
wherein the imaging medium includes:
an image-receiving substrate including a color-forming layer;
a donor ribbon attached to the image-receiving substrate and including a color layer; and
a repeated pattern, wherein a repeat of the pattern is defined by a portion of the color-forming layer and a portion of the color layer;
and wherein the selectively exposing of the imaging medium to heat one of:
activates a respective color-forming dye in the color-forming layer; or
transfers a respective dye from the color layer to the color-forming layer.

13. The method as defined in claim 12 wherein:
the repeat of the pattern includes:
at least three adjacent stripes including a cyan or cyan-forming stripe, a magenta or magenta-forming stripe, and a yellow or yellow-forming stripe, wherein:
a first of the at least three adjacent stripes is a color-forming stripe in the color-forming layer of the image-receiving substrate;
a second of the at least three adjacent stripes is a colored stripe in the color layer of the donor ribbon; and
a third of the at least three adjacent stripes is either a second color-forming stripe in the color-forming layer or a second colored stripe in the color layer of the donor ribbon; and
the selectively exposing of the imaging medium to heat one of:
activates a respective color-forming dye in the color-forming stripe or in the second color-forming stripe; or
transfers a respective dye from the colored stripe or the second colored stripe to the color-forming layer.

14. The method as defined in claim 12 wherein:
the repeat of the pattern includes:
a grid of four sections including i) a section selected from the group consisting of black, cyan, light cyan, yellow, magenta, and light magenta or selected from the group consisting of black-forming, cyan-forming, light cyan-forming, yellow-forming, magenta-forming, and light magenta-forming, ii) a cyan or cyan-forming section, iii) a magenta or magenta-forming section, and iv) a yellow or yellow-forming section;
wherein:
a first of the four sections is a color-forming section in the color-forming layer of the image-receiving substrate;
a second of the four sections is a colored section in the color layer of the donor ribbon; and
a third and a fourth of the four sections are one of:
a second color-forming section in the color-forming layer of the image-receiving substrate, and a second colored section in the color layer of the donor ribbon; or
a second color-forming section in the color-forming layer of the image-receiving substrate, and a third color-forming section in the color-forming layer of the image-receiving substrate; or
a second colored section in the color layer of the donor ribbon, and a third colored section in the color layer of the donor ribbon; and
the selectively exposing of the imaging medium to heat one of:
activates a respective color-forming dye in the color-forming section, in the second color-forming section, or in the third color-forming section; or
transfers a respective dye from the colored section, the second colored section, or the third colored section to the color-forming layer.

15. The method as defined in claim 12 wherein the selectively exposing of the imaging medium to heat is accomplished with a thermal inkjet printhead including a row of thermal resistors.
